(19) United States
(12) Patent Application Publication
(10) Pub. No.: US 2023/0169144 A1
(43) Pub. Date: Jun. 1, 2023

(54) OPERATION METHOD, PROCESSOR, AND RELATED PRODUCT

(71) Applicant: Cambricon (Xi'an) Semiconductor Co., Ltd., Xi'an, Shaanxi (CN)

(72) Inventors: Shaoli LIU, Xi'an (CN); Deyuan HE, Xi'an (CN); Daofu LIU, Xi'an (CN)

(73) Assignee: Cambricon (Xi'an) Semiconductor Co., Ltd., Xi'an, Shaanxi (CN)

(21) Appl. No.: 17/920,372

(22) PCT Filed: Feb. 8, 2021
(86) PCT No.: PCT/CN2021/075957

§ 371 Date: Oct. 20, 2022

(30) Foreign Application Priority Data
Apr. 21, 2020 (CN) 202010317734.8
Apr. 21, 2020 (CN) 202010318380.9
Apr. 21, 2020 (CN) 202010318387.0

(51) Int. Cl. G06F 17/16; G06F 7/523; G06F 7/544; G06F 7/50

(52) U.S. Cl. CPC G06F 17/16; G06F 7/50; G06F 7/523; G06F 7/5443

(57) ABSTRACT

The present disclosure relates to an operation method, a processor, and related products that improve operation efficiency during matrix multiplication. The products include a storage component, an interface apparatus, a control component, and the an artificial intelligence chip. The artificial intelligence chip is connected to the storage component, the control component, and the interface apparatus, respectively. The storage component stores data. The interface apparatus implements data transfer between the artificial intelligence chip and an external device. The control component monitors a state of the artificial intelligence chip. .

### TECHNICAL FIELD

The present disclosure relates to the technical field of information processing. Especially, the present disclosure relates to an operation method, a processor, and related products.

### BACKGROUND

In the technical field of artificial intelligence, a neural network algorithm, which is a very popular machine learning algorithm recently, has achieved good effects in various fields, such as image recognition, speech recognition, natural language processing, and the like. As the neural network algorithm develops, complexity of the algorithm is increasing, and in order to improve recognition, a size of a model is also increasing gradually. Processing these large-scale models with a graphics processing unit (GPU) and a central processing unit (CPU) takes a lot of calculation time and consumes a lot of power.

### SUMMARY

Based on this, it is necessary to provide an operation method, a processor, and related products that may improve operation efficiency to solve the above technical problems.

A first aspect of the present disclosure provides an operation method of matrix multiplication based on a processing element matrix. The method is applied to a processor. The processor includes two or more processing elements. The two or more processing elements are arranged in the form of a two-dimensional matrix. Each processing element includes at least one register. The method implements a matrix multiplication operation on a first matrix and a second matrix.

The method includes:
loading the first matrix into registers of the processing elements, where arrangements of elements of the first matrix in the matrix are the same as arrangements of elements of the first matrix in the registers of the processing elements;
for each row of the second matrix, storing elements in each row of the second matrix and elements of each column of the first matrix to the registers of the processing elements correspondingly, obtaining products of the elements in each row of the second matrix and the elements of each column of the first matrix respectively, and summing products of one column to obtain a first intermediate result; or for each column of the second matrix, storing elements in each column of the second matrix and elements of each row of the first matrix to the registers of the processing elements correspondingly, obtaining products of the elements in each column of the second matrix and the elements of each row of the first matrix respectively, and summing products of one row to obtain the first intermediate result; and
processing first intermediate results to obtain a product of the first matrix and the second matrix.

A second aspect of the present disclosure provides a processor. The processor includes two or more processing elements. The two or more processing elements are arranged in the form of a two-dimensional matrix. Each processing element includes at least one register. The processor is used to perform a matrix multiplication operation on a first matrix and a second matrix.

The processor further includes a controller, which is used to load the first matrix into registers of the processing elements.

For each row of the second matrix, the controller is used to store elements in each row of the second matrix and elements of each column of the first matrix to the registers of the processing elements correspondingly, obtain products of the elements in each row of the second matrix and the elements of each column of the first matrix respectively, and sum products of one column to obtain a first intermediate result; or for each column of the second matrix, the controller is used to store elements in each column of the second matrix and elements of each row of the first matrix to the registers of the processing elements correspondingly, obtain products of the elements in each column of the second matrix and the elements of each row of the first matrix respectively, and sum products of one row to obtain the first intermediate result.

The controller is further used to process first intermediate results to obtain a product of the first matrix and the second matrix.

A third aspect of the present disclosure provides an artificial intelligence chip, including the aforementioned processor.

A fourth aspect of the present disclosure provides an electronic device, including the aforementioned artificial intelligence chip.

A fifth aspect of the present disclosure provides an electronic device, including the aforementioned processor.

The operation method of matrix multiplication and the processor according to the aforementioned implementations of the present disclosure are more applicable to a processor composed of processing elements arranged in the form of an array, and operation efficiency is high. Moreover, for an input matrix with any size satisfying arrangements of processing elements, an operation result of matrix multiplication may be obtained, the number of times of memory accesses may be decreased, bandwidth pressure may be reduced, and operation efficiency may be improved.

A first aspect of the present disclosure provides a processor. The processor includes two or more processing elements. The two or more processing elements are arranged in the form of a two-dimensional matrix. Each processing element includes at least one register. The processor is used to perform a matrix multiplication operation on a first matrix and a second matrix.

The processor further includes a controller. The controller is used to load each element of a transposed matrix of the first matrix and each element of the second matrix into registers of each processing element respectively. An element of the transposed matrix and an element of a corresponding position of the second matrix are stored in a register of a same processing element.

The controller is used to control the transposed matrix or the second matrix to roll in row direction or in column direction. The controller is used to control the processing elements to perform multiplication operations on elements in corresponding registers to obtain element products. The controller is used to sum element products of a same row or element products of a same column to obtain first intermediate results.

The controller is further used to process the first intermediate results to obtain a product of the first matrix and the second matrix.

A second aspect of the present disclosure provides an operation method of matrix multiplication based on a processing element matrix. The method is applied to a processor. The processor includes two or more processing elements. The two or more processing elements are arranged in the form of a two-dimensional matrix. Each processing element includes at least one register. The method implements a matrix multiplication operation on a first matrix and a second matrix. The method includes:
transposing the first matrix to obtain a transposed matrix, and loading each element of the transposed matrix and each element of the second matrix into registers of each processing element respectively, where an element of the transposed matrix and an element of a corresponding position of the second matrix are stored in a register of a same processing element;
controlling the transposed matrix or the second matrix to roll in row direction or in column direction, controlling the processing elements to perform multiplication operations on elements in corresponding registers to obtain element products, and summing element products of a same row or element products of a same column to obtain first intermediate results; and
processing the first intermediate results to obtain a product of the first matrix and the second matrix.

A third aspect of the present disclosure provides an artificial intelligence chip, including the aforementioned processor.

A fourth aspect of the present disclosure provides an electronic device, including the aforementioned artificial intelligence chip.

Based on the operation method of matrix multiplication, the processor, and the related products according to the aforementioned implementations of the present disclosure, for an input matrix with any size satisfying arrangements of processing elements, an operation result of matrix multiplication may be obtained. Moreover, compared with matrix multiplication operations in related technologies, the number of times of memory accesses may be decreased, bandwidth pressure may be reduced, and operation efficiency may be improved.

A first aspect of the present disclosure provides an operation method of matrix multiplication based on a processing element matrix. The method is applied to a processor. The processor includes two or more processing elements. The two or more processing elements are arranged in the form of a two-dimensional matrix. Each processing element includes at least one register. The method implements a matrix multiplication operation on a first matrix and a second matrix. The method includes:
pre-processing the first matrix and the second matrix to obtain a third matrix and a fourth matrix, where both the third matrix and the fourth matrix are matrices of p×p, and p=max(m, k, n), where m represents a row rank of the first matrix, n represents a column rank of the second rank, both a column rank of the first matrix and a row rank of the second matrix are k, and p is a maximum value among m, k, and n;
loading the third matrix and the fourth matrix into registers of processing elements in a row-aligned and column-aligned fashion, and after loading, where an element of the third matrix and an element of a corresponding position of the fourth matrix are stored in a register of a same processing element;
rolling the third matrix and the fourth matrix in row direction or in column direction, and controlling the processing elements to perform multiplication operations on elements in corresponding registers to obtain an element product matrix; and
processing the element product matrix to obtain a product of the first matrix and the second matrix according to a way of pre-processing the first matrix and the second matrix.

In a possible implementation, rolling the third matrix and the fourth matrix in row direction or in column direction and controlling the processing elements to perform the multiplication operations on the elements in the corresponding registers to obtain the element product matrix include:
controlling the processing elements to perform the multiplication operations on the elements in the corresponding registers to obtain a first element product matrix; and
rolling the whole third matrix to the left once and rolling the whole fourth matrix up once, or rolling the whole third matrix to the right once and rolling the whole fourth matrix down once, controlling the processing elements to perform the multiplication operations on the elements in the corresponding registers to obtain a second element product matrix, and repeating p-1 times to obtain the second element product matrix.

In a possible implementation, processing the element product matrix to obtain the product of the first matrix and the second matrix according to the way of pre-processing the first matrix and the second matrix includes:
summing the first element product matrix and the second element product matrix to obtain a fifth matrix, and processing the fifth matrix to obtain the product of the first matrix and the second matrix according to the way of pre-processing the first matrix and the second matrix.

A second aspect of the present disclosure provides a processor. The processor includes two or more processing elements. The two or more processing elements are arranged in the form of a two-dimensional matrix. Each processing element includes at least one register. The processor is used to perform a matrix multiplication operation on a first matrix and a second matrix. The processor further includes a controller. The controller is used to pre-process the first matrix and the second matrix to obtain a third matrix and a fourth matrix. An element of the third matrix and an element of a corresponding position of the fourth matrix are stored in a register of a same processing element. Both the third matrix and the fourth matrix are matrices of p×p, and p=max(m, k, n), where m represents a row rank of the first matrix, n represents a column rank of the second rank, both a column rank of the first matrix and a row rank of the second matrix are k, and p is a maximum value among m, k, and n.

The controller is used to roll the third matrix and the fourth matrix in row direction or in column direction and control the processing elements to perform multiplication operations on elements in corresponding registers to obtain an element product matrix.

The controller is used to process the element product matrix to obtain a product of the first matrix and the second matrix according to a way of pre-processing the first matrix and the second matrix.

A third aspect of the present disclosure provides an operation apparatus of matrix multiplication based on a processing element matrix, including the aforementioned processor.

A fourth aspect of the present disclosure provides a non-volatile computer-readable storage medium, on which a computer program instruction is stored. When the computer program instruction is executed by a processor, the aforementioned method is implemented.

A fifth aspect of the present disclosure provides an artificial intelligence chip, including the aforementioned processor.

A sixth aspect of the present disclosure provides an electronic device, including the aforementioned artificial intelligence chip.

Based on the operation method of matrix multiplication, the processor, and the related products according to the aforementioned implementations of the present disclosure, data may not be required to be read repeatedly during the matrix multiplication operation, the number of times of memory accesses may be decreased, bandwidth pressure may be reduced, and operation efficiency may be high. Moreover, for an input matrix with any size, by transforming and then operating the input matrix by means of pre-processing, an operation result of matrix multiplication may be obtained.

Other features and aspects of the present disclosure will become clear based on the following detailed description of exemplary embodiments with reference to drawings.

### BRIEF DESCRIPTION OF DRAWINGS

Drawings are included in the specification and constitute a part of the specification. Together with the specification, the drawings illustrate exemplary embodiments, features, and aspects of the present disclosure, and the drawings are used to explain principles of the present disclosure.

FIG. 1-1 is a schematic diagram of a processor according to an embodiment of the present disclosure.

FIG. 1-2a and FIG. 1-2b respectively show examples of different ways of division.

FIGS. 1-3 is a flowchart of an operation method according to an embodiment of the present disclosure.

FIGS. 1-4 is a schematic diagram of an array composed of processing elements according to an embodiment of the present disclosure.

FIGS. 1-5 is a schematic diagram of partitioning according to an embodiment of the present disclosure.

FIGS. 1-6 shows an example of dividing a matrix according to an embodiment of the present disclosure.

FIGS. 2-1 is a schematic diagram of a processor according to an embodiment of the present disclosure.

FIG. 2-2a and FIG. 2-2brespectively show examples of a plurality of different ways of division.

FIGS. 2-3 is a flowchart of an operation method according to an embodiment of the present disclosure.

FIGS. 2-4 is a schematic diagram of an array composed of processing elements according to an embodiment of the present disclosure.

FIGS. 2-5 is a schematic diagram of partitioning according to an embodiment of the present disclosure.

FIGS. 2-6 shows an example of dividing a matrix according to an embodiment of the present disclosure.

FIGS. 3-1 is a schematic diagram of a processor according to an embodiment of the present disclosure.

FIG. 3-2a and FIG. 3-2brespectively show examples of different ways of dividing a matrix.

FIG. 3-3 is a flowchart of an operation method according to an embodiment of the present disclosure.

FIGS. 3-4 is a schematic diagram of partitioning according to an embodiment of the present disclosure.

FIG. 4 is a structural block diagram of a board card according to an embodiment of the present disclosure.

### DETAILED DESCRIPTION

Technical solutions in embodiments of the present disclosure will be described clearly and completely hereinafter with reference to drawings in the embodiments of the present disclosure. Obviously, embodiments to be described are merely some of, but not all of the embodiments of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” in the claims, the specification, and the drawings of the present disclosure are used for distinguishing different objects rather than describing a specific order. It should be understood that terms “including” and “comprising” used in the specification and the claims of the present disclosure indicate the presence of a feature, an entity, a step, an operation, an element, and/or a component, but do not exclude the existence or addition of one or more other features, entities, steps, operations, elements, components, and/or collections thereof.

It should also be understood that terms used in the specification of the present disclosure are merely for a purpose of describing a particular embodiment rather than limiting the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims of the present disclosure refers to any and all possible processing of one or more of relevant listed items and includes these processing.

As being used in the specification and the claims of the present disclosure, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

During a process of processing information by means of artificial intelligence, a matrix operation may occupy a relatively large calculating amount. Moreover, during a process of processing the matrix operation, splitting the matrix operation into a multiplication operation and an addition operation by an existing processor requires reading data from a memory frequently, resulting in very low operation efficiency.

In related technologies, for a matrix multiplication where a size of an input matrix is relatively large, in order to improve efficiency of the matrix operation, a multi-stage pipeline method is usually adopted to perform the operation. However, in a multi-stage pipeline, since each stage may process a part of input data, it is required to read the data from the memory frequently, and frequent memory accesses lead to high demands for a bandwidth.

In order to solve the aforementioned technical problems, the present disclosure provides an operation method and a processor for performing the operation method. The processor may include a plurality of processing elements. In some implementations, the plurality of processing elements may be arranged in the form of a two-dimensional matrix to better adapt to the matrix operation, and each processing element may include at least one register.

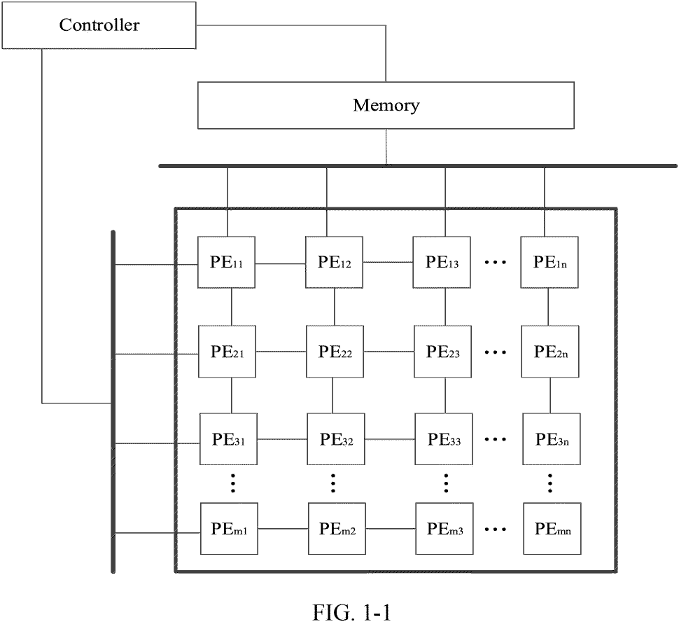

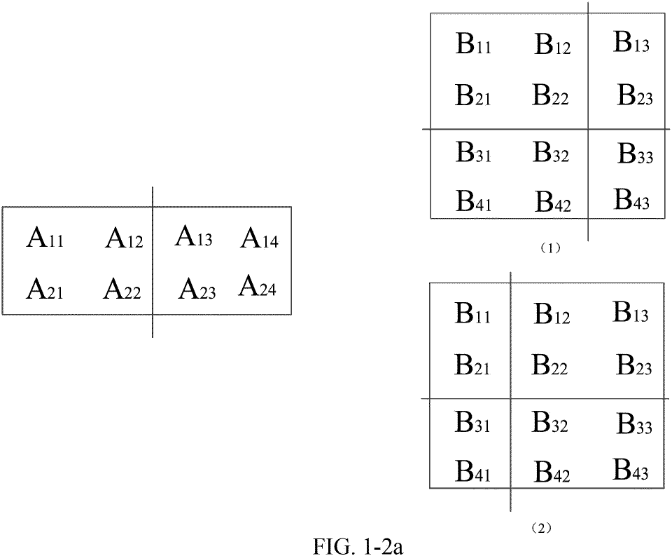

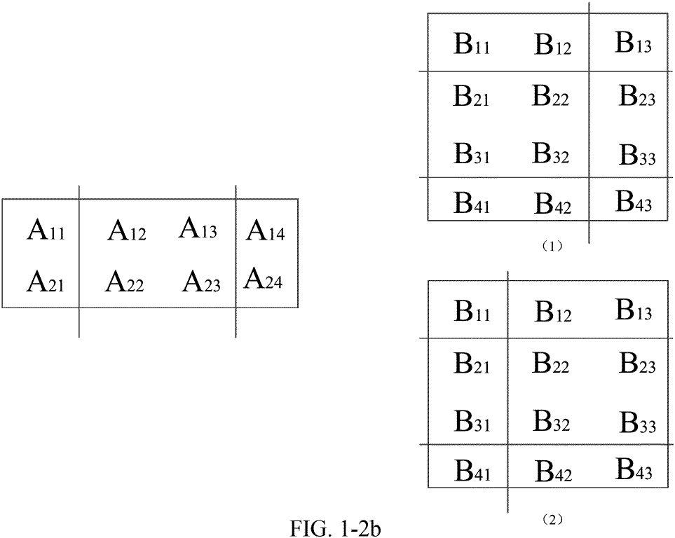

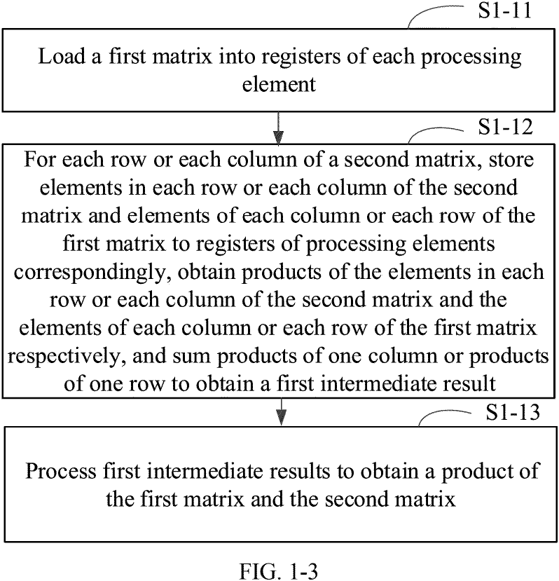

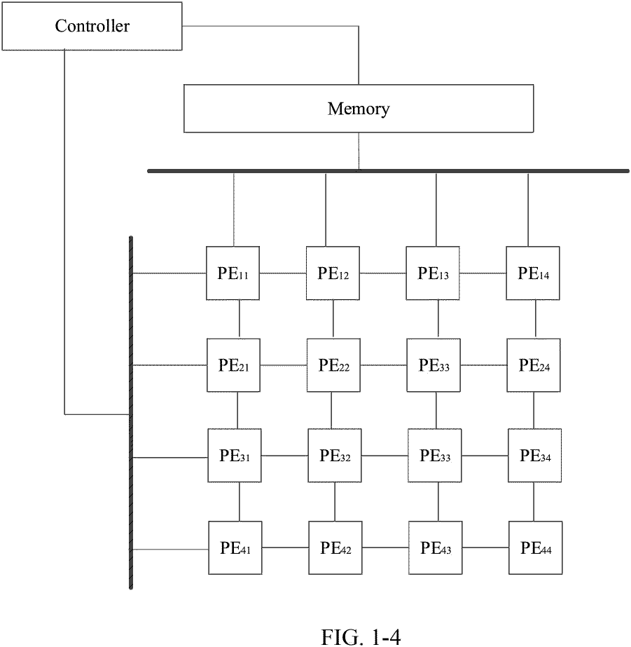

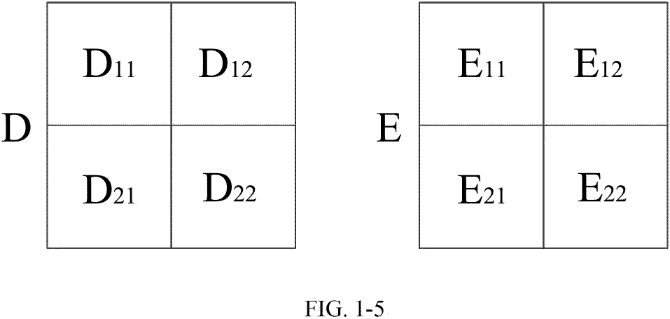

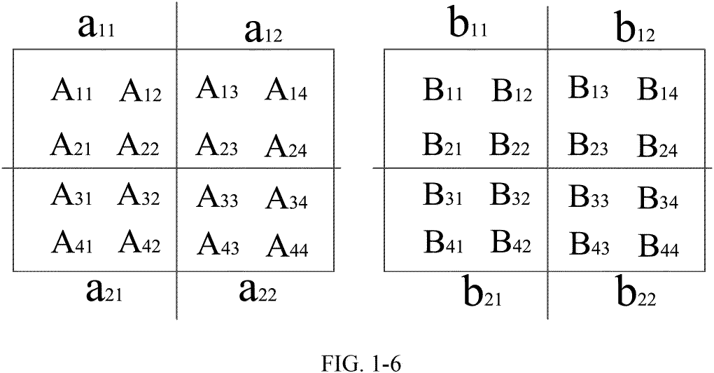

FIG. 1-1 is a schematic diagram of a processor according to an embodiment of the present disclosure. As shown in FIG. 1-1, a plurality of processing elements (PE) may be arranged in the form of a two-dimensional matrix. Each processing element may be connected to adjacent processing elements. Each PE may be configured with at least one register (which is not shown in the figure). The processor may further include a controller and a memory, where both the controller and the memory may be connected to the plurality of processing elements, and the controller may be connected to the memory. The controller may be used to load data from the memory into registers of processing elements and control the processing elements to process input data.

During an operation process of an embodiment of the present disclosure, the controller may load elements of a matrix into registers corresponding to each PE first. Then, the controller may store elements of another matrix to the corresponding registers by row, or by column, or by means of element traversal according to positions of elements in the matrix loaded into the registers. Then, the controller may control each PE to perform operations on elements stored in the registers set in the PE.

In a possible implementation, the memory may further store an executable program. The executable program may include an instruction. By executing the instruction by the processor, a matrix multiplication operation may be implemented. The controller may be configured with a loader and a decoder. The loader may be used to load input data in the memory into the registers of the processing elements. The decoder may decode an instruction for accessing data in the executable program according to changes of storage addresses of the input data after loading. For example, for the instruction for accessing data, storage addresses of the data in the registers obtained by decoding may be assigned to the instruction for accessing data and the decoded instruction may be sent to the processing elements, and the processing elements execute the instruction, thus realizing processing on the data.

In a possible implementation, the memory may be an on-chip caching unit. The controller may load an executable program and input data (such as an input matrix, including a left multiply matrix and a right multiply matrix) from an off-chip flash memory into the aforementioned memory (the on-chip caching unit), and then the controller may perform subsequent processes of the matrix multiplication operation.

In a possible implementation, the controller may also load the input matrix and the executable program from the off-chip memory into the registers of the processing elements directly, which is not limited in the present disclosure.

The PE may further include an operator for completing a specified operation. Taking a matrix operation as an example, the PE may include, for example, a multiplier and an adder. Specific structures of each PE may be the same or different. The present disclosure does not limit this. The PE may further include other types of operators to adapt to various different operation processes. The present disclosure does not limit the number and type of the operators included in the PE.

The input matrix of the multiplication operation may include a left multiply matrix and a right multiply matrix. The left multiply matrix may refer to a matrix located in a left side of a multiplication sign. The right multiply matrix may refer to a matrix located in a right side of the multiplication sign.

The operation method of the present disclosure is used to implement a matrix multiplication operation on a first matrix and a second matrix. In an example, the first matrix may be the left multiply matrix, and the second matrix may be the right multiply matrix. In another example, the first matrix may be the right multiply matrix, and the second matrix may be the left multiply matrix.

In an implementation of the present disclosure, the controller may determine a matrix in an input matrix as a to-be-loaded matrix. Since the number and arrangements of the processing elements in the processor are fixed, in some cases, the controller may partition the to-be-loaded matrix, and in some cases, the controller may not partition a matrix loaded into the processor. For another matrix in the input matrix besides the to-be-loaded matrix, partition processing may not be performed.

In a possible implementation, the controller may determine the to-be-loaded matrix from the input matrix. According to arrangements of the processing elements, a row number of the to-be-loaded matrix, and a column number of the to-be-loaded matrix, the controller may determine whether to partition the to-be-loaded matrix. The arrangements of the processing elements may refer to a row number of the processing elements and a column number of the processing elements. A row rank of the to-be-loaded matrix may refer to the row number of the to-be-loaded matrix, and a column rank of the to-be-loaded matrix may refer to the column number of the to-be-loaded matrix. The to-be-loaded matrix may be either the left multiply matrix or the right multiply matrix, which is not limited in the present disclosure.

If the row number of the to-be-loaded matrix is not greater than the row number of the processing elements, and the column number of the to-be-loaded matrix is not greater than the column number of the processing elements, the controller may not partition the to-be-loaded matrix. If the row number of the to-be-loaded matrix is greater than the row number of the processing elements, or the column number of the to-be-loaded matrix is greater than the column number of the processing elements, the controller may partition the to-be-loaded matrix.

In a possible implementation, when determining the to-be-loaded matrix from the input matrix, the controller may either determine randomly or determine a matrix that is not required to be partitioned as the to-be-loaded matrix preferentially according to the arrangements of the processing elements. The present disclosure does not limit a specific determination method.

For example, it is assumed that an array composed of the processing elements may be expressed as PE_{MN} representing a matrix with M×N processing elements. M represents a row number of the processing elements. N represents a column number of the processing elements. Both M and N are positive integers greater than 0. It is assumed that the left multiply matrix is αₘₙ representing the left multiply matrix is a matrix of m×n, where m represents a row number of the matrix aₘₙ, n represents a column number of the matrix aₘₙ, and both m and n are positive integers greater than 0. It is assumed that the right multiply matrix is bₙₖ representing the right multiply matrix is a matrix of n×k, where n is a row number of the matrix bₙₖ, k is a column number of the matrix bₙₖ, and k is a positive integer. If m is less than M and n is less than N, and n is greater than M or k is greater than N, the controller may select the matrix aₘₙ as the to-be-loaded matrix preferentially.

In a possible implementation, if both two input matrices satisfy conditions of not requiring partitioning, which means that both the two input matrices may be used as the to-be-loaded matrix, at this time, the controller may either determine one of the two input matrices as the to-be-loaded matrix randomly or select a matrix including more elements as the to-be-loaded matrix. As such, the number of times of loading elements may be decreased, and operation efficiency may be improved.

If it is determined to partition the to-be-loaded matrix, the controller may partition the to-be-loaded matrix to obtain two or more first matrices according to the arrangements of the processing elements, the row rank of the to-be-loaded matrix, and the column rank of the to-be-loaded matrix.

It is required to be explained that the example of the present disclosure takes loading the first matrix into each processing element as an example. In other words, the to-be-loaded matrix is used as the first matrix, or a matrix obtained after partitioning the to-be-loaded matrix is used as the first matrix.

For a case of not requiring partitioning, if the loaded first matrix is the left multiply matrix, the controller may use the right multiply matrix as the second matrix. If the loaded first matrix is the right multiply matrix, the controller may use the left multiply matrix as the second matrix.

For a case of requiring partitioning, if two or more first matrices are obtained after the to-be-loaded matrix is partitioned, the controller may process another matrix in the input matrix depending on situations.

If the registers included in the processing elements are unable to store all of the first matrices, at this time, according to different ways of partitioning the to-be-loaded matrix, the controller may partition another matrix in the input matrix besides the to-be-loaded matrix, or the controller may not partition another matrix in the input matrix besides the to-be-loaded matrix.

For example, if the to-be-loaded matrix is the left multiply matrix, and the to-be-loaded matrix is partitioned in row direction, at this time, the controller may not partition another matrix. If the to-be-loaded matrix is the left multiply matrix, and the to-be-loaded matrix is partitioned in column direction, at this time, the controller may partition another matrix in the input matrix besides the to-be-loaded matrix to obtain two or more second matrices according to a way of partitioning the to-be-loaded matrix.

If the to-be-loaded matrix is the right multiply matrix, and the to-be-loaded matrix is partitioned in row direction, at this time, the controller may partition another matrix in the input matrix besides the to-be-loaded matrix to obtain two or more second matrices according to the way of partitioning the to-be-loaded matrix. If the to-be-loaded matrix is the right multiply matrix, and the to-be-loaded matrix is partitioned in column direction, at this time, the controller may not partition another matrix.

If the to-be-loaded matrix is aₘₙ, according to a row number and a column number of the matrix aₘₙ, and the row number and the column number of the processing elements, whether the matrix aₘₙ is required to be partitioned may be determined. If a row number m of the matrix aₘₙ is not greater than a row number M of the processing elements, and a column number n of the matrix is not greater than a column number N of the processing elements, the matrix aₘₙ may not be partitioned. If the row number m of the matrix aₘₙ is greater than the row number M of the processing elements, or the column number n of the matrix is greater than the column number N of the processing elements, the matrix aₘₙ may be partitioned in row direction or in column direction.

If the to-be-loaded matrix is bₙₖ, according to a row number and a column number of the matrix bₙₖ, and the row number and the column number of the processing elements, whether the matrix bₙₖ is required to be partitioned may be determined. If a row number n of the matrix bₙₖ is not greater than the row number M of the processing elements, and a column number k of the matrix is not greater than the column number N of the processing elements, the matrix bₙₖ may not be partitioned. If the row number n of the matrix bₙₖ is greater than the row number M of the processing elements, or the column number k of the matrix is greater than the column number N of the processing elements, the matrix bₙₖ may be partitioned in row direction or in column direction.

In a possible implementation, a matrix obtained after partitioning satisfies conditions of not requiring partitioning again. In other words, a row number of a matrix after partitioning is not greater than the row number of the processing elements, and a column number of the matrix after partitioning is not greater than the column number of the processing elements.

If the row number m of the matrix aₘₙ is greater than the row number M of the processing elements, and the column number n of the matrix is not greater than the column number N of the processing elements, the controller may partition the matrix aₘₙ in row direction. Since the matrix aₘₙ is the left multiply matrix, partitioning the matrix in row direction may not affect a normal operation of the matrix with the right multiply matrix. As such, the controller may not partition the right multiply matrix. If the row number m of the matrix aₘₙ is not greater than the row number M of the processing elements, and the column number n of the matrix is greater than the column number N of the processing elements, the matrix aₘₙ may be partitioned in column direction. At this time, the controller may partition the right multiply matrix in row direction according to a way of partitioning the matrix aₘₙ in column direction. Partitioning the left multiply matrix in column direction and partitioning the right multiply matrix in row direction are performed in the same way. The same way of partitioning means that a column number of a first matrix obtained after partitioning is the same as a row number of the second matrix, so as to ensure that the matrix operation may be completed normally. If the row number m of the matrix aₘₙ is greater than the row number M of the processing elements, and the column number n of the matrix is greater than the column number N of the processing elements, the controller may partition the matrix aₘₙ in row direction and in column direction. The controller may partition the right multiply matrix in row direction according to a way of partitioning the matrix aₘₙ in column direction. Partitioning the left multiply matrix in column direction and partitioning the right multiply matrix in row direction are performed in the same way. The same way of partitioning means that the column number of the first matrix obtained after partitioning is the same as the row number of the second matrix, so as to ensure that the matrix operation may be completed normally.

If the row number n of the matrix bₙₖ is not greater than the row number M of the processing elements, and the column number k of the matrix is greater than the column number N of the processing elements, the controller may partition the matrix bₙₖ in column direction. Since the matrix bₙₖ is the right multiply matrix, partitioning the matrix in column direction may not affect a normal operation of the matrix with the left multiply matrix. As such, the controller may not partition the left multiply matrix. If the row number n of the matrix bₙₖ is greater than the row number M of the processing elements, and the column number k of the matrix is not greater than the column number N of the processing elements, the matrix bₙₖ may be partitioned in row direction. At this time, the controller may partition the left multiply matrix in column direction according to a way of partitioning the matrix bₙₖ in row direction. Partitioning the left multiply matrix in column direction and partitioning the right multiply matrix in row direction are performed in the same way. The same way of partitioning means that the column number of the first matrix obtained after partitioning is the same as the row number of the second matrix, so as to ensure that the matrix operation may be completed normally. If the row number n of the matrix bₙₖ is greater than the row number M of the processing elements, and the column number k of the matrix is greater than the column number N of the processing elements, the controller may partition the matrix bₙₖ in row direction and in column direction. At this time, the controller may partition the left multiply matrix in column direction according to a way of partitioning the matrix bₙₖ in row direction. Partitioning the left multiply matrix in column direction and partitioning the right multiply matrix in row direction are performed in the same way. The same way of partitioning means that the column number of the first matrix obtained after partitioning is the same as the row number of the second matrix, so as to ensure that the matrix operation may be completed normally.

In a possible implementation, partitioning may be performed in such a way that the row rank of the partitioned matrix is as close as possible to the row number of the processing elements, and the column rank of the partitioned matrix is as close as possible to the column number of the processing elements. As such, efficiency of the operation may be improved, and operation time may be reduced. In other words, assuming that the processing elements constitute an array of 4×4, partitioning may be performed in such a way that the partitioned matrices are 4×4 first. As such, the processing elements may be utilized with maximum efficiency, and operation efficiency may be improved.

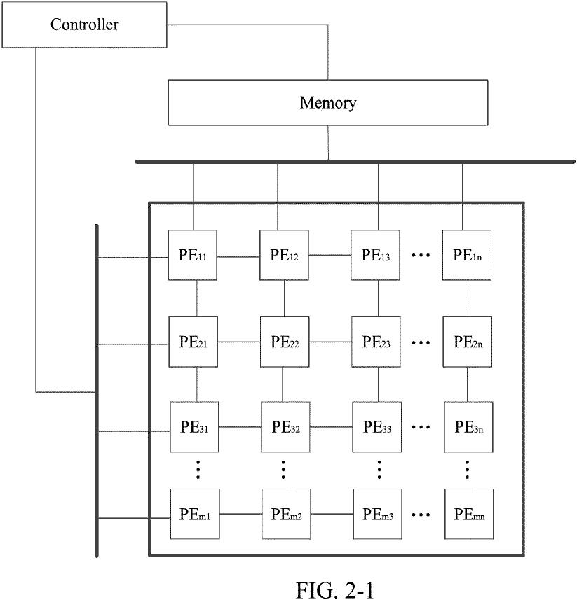

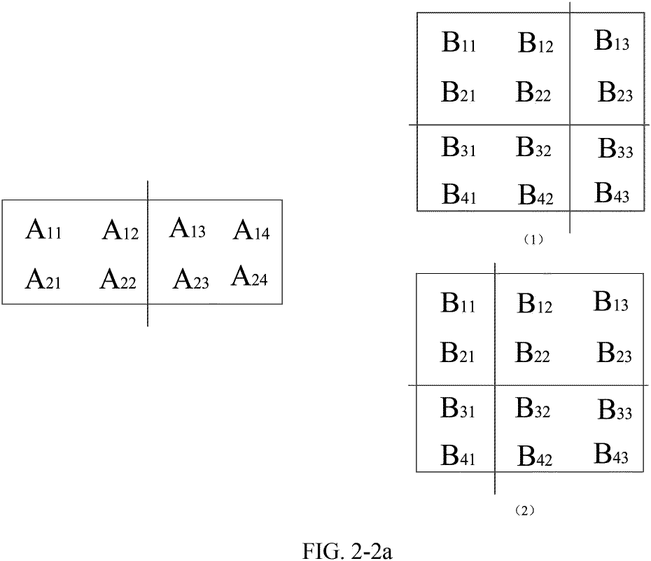

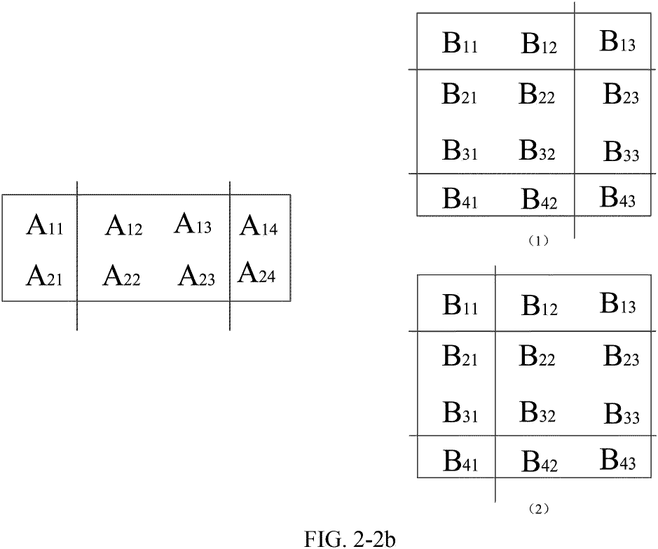

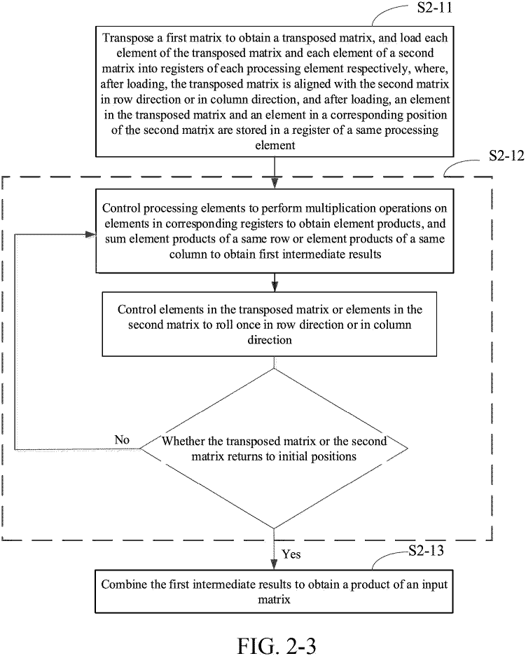

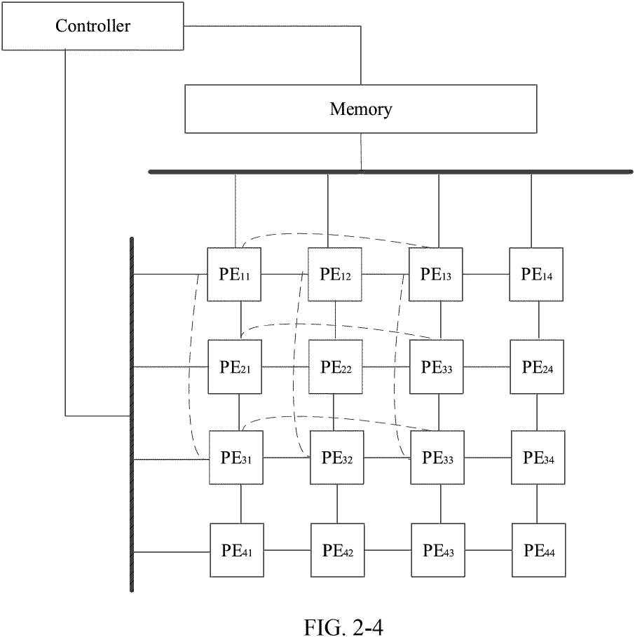

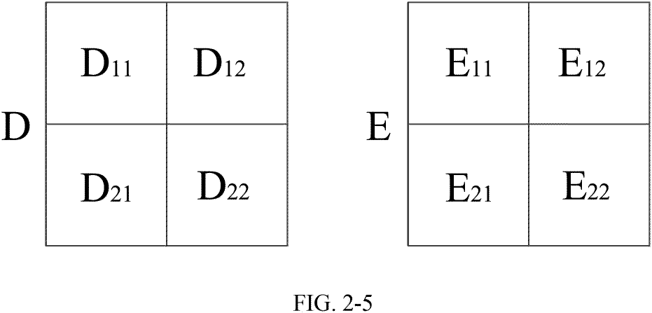

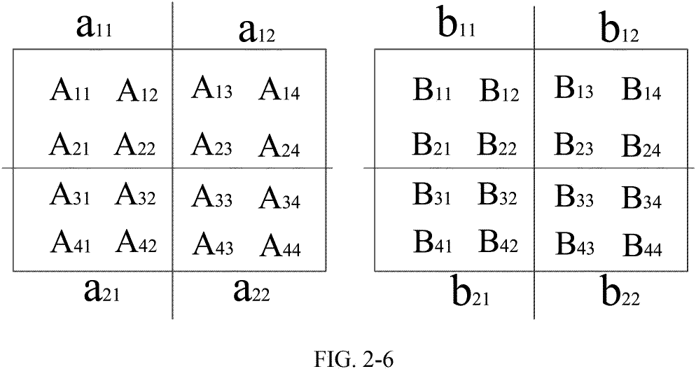

For example, it is assumed that the processing elements constitute an array of 2×2, the left multiply matrix is a matrix of 2×4, and the right multiply matrix is a matrix of 4×3. In this case, no matter the left multiply matrix or the right multiply matrix is loaded, both the left multiply matrix and the right multiply matrix are required to be partitioned. There are many ways of partitioning. FIG. 1-2a and FIG. 1-2b respectively show a plurality of different ways of partitioning. Partitioning a matrix a₂₄ in column direction and partitioning a matrix b₄₃ in row direction may be performed in the same way. FIG. 1-2a is an example of partitioning. The matrix a₂₄ is divided into two parts in column direction, and each part includes two columns. The matrix b₄₃ is divided into two parts in row direction, and each part includes two rows. FIG. 1-2b is another example of partitioning. The matrix a₂₄ is divided into three parts in column direction, where one part includes two columns, and other two parts each includes one column respectively. The matrix b₄₃ is divided into three parts in row direction, where one part includes two rows, and other two parts each includes one row. The aforementioned arrangement of the processing elements and the aforementioned way of partitioning of the input matrix are only examples of the present disclosure and do not limit the present disclosure in any way.

The row rank of the matrix divided based on the way of partitioning shown in FIG. 1-2a is closer to the row number of the processing elements, and the column rank of the matrix divided based on the way of partitioning shown in FIG. 1-2a is closer to the column number of the processing elements. In this way, utilization of the processing elements may be improved, and complexity of controlling may be decreased. Moreover, for a same input matrix, since the number of blocks after partitioning is less, the number of times of loading data may be less, and efficiency of the operation in such a way of partitioning may be high.

The present disclosure does not limit the way of partitioning the left multiply matrix in row direction and the way of partitioning the right multiply matrix in column direction, as long as the partitioned matrices satisfy conditions of not requiring partitioning again.

In a possible implementation, if the number of registers included in the processing elements may meet requirements for storing the input matrix, the divided first matrices may be stored to the registers of the processing elements by adopting a way of storing in stacks, so as to implement the multiplication operation of the input matrix. For example, each processing element may include a plurality of registers. The controller may divide the registers included in the processing elements into a plurality of different groups. After partitioning the input matrix, the controller may store two or more first matrices in stacks in the plurality of groups of registers, where each group stores one first matrix. In this implementation, the controller may use another matrix in the input matrix besides the to-be-loaded matrix as the second matrix. It is required to be explained that storing in stacks is only an optional implementation. The present disclosure does not limit this.

FIGS. 1-3 is a flowchart of an operation method according to an embodiment of the present disclosure. Taking a case that it is not required to partition a to-be-loaded matrix as an example, the operation method of the present disclosure may be explained first. Assuming that the to-be-loaded matrix is a first matrix, another matrix in an input matrix besides the to-be-loaded matrix is a second matrix, as shown in FIGS. 1-3, the operation method of the present disclosure may include the following steps.

In a step S1-11, the first matrix is loaded into registers of each processing element.

In a possible implementation, arrangements of elements of the first matrix in the matrix are the same as arrangements of elements of the first matrix in the registers of the processing elements.

In a step S1-12, for each row or each column of the second matrix, elements in each row or each column of the second matrix and elements of each column or each row of the first matrix are stored to the registers of the processing elements correspondingly, products of the elements in each row or each column of the second matrix and the elements of each column or each row of the first matrix are obtained respectively, and products of one column or products of one row are summed to obtain a first intermediate result. In other words, for each row or each column of the second matrix, elements in each row or each column of the second matrix are stored to the registers of the processing elements where the registers that store the elements of each column or each row of the first matrix are located.

In other words, for each row of the second matrix, elements in each row of the second matrix and elements of each column of the first matrix are stored to the registers of the processing elements correspondingly, products of the elements in each row of the second matrix and the elements of each column of the first matrix are obtained respectively, and products of one column are summed to obtain the first intermediate result. Or for each column of the second matrix, elements in each column of the second matrix and elements of each row of the first matrix are stored to the registers of the processing elements correspondingly, products of the elements in each column of the second matrix and the elements of each row of the first matrix are obtained respectively, and products of one row are summed to obtain the first intermediate result.

In a step S1-13, first intermediate results are processed to obtain a product of the first matrix and the second matrix.

For a case of not partitioning, the controller may use the left multiply matrix as the first matrix and the right multiply matrix as the second matrix directly, or the controller may use the left multiply matrix as the second matrix and the right multiply matrix as the first matrix directly. The present disclosure does not limit this.

In an example, the first matrix is the left multiply matrix, and the second matrix is the right multiply matrix. Then, in the step S1-12, for elements of each column of the second matrix, each of the elements of each column of the second matrix and elements of a corresponding column of the first matrix are stored to the registers of the processing elements (in other words, each of the elements of each column of the second matrix is stored to the registers of the processing elements where the registers that store the elements of the corresponding column of the first matrix are located); each processing element is controlled to perform multiplication operations on elements in corresponding registers to obtain element products; and element products of each row are summed to obtain the first intermediate results. The elements of the column of the first matrix corresponding to each of the elements of each column of the second matrix mean that a row number of the element in the second matrix is the same as a column number of the elements of the column in the second matrix.

In another example, the first matrix is the right multiply matrix, and the second matrix is the left multiply matrix. Then, in the step S1-12, for elements of each row of the second matrix, each of the elements of each row of the second matrix and elements of a corresponding row of the first matrix are stored to the registers of the processing elements; each processing element is controlled to perform the multiplication operations on the elements in the corresponding registers to obtain the element products; and element products of each column are summed to obtain the first intermediate results. The elements of the row of the first matrix corresponding to each of the elements of each row of the second matrix mean that a column number of the element in the second matrix is the same as a row number of the elements of the row.

Depending on whether the matrix loaded into the processor is the left multiply matrix or the right multiply matrix, the first intermediate results may be processed in different ways in the step S1-13. Specifically, if the first matrix is the left multiply matrix, then, the obtained first intermediate results may be used as elements of one column of a product matrix of the first matrix and the second matrix. A column number of the first intermediate results in the product matrix is the same as a column number of the second matrix that obtains the first intermediate results by performing the operation. If the first matrix is the right multiply matrix, then, the obtained first intermediate results may be used as elements of one row of the product matrix of the first matrix and the second matrix. A row number of the first intermediate results in the product matrix is the same as a row number of the second matrix that obtains the first intermediate results by performing the operation.

In a possible implementation, for processing elements of a same row or processing elements of a same column, the controller may control the processing elements of this row or the processing elements of this column to move element products obtained after calculating each time to one processing element in this row or one processing element in this column. Moreover, the controller may control the processing element in this row or the processing element in this column to sum the element products to obtain the first intermediate results. For example, if the first matrix is the left multiply matrix, and the second matrix is the right multiply matrix, when the element products are calculated each time, the controller may control the processing elements of the same row to move the element products obtained after calculating to one processing element of this row. Moreover, the controller may control the processing element to sum the element products to obtain the first intermediate results. If the first matrix is the right multiply matrix, and the second matrix is the left multiply matrix, when the element products are calculated each time, the controller may control the processing elements of the same column to move the element products obtained after calculating to one processing element of this column. Moreover, the controller may control the processing element to sum the element products to obtain the first intermediate results. The processing element may sum the element products by adopting an adder. The one processing element may be either a processing element storing elements of the first matrix or a processing element not storing the elements of the first matrix. The present disclosure does not limit this.

The above example just shows a way of calculating the first intermediate results, which is not limited in the present disclosure. For example, a specialized adder may be set in rows or columns of the processing element array for implementing the above calculating process.

### Example 1-1: The First Matrix Is the Left Multiply Matrix, and the Second Matrix is The Right Multiply Matrix

It is assumed that both the first matrix aₘₙ and the second matrix bₙₖ are matrices of 3×3, and the processing elements constitute an array of 4×4.

FIGS. 1-4 is a schematic diagram of an array composed of processing elements according to an embodiment of the present disclosure. The operation method of the present disclosure may be explained in combination with FIGS. 1-4 and FIGS. 1-3.

It is assumed that a first matrix is

$${a}_{33} = \left[\begin{matrix}{A}_{11} & {A}_{12} & {A}_{13} \\ {A}_{21} & {A}_{22} & {S}_{23} \\ {A}_{31} & {A}_{32} & {A}_{33}\end{matrix}\right]$$

, and a second matrix is b₃₃ =

$$\left[\begin{matrix}{B}_{11} & {B}_{12} & {B}_{13} \\ {B}_{21} & {B}_{22} & {B}_{23} \\ {B}_{31} & {B}_{32} & {B}_{33}\end{matrix}\right]$$

For loading the first matrix into registers of processing elements, the first matrix may be loaded into the registers of the processing elements according to arrangements of rows and columns of the first matrix. In other words, arrangements of elements of the first matrix in the matrix are the same as arrangements of elements of the first matrix in the registers of the processing elements. In other words, the same arrangements mean that row subscripts of all elements in the matrix are the same as row difference values of the processing elements where all elements are located, and column subscripts of all elements in the matrix are the same as difference values of column subscripts of the processing elements where all elements are located.

In a possible implementation, a row number and a column number of an element of the first matrix in the matrix are the same as a row number and a column number of a processing element loading the element in the array composed of the processing elements.

For example, in an example, the controller may load A₁₁ into registers of PE₁₁, load A₁₂ into registers of PE₁₂, load A₁₃ into registers of PE₁₃, load A₂₁ into registers of PE₂₁...and load A₃₃ into registers of PE₃₃. In other words, subscripts of the elements of the first matrix may be the same as subscripts of the processing elements where the elements are located. Both the aforementioned difference values of row subscripts and the aforementioned difference values of column subscripts are 0.

In another example, the controller may load A₁₁ into registers of PE₁₂, load A₁₂ into registers of PE₁₃, load A₁₃ into registers of PE₁₄, load A₂₁ into registers of PE₂₂...and load A₃₃ into registers of PE₃₄. In other words, arrangements of the elements of the first matrix in the matrix may be the same as arrangements of the elements of the first matrix in the registers of the processing elements. The difference values of row subscripts are 0 and the difference values of column subscripts are 1.

It is required to be explained that the above two examples are just some examples of loading the first matrix and do not restrict the present disclosure in any way. Those skilled in the art should know that the first matrix may be loaded in other ways, as long as arrangements of the elements of the first matrix in the matrix are the same as arrangements of the elements of the first matrix in the registers of the processing elements.

In a possible implementation, after loading the input matrix, for the step S1-12, the controller may store an element B₁₁ in a first column of the second matrix and elements of one corresponding column of the first matrix to the registers of the processing elements. The elements of one corresponding column mean that a row number of the element in the second matrix is the same as a column number of the elements of the column in the first matrix. If B₁₁ is a first row of the first matrix, then, the elements of the one corresponding column may refer to elements in a first column of the first matrix. In other words, the controller may store the element B₁₁ to the registers of the processing elements where registers that store A₁₁, A₂₁, and A₃₁ are located.

The controller may store an element B₂₁ in the first column of the second matrix to the registers of the processing elements where registers that store A₁₂, A₂₂, and A₃₂ are located. The controller may store an element B₃₁ in the first column of the second matrix to the registers of the processing elements where registers that store A₁₃, A₂₃, and A₃₃ are located.

In other words, B₁₁ and A₁₁ are stored in the registers of the same processing element; B₁₁ and A₂₁ are stored in the registers of the same processing element; and B₁₁ and A₃₁ are stored in the registers of the same processing element. B₂₁ and A₁₂ are stored in the registers of the same processing element; B₂₁ and A₂₂ are stored in the registers of the same processing element; and B₂₁ and A₃₂ are stored in the registers of the same processing element. B₃₁ and A₁₃ are stored in the registers of the same processing element; B₃₁ and A₂₃ are stored in the registers of the same processing element; and B₃₁ and A₃₃ are stored in the registers of the same processing element.

The controller in the processor may control the processing elements to obtain products of elements stored in the corresponding registers respectively. Then, the controller in the processor may sum products of each row to obtain the first intermediate results. The obtained first intermediate results are respectively: B₁₁ × A₁₁ + B₂₁ × A₁₂ + B₃₁ × A₁₃, B₁₁ × A₂₁ + B₂₁ ×A₂₂ + B₃₁ ×A₂₃, and B₁₁×A₃₁ + B₂₁×A₃₂ + B₃₁×A₃₃. Assuming that a matrix obtained by multiplying the first matrix with the second matrix is C₃₃, then the aforementioned first intermediate results may be expressed as: C₁₁, C₂₁, and C₃₁.

In a possible implementation, exemplarily, the controller may load A₁₁ into registers of PE₁₁, load A₁₂ into registers of PE₁₂, load A₁₃ into registers of PE₁₃, load A₂₁ into registers of PE₂₁...and load A₃₃ into registers of PE₃₃. In other words, subscripts of the elements of the first matrix may be the same as subscripts of the processing elements where the elements are located. Both the aforementioned difference values of row subscripts and the aforementioned difference values of column subscripts are 0. In this example, after storing elements including B₁₁, B₂₁, and B₃₁ in the first column of the second matrix to the registers of the processing elements, the controller may control the processing elements to use multipliers to take products of elements of respective registers to obtain element products. The controller may control each row of processing elements to move the element products obtained after calculating to one processing element of this row. For example, the controller may control PE₁₁, PE₁₂, and PE₁₃ to move the element products obtained after calculating including B₁₁×A₁₁, B₂₁ ×A₁₂, and B₃₁×A₁₃ to an processing element PE₁₄, and the controller may control PE₁₄ to use an adder to sum the aforementioned element products to obtain C₁₁. It is required to be explained that the controller may also control the processing elements in the first row to move the element products to PE₁₁, PE₁₂, or PE₁₃, which is not limited in the present disclosure. After the controller controls processing elements in a second row and processing elements in a third row to perform similar operations, first intermediate results including C₁₁, C₂₁, and C₃₁may be obtained.

For each column of the second matrix, by repeating the above process, first intermediate results including C₁₂, C₂₂, C₃₂, C₁₃, C₂₃, and C₃₃ may be obtained. By using the aforementioned first intermediate results, a product

$${\text{c}}_{\text{33}} = \left[\begin{matrix}{\text{C}}_{\text{11}} & {\text{C}}_{\text{12}} & {\text{C}}_{\text{13}} \\ {\text{C}}_{\text{21}} & {\text{C}}_{\text{22}} & {\text{C}}_{\text{23}} \\ {\text{C}}_{\text{31}} & {\text{C}}_{\text{32}} & {\text{C}}_{\text{33}}\end{matrix}\right]$$

of the first matrix and the second matrix may be obtained.

In a possible implementation, the obtained first intermediate results may be stored by column to obtain the product of the first matrix and the second matrix. As described above, if the first matrix is the left multiply matrix, the first intermediate results obtained each time may be used as elements of one column of the product matrix of the first matrix and the second matrix. A case where the column number of the first intermediate results in the product matrix is the same as the column number of the second matrix that obtains the first intermediate results by performing the operation means that, by taking the above example as an example, the elements in the first column of the second matrix and the first intermediate results including C₁₁, C₂₁, and C₃₁ obtained after the elements of the first matrix perform the operation constitute the first column of c₃₃.

### Example 1-2: The First Matrix Is the Right Multiply Matrix, and The Second Matrix Is The Left Multiply Matrix

It is still assumed that both a first matrix aₘₙ and a second matrix bₙₖ are matrices of 3×3, and the processing elements constitute an array of 4×4. It is assumed that the first matrix is

$${\text{a}}_{\text{33}} \text{=} \left[\begin{matrix}{\text{A}}_{\text{11}} & {\text{A}}_{\text{12}} & {\text{A}}_{\text{13}} \\ {\text{A}}_{\text{21}} & {\text{A}}_{\text{22}} & {\text{S}}_{\text{23}} \\ {\text{A}}_{\text{31}} & {\text{A}}_{\text{32}} & {\text{A}}_{\text{33}}\end{matrix}\right]$$

, and the second matrix is

$${b}_{33} = \left[\begin{matrix}{B}_{11} & {B}_{12} & {B}_{13} \\ {B}_{21} & {B}_{22} & {B}_{23} \\ {B}_{31} & {B}_{32} & {B}_{33}\end{matrix}\right] .$$

.

For a way of loading the first matrix into the registers of the processing elements, reference may be made to the way of loading the first matrix in the example 1-1, which will not be repeated.

After loading the first matrix, for the step S1-12, the element B₁₁in the first row of the second matrix and elements of one corresponding row of the first matrix may be stored to the registers of the processing elements. The elements of one corresponding row mean that a column number of the element in the second matrix is the same as a row number of the elements of the column in the first matrix. If B₁₁ is in the first column of the first matrix, then, the elements of the one corresponding column may refer to elements in the first row of the first matrix. In other words, the controller may store the element B₁₁ to the registers of the processing elements where the registers that store A₁₁, A₁₂, and A₁₃ are located.

The controller may store the element B₁₂ in the first row of the second matrix to the registers of the processing elements where the registers that store A₂₁, A₂₂, and A₂₃ are located. The controller may store the element B₁₃ in the first row of the second matrix to the registers of the processing elements where the registers that store A₃₁, A₃₂, and A₃₃ are located.

In other words, B₁₁ and A₁₁ are stored in the registers of the same processing element; B₁₁ and A₁₂ are stored in the registers of the same processing element; and B₁₁ and A₁₃ are stored in the registers of the same processing element. B₁₂ and A₂₁ are stored in the registers of the same processing element; B₁₂ and A₂₂ are stored in the registers of the same processing element; and B₁₂ and A₂₃ are stored in the registers of the same processing element. B₁₃ and A₃₁ are stored in the registers of the same processing element; B₁₃ and A₃₂ are stored in the registers of the same processing element; and B₁₃ and A₃₃ are stored in the registers of the same processing element.

The controller in the processor may control the processing elements to obtain products of elements stored in the corresponding registers respectively. Then, the controller in the processor may sum products of each column to obtain the first intermediate results. The obtained first intermediate results are respectively: B₁₁× A₁₁+ B₁₂×A₂₁+B₁₃×A_{31,} B₁₁×A₁₂ + B₁₂×A₂₂ + B₁₃×A₃₂, and B₁₁×A₁₃+B₁₂×A₂₃ + B₁₃×A₃₃. Assuming that a matrix obtained by multiplying the first matrix with the second matrix is C₃₃, then, the aforementioned first intermediate results may be expressed as: C₁₁, C₁₂, and C₁₃.

In a possible implementation, exemplarily, the controller may load A₁₁ into registers of PE₁₁, load A₁₂ into registers of PE₁₂, load A₁₃ into registers of PE₁₃, load A₂₁ into registers of PE₂₁...and load A₃₃ into registers of PE₃₃. In other words, subscripts of the elements of the first matrix may be the same as subscripts of the processing elements where the elements are located. Both the aforementioned difference values of row subscripts and the aforementioned difference values of column subscripts are 0. In this example, after storing elements including B₁₁, B₁₂, and B₁₃ in the first row of the second matrix to the registers of the processing elements, the controller may control the processing elements to use multipliers to take products of elements of respective registers to obtain element products. The controller may control each column of processing elements to move the element products obtained after calculating to one processing element of this column. For example, the controller may control PE₁₁, PE₂₁, and PE₃₁ to move the element products obtained after calculating including B₁₁×A₁₁, B₁₂×A_{21,} and B₁₃×A₃₁ to the processing element PE₄₁, and the controller may control PE₁₄ to use an adder to sum the aforementioned element products to obtain C₁₁. It is required to be explained that the controller may also control the processing elements in the first row to move the element products to PE₁₁, PE₂₁, or PE₃₁, which is not limited in the present disclosure. After the controller may control processing elements in a second row and processing elements in a third row to perform similar operations, first intermediate results including C₁₁, C₁₂, and C₁₃may be obtained.

For each row of the second matrix, by repeating the above process, first intermediate results including C₂₁, C₂₂, C₂₃ and C₃₁, C₃₂, C₃₃ may be obtained. By using the aforementioned first intermediate results, a product

$${\text{c}}_{\text{33}} \text{=} \left[\begin{matrix}{\text{C}}_{\text{11}} & {\text{C}}_{\text{12}} & {\text{C}}_{\text{13}} \\ {\text{C}}_{\text{21}} & {\text{C}}_{\text{22}} & {\text{C}}_{\text{23}} \\ {\text{C}}_{\text{31}} & {\text{C}}_{\text{32}} & {\text{C}}_{\text{33}}\end{matrix}\right]$$

of the first matrix and the second matrix may be obtained.

In a possible implementation, the obtained first intermediate results may be stored by column to obtain the product of the first matrix and the second matrix.

It is required to be explained that the arrangements of the processing elements and the input matrix in the above example are just used to clearly explain processes of the operation method of the present disclosure and do not restrict the present disclosure in any way.

Based on the operation method of matrix multiplication according to the above implementations of the present disclosure, for an input matrix with any size satisfying the arrangements of the processing elements, an operation result of matrix multiplication may be obtained.

For a case of not partitioning, according to the above example, the result of matrix multiplication may be obtained directly.

The operation method of matrix multiplication according to the above implementations of the present disclosure is more applicable to a processor composed of processing elements arranged in the form of an array. Compared with matrix multiplication operations in related technologies, the number of times of memory accesses may be decreased, bandwidth pressure may be reduced, and operation efficiency may be improved. For a case of requiring partitioning, for the partitioned first matrix and the partitioned second matrix (where the second matrix may be obtained either by partitioning or by using another matrix as the second matrix directly), according to a product of the first matrix and the corresponding second matrix, based on rules of matrix multiplication, a product of the left multiply matrix and the right multiply matrix may be calculated. In other words, the partitioned first matrix and the partitioned second matrix may be used as one element of the matrix. By executing an operation process of matrix multiplication based on the rules of matrix multiplication, second intermediate results may be obtained. By calculating according to the second intermediate results, products of the input matrix may be obtained.

FIGS. 1-5 is a schematic diagram of partitioning according to an embodiment of the present disclosure. As shown in FIGS. 1-5, a matrix D may be partitioned according to the above way to obtain first matrices including D₁₁, D₁₂, D₂₁, D₂₂, and a matrix E may be partitioned according to the above way to obtain second matrices including E₁₁, E₁₂, E_{21,} E₂₂. The first matrix and the second matrix may be used as one element of the matrix to perform the operation process of matrix multiplication. For example, multiplying a first row of the matrix D with a first column of the matrix E is F₁₁=D₁₁ × E₁₁ + D₁₂ × E₂₁; multiplying the first row of the matrix D with a second column of the matrix E is F₁₂=D₁₁ × E₁₂ + D₁₂ × E₂₂; multiplying a second row of the matrix D with the first column of the matrix E is F₂₁=D₂₁ × E₁₁ + D₂₂ × E₂₁; and multiplying the second row of the matrix D with the second column of the matrix E is F₂₂=D₂₁ ×E₁₂ + D₂₂ × E₂₂. In other words, in order to obtain a final operation result of matrix multiplication, it is required to obtain the second intermediate results first, including:

$$\left({\text{D}}_{\text{11}} \times {\text{E}}_{\text{11}} \text{,} {\text{D}}_{\text{12}} \times {\text{E}}_{\text{21}} \text{,} {\text{D}}_{\text{11}} \times {\text{E}}_{\text{12}} \text{,} {\text{D}}_{\text{12}} \times {\text{E}}_{\text{22}} \text{,}\right)$$

$${\text{D}}_{21} \times {\text{E}}_{11} , {\text{D}}_{22} \times \text{E} {}_{21} , {\text{D}}_{21} \times {\text{E}}_{12} , {\text{D}}_{22} \times {\text{E}}_{22} .$$

Processes of specifically calculating the second intermediate results may be obtained by operating corresponding first matrices and corresponding second matrices according to steps S1-11 to S1-13 respectively.

By partitioning the input matrix and performing the matrix multiplication operations of the present disclosure on the partitioned matrices respectively to obtain the second intermediate results, based on the rules of matrix multiplication, according to the second intermediate results, the products of the input matrix may be obtained by calculating. Based on the operation method according to the aforementioned implementations of the present disclosure, for a matrix with any dimension, processes of matrix multiplication may be implemented quickly, and operation efficiency may be high.

For a case of performing partitioning, if the number of registers included in the processing elements may meet requirements for storing the input matrix, then, the input matrix may be stored to the registers of the processing elements by adopting a way of storing in stacks, so as to implement the multiplication operations of the input matrix. For example, each processing element may include a plurality of registers. The controller may divide the registers included in the processing elements into a plurality of groups of registers. Then, the processor may include a plurality of groups of registers, and each group of registers may be used to store one first matrix after partitioning. Therefore, in a possible implementation, the controller may divide the registers of the processing elements according to the way of partitioning the input matrix to obtain the plurality of groups of registers.

In this implementation, the operation method of the present disclosure may further include:

after partitioning the input matrix, storing, by the controller, two or more first matrices in stacks in the plurality of groups of registers, where each group stores one first matrix.

In another possible implementation, the controller may also store one first matrix each time. Referring to examples in FIGS. 1-5, the controller may calculate the products of the input matrix according to the second intermediate results.

According to processes of steps S1-11 to S1-13, a matrix multiplication operation may be performed on the first matrix and the second matrix corresponding to the first matrix to obtain the second intermediate results. According to the second intermediate results, the products of the input matrix may be calculated. The second matrix corresponding to the first matrix may be a matrix that is required to perform the multiplication operation with the first matrix in matrices that are obtained by partitioning the left multiply matrix/the right multiply matrix according to the rules of matrix multiplication.

### Example 1-3: Storage in Stacks in Combination With Steps S1-11 to S1-13

For example, the operation method of the present disclosure may be explained by taking a case where the processing elements constitute an array of 2×2, and input matrices are matrices of 4×4 as an example.

It is assumed that the left multiply matrix is

$${a}_{44} = \left[\begin{matrix}{A}_{11} & {A}_{12} & {A}_{13} & {A}_{14} \\ {A}_{21} & {A}_{22} & {A}_{23} & {A}_{24} \\ {A}_{31} & {A}_{32} & {A}_{33} & {A}_{34} \\ {A}_{41} & {A}_{42} & {A}_{43} & {A}_{44}\end{matrix}\right] ,$$

and the right multiply matrix is

$${b}_{44} = \left[\begin{matrix}{B}_{11} & {B}_{12} & {B}_{13} & {B}_{14} \\ {B}_{21} & {B}_{22} & {B}_{23} & {B}_{24} \\ {B}_{31} & {B}_{32} & {B}_{33} & {B}_{34} \\ {B}_{41} & {B}_{42} & {B}_{43} & {B}_{44}\end{matrix}\right] .$$

Then, in an example, both the left multiply matrix and the right multiply matrix may be divided into matrices of 2×2. It is required to be explained that the above way of partitioning is just an example of the present disclosure, and other ways of partitioning may be adopted. The present disclosure does not limit this.

FIGS. 1-6 shows an example of dividing a matrix according to an embodiment of the present disclosure. As shown in FIGS. 1-6, both the left multiply matrix and the right multiply matrix may be divided into sub-matrices of 2×2. Four first matrices obtained after dividing the left multiply matrix are a₁₁, a₁₂, a₂₁, and a₂₂, where a₁₁ is

$$\left[\begin{matrix}{\text{A}}_{\text{11}} & {\text{A}}_{\text{12}} \\ {\text{A}}_{\text{21}} & {\text{A}}_{\text{22}}\end{matrix}\right]$$

, a₁₂ is

$$\left[\begin{matrix}{\text{A}}_{\text{13}} & {\text{A}}_{\text{14}} \\ {\text{A}}_{\text{23}} & {\text{A}}_{\text{24}}\end{matrix}\right]$$

, a₂₁ is

$$\left[\begin{matrix}{\text{A}}_{\text{31}} & {\text{A}}_{\text{32}} \\ {\text{A}}_{\text{41}} & {\text{A}}_{\text{42}}\end{matrix}\right]$$

, and a₂₂ is

$$\left[\begin{matrix}{\text{A}}_{\text{33}} & {\text{A}}_{\text{34}} \\ {\text{A}}_{\text{43}} & {\text{A}}_{\text{44}}\end{matrix}\right]$$

. Four second matrices obtained after dividing the right multiply matrix are b₁₁, b₁₂, b_{21,} and b₂₂, where b₁₁ is

$$\left[\begin{matrix}{\text{B}}_{\text{11}} & {\text{B}}_{\text{12}} \\ {\text{B}}_{\text{21}} & {\text{B}}_{\text{22}}\end{matrix}\right]$$

, b₁₂ is

$$\left[\begin{matrix}{\text{B}}_{\text{13}} & {\text{B}}_{\text{14}} \\ {\text{B}}_{\text{23}} & {\text{B}}_{\text{24}}\end{matrix}\right]$$

, b₂₁ is

$$\left[\begin{matrix}{\text{B}}_{\text{31}} & {\text{B}}_{\text{32}} \\ {\text{B}}_{\text{41}} & {\text{B}}_{\text{42}}\end{matrix}\right]$$

, and b₂₂ is

$$\left[\begin{matrix}{\text{B}}_{\text{33}} & {\text{B}}_{\text{34}} \\ {\text{B}}_{\text{43}} & {\text{B}}_{\text{44}}\end{matrix}\right]$$

.

Taking a case where the second intermediate results are calculated by adopting processes of steps S1-11 to S1-13 as an example, assuming that the processing elements constitute the array of 2×2, taking the example shown in FIGS. 1-6 as an example, for the operation method of the present disclosure, the first matrices may be loaded, and a result of loading is as shown in Table 1-1. Each of RegO, Reg1, Reg2, and Reg3 represents one group of registers in the processing elements. The processing elements constitute the array of 2×2, and each processing element includes a plurality of registers. When storing data, registers located in a same group may store one first matrix, as shown in Table 1-1.

In a possible implementation, the first matrices and the corresponding second matrices may be processed according to a method used in the step S1-12: Reg0 is used to store a₁₁, and a first column of b₁₁ is stored to registers of processing elements where both a first row and a second row of a₁₁ are located; Reg1 is used to store a₁₂, and a first column of b₂₁ is stored to registers of processing elements where both a first row and a second row of a₁₂ are located; Reg2 is used to store a₂₁, and a first column of b₁₂ is stored to registers of processing elements where both a first row and a second row of a₂₁ are located; and Reg3 is used to store

a₂₂, and a first column of b₂₂ is stored to registers of processing elements where both a first row and a second row of a₂₂ are located, as shown in Table 1-2.

Then, the controller in the processor may control the processing elements to take products of the elements stored in the corresponding registers respectively to obtain the element products. Then, the controller in the processor may sum element products of each row to obtain the first intermediate results (for specific processes, reference may be made to the aforementioned example, which will not be repeated). For second columns of b₁₁, b₁₂, b_{21,} and b₂₂, a similar method may be adopted to store, take products to obtain the element products, and sum the element products by row to obtain the first intermediate results. By processing the first intermediate results, second intermediate results including a₁₁ × b₁₁, a₁₂ × b_{21,} a₂₁ × b₁₂, and a₂₂ × b₂₂ may be obtained.

TABLE 1-1

Element Storage Example

| Reg0 | | Reg1 | |
|---|---|---|---|
| A₁₁ | A₁₂ | A₁₃ | A₁₄ |
| A₂₁ | A₂₂ | A₂₃ | A₂₄ |
| Reg2 | | Reg3 | |
| A₃₁ | A₃₂ | A₃₃ | A₃₄ |
| A₄₁ | A₄₂ | A₄₃ | A₄₄ |

TABLE 1-2

Element Storage Example

| Reg0 | | Reg1 | |
|---|---|---|---|
| B₁₁ | B₂₁ | B₃₁ | B₄₁ |
| B₁₁ | B₂₁ | B₃₁ | B₄₁ |
| Reg2 | | Reg3 | |
| B₁₃ | B₂₃ | B₃₃ | B₄₃ |
| B₁₃ | B₂₃ | B₃₃ | B₄₃ |

In other words, during a calculating process, for elements in each group of registers, the controller may control the processing elements to obtain the second intermediate results including a₁₁ ×b₁₁, a₁₂ × b_{21,} a₂₁ × b₁₂, and a₂₂ × b₂₂ by calculating. Specific processes will not be repeated herein. According to the second intermediate results including a₁₁ × b₁₁, a₁₂ × b_{21,} a₂₁ × b₁₂, and a₂₂ × b₂₂, the controller may control the processing elements to obtain C₁₁=a₁₁ × b₁₁ + a₁₂ × b_{21,} and C₂₂=a₂₁ × b₁₂ + a₂₂ × b₂₂ by calculating.

According to the above process, the controller may further control the processing elements to obtain second intermediate results including a₁₁ ×b₁₂, a₁₂ × b₂₂, a₂₁ × b₁₁, and a₂₂ × b₂₁ by calculating according to the steps S1-11 to S1-13: a first column of b₁₁ is stored to registers of processing elements where both a first row and a second row of a₂₁ are located; a first column of b₂₁ is stored to registers of processing elements where both a first row and a second row of a₂₂ are located; a first column of b₁₂ is stored to registers of processing elements where both a first row and a second row of a₁₁ are located; a first column of b₂₂ is stored to registers of processing elements where both a first row and a second row of a₁₂ are located; then, the controller in the processor controls the processing elements to take products of the elements stored in the corresponding registers respectively to obtain the element products, and then the controller in the processor sums element products of each row to obtain the first intermediate results; and for second columns of b₁₁, b₁₂, b_{21,} and b₂₂, a similar method may be adopted to store, take products, and sum the element products by row to obtain the first intermediate results, and by processing the first intermediate results, second intermediate results including a₁₁ ×b₁₂, a₁₂ × b₂₂, a₂₁ × b₁₁, and a₂₂ × b₂₁ may be obtained. According to the second intermediate results including a₁₁ ×b₁₂, a₁₂ × b₂₂, a₂₁ × b₁₁, and a₂₂ × b_{21,} C₁₂=a₁₁ × b₁₂ + a₁₂ × b₂₂, and C₂₁=a₂₁ × b₁₁ + a₂₂ × b₂₁ may be obtained by calculating.

In another possible implementation, as shown in Table 1-3, in the step S1-12, the controller may further store a first column of b₁₁ to registers of processing elements where both a first row and a second row of a₁₁ are located and to registers of processing elements where both a first row and a second row of a₂₁ are located. The controller may further store a first column of b₂₁ to registers of processing elements where both a first row and a second row of a₁₂ are located and to registers of processing elements where both a first row and a second row of a₂₂ are located.

TABLE 1-3

Element Storage Example

| Reg0 | | Reg1 | |
|---|---|---|---|
| ^{B}11 | ^{B}21 | ^{B}31 | ^{B}41 |
| ^{B}11 | ^{B}21 | ^{B}31 | ^{B}41 |
| Reg2 | | Reg3 | |
| ^{B}11 | ^{B}21 | ^{B}31 | ^{B}41 |
| ^{B}11 | ^{B}21 | ^{B}31 | ^{B}41 |

For the example of Table 1-3, the controller in the processor may control the processing elements to take the products of the elements stored in the corresponding registers respectively to obtain the element products. Then, the controller in the processor may sum element products of each row to obtain the first intermediate results. For second columns of b₁₁ and b₂₁, a similar method may be adopted to store, take products to obtain the element products, and sum the element products by row to obtain the first intermediate results. The controller may control the processing elements to obtain second intermediate results including a₁₁ x b₁₁, a₁₂ _{X} b₂₁, a₂₁ x b₁₁, and a₂₂ × b₂₁ by calculating according to the first intermediate results.

For b₁₂ and b₂₂, the above process may be repeated to obtain second intermediate results including a₁₁ x b₁₂, a₁₂ × b₂₂, a₂₁ × b₁₂, and a₂₂ × b₂₂. Specific processes will not be repeated herein.

According to the second intermediate results, the products of the input matrix may be obtained by calculating.

According to the above process, a way of partitioning may be adopted to obtain the products of the input matrix by calculating. Therefore, according to the operation method of matrix multiplication of the present disclosure, a matrix operation with any size may be implemented. Moreover, compared with matrix multiplication operations in related technologies, the number of times of memory accesses may be decreased, bandwidth pressure may be reduced, and operation efficiency may be improved.

It is required to be explained that for the sake of conciseness, the foregoing method embodiments are all described as a series of processing of actions, but those skilled in the art should know that the present disclosure is not limited by the described order of actions since some steps may be performed in a different order or simultaneously according to the present disclosure. Secondly, those skilled in the art should also understand that the embodiments described in the specification are all optional, and the actions and modules involved are not necessarily required for the present disclosure.

It should be further explained that, although steps in the flowchart are shown by following the direction of arrows, these steps may not necessarily be performed according to the order indicated by the arrows. Unless clearly stated herein, the order for performing these steps is not strictly restricted, and these steps may be performed in a different order. Additionally, at least part of the steps shown in the flowchart may include a plurality of sub-steps or a plurality of stages. These sub-steps or stages may not necessarily be performed and completed at the same time; instead, these sub-steps or stages may be performed at different time. These sub-steps or stages may not necessarily be performed sequentially either; instead, these sub-steps or stages may be performed in turn or alternately with at least part of other steps, or sub-steps of other steps, or stages of other steps.

The present disclosure also provides a processor. FIG. 1-1 is an exemplary processor. The processor may include two or more processing elements arranged in the form of a two-dimensional matrix. Each processing element may include at least one register. The processor may be used to implement a matrix multiplication operation on a first matrix and a second matrix.

In a possible implementation, the processor may further include a controller, which is used to load the first matrix into registers of the processing elements.

For each row of the second matrix, the controller is used to store elements in each row of the second matrix to registers of processing elements storing elements of each column of the first matrix, obtain products of the elements in each row of the second matrix and the elements of each column of the first matrix respectively, and sum products of one column to obtain a first intermediate result. Or for each column of the second matrix, the controller is used to store elements in each column of the second matrix to registers of processing elements storing elements of each row of the first matrix, obtain products of the elements in each column of the second matrix and the elements of each row of the first matrix respectively, and sum products of one row to obtain the first intermediate result.

The controller is further used to process first intermediate results to obtain a product of the first matrix and the second matrix.

The first matrix may be one of a plurality of first matrices obtained after partitioning a to-be-loaded matrix, and the to-be-loaded matrix may be a left multiply matrix or a right multiply matrix. Another matrix in an input matrix besides the to-be-loaded matrix may be the second matrix.

The first matrix may also not be the matrix after partitioning. For example, the first matrix may be the left multiply matrix or the right multiply matrix in the input matrix, and the second matrix may be another matrix in the input matrix.

In other words, in a possible implementation, the controller of the processor of the present disclosure may also determine a matrix that is not required to be partitioned from the input matrix as the first matrix and determine another matrix in the input matrix as the second matrix according to arrangements of the processing elements. The input matrix includes the left multiply matrix and the right multiply matrix.

In a possible implementation, the first matrix is the left multiply matrix, and the second matrix is the right multiply matrix. For elements of each column of the second matrix, the controller is used to store each of the elements of each column of the second matrix to registers of processing elements storing elements of one corresponding column of the first matrix, control each processing element to perform multiplication operations on elements in corresponding registers to obtain element products, and sum element products of each row to obtain the first intermediate results. The elements of the column of the first matrix corresponding to each of the elements of each column of the second matrix mean that a row number of the element in the second matrix is the same as a column number of the elements of the column of the first matrix.

In another possible implementation, the first matrix is the right multiply matrix, and the second matrix is the left multiply matrix. For elements of each row of the second matrix, the controller is used to store each of the elements of each row of the second matrix to registers of processing elements storing elements of one corresponding row of the first matrix, control each processing element to perform the multiplication operations on the elements in the corresponding registers to obtain the element products, and sum element products of each column to obtain the first intermediate results. The elements of the row of the first matrix corresponding to each of the elements of each row of the second matrix mean that a column number of the element in the second matrix is the same as a row number of the elements of the row.

For the above two implementations, for specific examples of not partitioning, reference may be made to the above description of the operation method, which will not be repeated herein.

In another possible implementation, the controller is further used to determine the to-be-loaded matrix from the input matrix, where the input matrix includes the left multiply matrix and the right multiply matrix, and the to-be-loaded is the left multiply matrix or the right multiply matrix. According to arrangements of the processing elements, a row rank of the to-be-loaded matrix, and a column rank of the to-be-loaded matrix, the controller is further used to determine whether to partition the to-be-loaded matrix. If it is determined to partition the to-be-loaded matrix, the controller is used to partition the to-be-loaded matrix to obtain two or more first matrices according to the arrangements of the processing elements, the row rank of the to-be-loaded matrix, and the column rank of the to-be-loaded matrix.

In this implementation, the controller is further used to partition another matrix in the input matrix besides the to-be-loaded matrix to obtain two or more second matrices according to a way of partitioning the to-be-loaded matrix. In this implementation, the processor includes a plurality of groups of registers. After partitioning the input matrix, the controller is further used to store the two or more first matrices in stacks in the plurality of groups of registers, where each group stores one first matrix. In this implementation, according to products of the first matrices and corresponding second matrices, based on rules of matrix multiplication, the controller may further calculate a product of the left multiply matrix and the right multiply matrix.

For the above specific examples of partitioning, reference may be made to the above descriptions of FIGS. 1-5 and FIGS. 1-6, which will not be repeated herein.

In an embodiment of the present disclosure, an artificial intelligence chip is also provided. The chip includes the aforementioned processor.

In a possible implementation, a board card is also disclosed. The board card includes a storage component, an interface apparatus, a control component, and the aforementioned artificial intelligence chip. The artificial intelligence chip is connected to the storage component, the control component, and the interface apparatus, respectively. The storage component is used to store data. The interface apparatus is used to implement data transfer between the artificial intelligence chip and an external device. The control component is used to monitor a state of the artificial intelligence chip.

The foregoing may be better understood according to the following articles:
Article A1. An operation method of matrix multiplication based on a processing element matrix, which is applied to a processor, where the processor includes two or more processing elements arranged in the form of a two-dimensional matrix, each processing element includes at least one register, the method implements a matrix multiplication operation on a first matrix and a second matrix, and
the method includes:
   loading the first matrix into registers of processing elements;
   for each row of the second matrix, storing elements in each row of the second matrix to registers of processing elements storing elements of each column of the first matrix, obtaining products of the elements in each row of the second matrix and the elements of each column of the first matrix respectively, and summing products of one column to obtain a first intermediate result; or for each column of the second matrix, storing elements in each column of the second matrix to registers of processing elements storing elements of each row of the first matrix, obtaining products of the elements in each column of the second matrix and the elements of each row of the first matrix respectively, and summing products of one row to obtain the first intermediate result; and
   processing first intermediate results to obtain a product of the first matrix and the second matrix.
Article A2. The method of article A1, where the first matrix is a left multiply matrix, and the second matrix is a right multiply matrix;
   for elements of each column of the second matrix, each of the elements of each column of the second matrix is stored to registers of processing elements storing elements of one corresponding column of the first matrix, each processing element is controlled to perform multiplication operations on elements in corresponding registers to obtain element products, and element products of each row are summed to obtain the first intermediate results, where
   the elements of the column of the first matrix corresponding to each of the elements of each column of the second matrix mean that a row number of the element in the second matrix is the same as a column number of the elements of the column.
Article A3. The method of article A1, where the first matrix is a right multiply matrix, and the second matrix is a left multiply matrix;
   for elements of each row of the second matrix, each of the elements of each row of the second matrix is stored to registers of processing elements storing elements of one corresponding row of the first matrix, each processing element is controlled to perform multiplication operation on elements in corresponding registers to obtain element products, and element products of each column are summed to obtain the first intermediate results, where
   the elements of the row of the first matrix corresponding to each of the elements of each row of the second matrix mean that a column number of the element in the second matrix is the same as a row number of the elements of the row.
Article A4. The method of any one of articles A1-A3, further including:
   according to arrangements of the processing elements, determining a matrix that is not required to be partitioned from an input matrix as the first matrix, and determining another matrix in the input matrix as the second matrix.
Article A5. The method of any one of articles A1-A3, further including:
   determining a to-be-loaded matrix from an input matrix, where the input matrix includes the left multiply matrix and the right multiply matrix, and the to-be-loaded is the left multiply matrix or the right multiply matrix;
   determining whether to partition the to-be-loaded matrix according to arrangements of the processing elements, a row rank of the to-be-loaded matrix, and a column rank of the to-be-loaded matrix, where the to-be-loaded matrix is the left multiply matrix or the right multiply matrix; and
   if it is determined to partition the to-be-loaded matrix, partitioning the to-be-loaded matrix to obtain two or more first matrices according to the arrangements of the processing elements, the row rank of the to-be-loaded matrix, and the column rank of the to-be-loaded matrix.
Article A6. The method of article A5, further including:
   according to a way of partitioning the to-be-loaded matrix, partitioning another matrix in the input matrix besides the to-be-loaded matrix to obtain two or more second matrices; and
   according to products of the first matrices and corresponding second matrices, based on rules of matrix multiplication, calculating a product of the left multiply matrix and the right multiply matrix.
Article A7. The method of article A5, where the processor includes a plurality of groups of registers, and the method further includes:
   after partitioning the input matrix, storing the two or more first matrices in stacks in the plurality of groups of registers, where each group stores one first matrix.
Article A8. A processor, where the processor includes two or more processing elements arranged in the form of a two-dimensional matrix, each processing element includes at least one register, and the processor is used to perform a matrix multiplication operation on a first matrix and a second matrix;
   the processor further includes a controller, which is used to load the first matrix into registers of the processing elements;
   for each row of the second matrix, the controller is used to store elements in each row of the second matrix to registers of processing elements storing elements of each column of the first matrix, obtain products of the elements in each row of the second matrix and the elements of each column of the first matrix respectively, and sum products of one column to obtain a first intermediate result; or for each column of the second matrix, the controller is used to store elements in each column of the second matrix to registers of processing elements storing elements of each row of the first matrix, obtain products of the elements in each column of the second matrix and the elements of each row of the first matrix respectively, and sum products of one row to obtain the first intermediate result; and
   the controller is further used to process first intermediate results to obtain a product of the first matrix and the second matrix.
Article A9. The processor of article A8, where the first matrix is a left multiply matrix, and the second matrix is a right multiply matrix;
   for elements of each column of the second matrix, the controller is used to store each of the elements of each column of the second matrix to registers of processing elements storing elements of one corresponding column of the first matrix, control each processing element to perform multiplication operations on elements in corresponding registers to obtain element products, and sum element products of each row to obtain the first intermediate results, where
   the elements of the column of the first matrix corresponding to each of the elements of each column of the second matrix mean that a row number of the element in the second matrix is the same as a column number of the elements of the column.
Article A10. The processor of article A8, where the first matrix is a right multiply matrix, and the second matrix is a left multiply matrix;
   for elements of each row of the second matrix, the controller is used to store each of the elements of each row of the second matrix to registers of processing elements storing elements of one corresponding row of the first matrix, control each processing element to perform multiplication operations on elements in corresponding registers to obtain element products, and sum element products of each column to obtain the first intermediate results, where
   the elements of the row of the first matrix corresponding to each of the elements of each row of the second matrix mean that a column number of the element in the second matrix is the same as a row number of the elements of the row.
Article A11. The processor of any one of articles A8-A10, where the processor is further used to determine a matrix that is not required to be partitioned from an input matrix as the first matrix and determine another matrix from the input matrix as the second matrix according to arrangements of the processing elements, where the input matrix includes the left multiply matrix and the right multiply matrix.
Article A12. The processor of any one of articles A8-A10, where the controller is further used to determine a to-be-loaded matrix from an input matrix, where the input matrix includes the left multiply matrix and the right multiply matrix, and the to-be-loaded matrix is the left multiply matrix or the right multiply matrix; according to arrangements of the processing elements, a row rank of the to-be-loaded matrix, and a column rank of the to-be-loaded matrix, the controller is further used to determine whether to partition the to-be-loaded matrix; and
if it is determined to partition the to-be-loaded matrix, the controller is used to partition the to-be-loaded matrix to obtain two or more first matrices according to the arrangements of the processing elements, the row rank of the to-be-loaded matrix, and the column rank of the to-be-loaded matrix.
Article A13. The processor of article A12, where the controller is further used to partition another matrix in the input matrix besides the to-be-loaded matrix to obtain two or more second matrices according to a way of partitioning the to-be-loaded matrix; and according to products of the first matrices and corresponding second matrices, based on rules of matrix multiplication, the controller is further used to calculate a product of the left multiply matrix and the right multiply matrix.
Article A14. The processor of article A12, where the processor includes a plurality of groups of registers, and after partitioning the input matrix, the controller is further used to store the two or more first matrices in stacks in the plurality of groups of registers, where each group stores one first matrix.
Article A15. An artificial intelligence chip, including the processor of any one of articles A8-A14.
Article A16. An electronic device, including the artificial intelligence chip of article A15.

During a process of processing information by means of artificial intelligence, a matrix operation may occupy a relatively large calculating amount. Moreover, during a process of processing the matrix operation, splitting the matrix operation into a multiplication operation and an addition operation by an existing processor requires reading data from a memory frequently, resulting in very low operation efficiency.

In order to solve the aforementioned technical problems, the present disclosure provides an operation method and a processor for performing the operation method. The processor may include a plurality of processing elements (two or more processing elements). These processing elements may be arranged in the form of a two-dimensional matrix, and each processing element may include at least one register.

FIGS. 2-1 is a schematic diagram of a processor according to an embodiment of the present disclosure. As shown in FIGS. 2-1, a plurality of processing elements (PE) may be arranged in the form of a two-dimensional matrix. Each processing element may be connected to adjacent processing elements. Each PE may be configured with at least one register (which is not shown in the figure). The processor may further include a controller and a memory, where both the controller and the memory may be connected to the plurality of processing elements, and the controller may be connected to the memory. The controller may be used to load input data into registers of processing elements from the memory and control the processing elements to process the input data. For example, the memory may store a first matrix and a second matrix. The processor may be used to perform a matrix multiplication operation on the first matrix and the second matrix. Therefore, the controller may load the first matrix and the second matrix into the registers of the processing elements and control the processing elements to perform the matrix multiplication operation.

In a possible implementation, the memory may further store an executable program. The executable program may include an instruction. By executing the instruction, the matrix multiplication operation on the first matrix and the second matrix may be implemented. The controller may be configured with a loader and a decoder. The loader may be used to load input data in the memory into the registers of the processing elements, and the decoder may decode an instruction for accessing data in the executable program according to storage addresses of the input data after loading. For example, for the instruction for accessing data, storage addresses of the data in the registers obtained by decoding may be assigned to the instruction for accessing data and the decoded instruction may be sent to the processing elements, and the processing elements execute the instruction, thus implementing processing on the data, such as the matrix multiplication operation on the first matrix and the second matrix.

In a possible implementation, the memory may be an on-chip caching unit. The controller may load an executable program and input data (such as an input matrix, including a left multiply matrix and a right multiply matrix) on an off-chip flash memory into the aforementioned memory (the on-chip caching unit). Then, the controller may perform subsequent processes of the matrix multiplication operation.

In a possible implementation, the controller may also load the input matrix and the executable program from the off-chip memory into the registers of the processing elements directly, which is not limited in the present disclosure.

The PE may further include an operator for completing a specified operation. Taking a matrix operation as an example, the PE may include, for example, a multiplier and an adder. Specific structures of each PE may be the same or different. The present disclosure does not limit this. The PE may further include other types of operators to adapt to various different operation processes. The present disclosure does not limit the number and type of operators included in the PE.

The input matrix of the matrix multiplication operation may include the left multiply matrix and the right multiply matrix. The left multiply matrix may refer to a matrix located in a left side of a multiplication sign, and the right multiply matrix may refer to a matrix located in a right side of the multiplication sign.

Since the number and arrangements of the processing elements in the processor are fixed, before loading data into the registers of the processing elements and calculating, the controller may determine whether to partition the input matrix according to arrangements of the processing elements, a row rank of the input matrix, and a column rank of the input matrix. The arrangements of the processing elements may refer to a row number of the processing elements and a column number of the processing elements. The row rank of the input matrix may refer to a row number of the left multiply matrix and a row number of the right multiply matrix. The column rank of the input matrix may refer to a column number of the left multiply matrix and a column number of the right multiply matrix.

Determining whether to partition the input matrix by the controller according to the arrangements of the processing elements, the row rank of the input matrix, and the column rank of the input matrix may mean that: the controller judges whether a row number of the input matrix or a row number of a transposed matrix of the input matrix is greater than the row number of the processing elements and whether a column number of the input matrix or a column number of the transposed matrix of the input matrix is greater than the column number of the processing elements, and the controller determines whether to partition the input matrix according to a result of judging.

If a row number of one matrix in the input matrix is not greater than the row number of the processing elements and a column number of the matrix is not greater than the column number of the processing elements, and a row number of a transposed matrix of another matrix in the input matrix is not greater than the row number of the processing elements and a column number of the transposed matrix of the matrix is not greater than the column number of the processing elements, then, the controller may not partition the input matrix.

If a row number of any matrix in the input matrix is greater than the row number of the processing elements or a column number of any matrix in the input matrix is greater than the column number of the processing elements, or a row number of a transposed matrix of any matrix in the input matrix is greater than the row number of the processing elements or a column number of the transposed matrix of any matrix in the input matrix is greater than the column number of the processing elements, then, the controller may partition the input matrix.

For example, it is assumed that an array composed of the processing elements may be expressed as PE_{MN}, which represents that the processing elements constitute an array of M_{X}N. M represents a row number of the matrix, and N represents a column number of the matrix. It is assumed that an input matrix is Aₘₙ representing a matrix of m×n, where m represents a row number of the matrix, and n represents a column number of the matrix. Another input matrix is Bₙₖ representing a matrix of n_{X}k, where n represents a row number of the matrix, and k represents a column number of the matrix. If a row number m of the matrix Aₘₙ is not greater than a row number M of the processing elements and a column number n of the matrix is not greater than a column number N of the processing elements, and a row number k of a transposed matrix

$${\text{B}}_{\text{nk}}^{\text{T}}$$

of Bₙₖ is not greater than the row number M of the processing elements and a column number n of the transposed matrix is not greater than the column number N of the processing elements, then, the controller may not partition the input matrix. In other words, if a row number n of a transposed matrix

$${\text{A}}_{\text{mn}}^{\text{T}}$$

of Aₘₙ is not greater than the row number M of the processing elements and a column number m of the transposed matrix is not greater than the column number N of the processing elements, and a row number n of Bₙₖ is not greater than the row number M of the processing elements and a column number k of the matrix is not greater than the column number N of the processing elements, then, the controller may not partition the input matrix.

If the row number m of the matrix Aₘₙ is greater than the row number M of the processing elements or the column number n of the matrix is greater than the column number M of the processing elements, or the row number k of the transposed matrix

$${\text{B}}_{\text{nk}}^{\text{T}}$$

of the matrix Bₙₖ is greater than the row number M of the processing elements or the column number n of the transposed matrix is greater than the column number N of the processing elements, then, the controller may partition the input matrix. Or if the row number n of

$${\text{A}}_{\text{mn}}^{\text{T}}$$

is greater than the row number M of the processing elements or the column number m of the matrix is greater than the column number N of the processing elements, or the row number n of Bₙₖ is greater than the row number M of the processing elements or the column number k of the matrix is greater than the column number N of the processing elements, then, the controller may partition the input matrix.

If it is determined to partition one matrix in the input matrix, the controller may split rows of the left multiply matrix or split columns of the right multiply matrix according to arrangements of the processing elements.

For example, assuming that an array composed of the processing elements is PE₂₂, the left multiply matrix is A₃₂, and the right multiply matrix is B₂₂, then, A₃₂ may be split into A₁₂ and A₂₂ to be multiplied with B₂₂, respectively. If the left multiply matrix is A₂₂, and the right multiply matrix is B₃₂, then, B₃₂ may be split into B₁₂ and B₂₂.

If it is determined to partition two matrices in the input matrix, the controller may partition the left multiply matrix in column direction and partition the right multiply matrix in row direction in the same way according to the arrangements of the processing elements, the row rank of the input matrix, and the column rank of the input matrix.

In other words, the left multiply matrix and the transposed right multiply matrix may be partitioned in column direction in the same way. Or the transposed left multiply matrix and the right multiply matrix may be partitioned in row direction in the same way. The same way of division means that a column number of a first matrix obtained after dividing is the same as a column number of a second matrix obtained after dividing, or a row number of the first matrix obtained after dividing is the same as a row number of the second matrix obtained after dividing, so as to ensure that the matrix operation may be completed normally.

It is assumed that by partitioning the left multiply matrix, two or more first matrices may be obtained, and by partitioning the right multiply matrix, two or more second matrices may be obtained. Or it is assumed that by partitioning the right multiply matrix, two or more first matrices may be obtained, and by partitioning the left multiply matrix, two or more second matrices may be obtained.

According to the arrangements of the processing elements, the row rank of the input matrix, and the column rank of the input matrix, partitioning the left multiply matrix in column direction and partitioning the right multiply matrix in row direction may be performed in the same way. Both the first matrices obtained after partitioning and the second matrices obtained after partitioning are required to meet conditions of not requiring partitioning again. In other words, both the row number of the first matrix and the row number of the transposed matrix of the second matrix are not greater than the row number of the processing elements, and both the column number of the first matrix and the column number of the transposed matrix of the second matrix are not greater than the column number of the processing elements. Or both the row number of the transposed matrix of the first matrix and the row number of the second matrix are not greater than the row number of the processing elements, and both the column number of the transposed matrix of the first matrix and the column number of the second matrix are not greater than the column number of the processing elements.

In a possible implementation, the controller may perform division in such a way that the row rank of the divided first matrix or the divided second matrix is as close as possible to the row number of the processing elements, and the column rank of the divided first matrix or the divided second matrix is as close as possible to the column number of the processing elements. As such, efficiency of the operation may be improved, and operation time may be reduced. In other words, assuming that the processing elements constitute an array of 4×4, then, division may be performed in such a way that the divided matrices are 4x4 first. As such, the processing elements may be utilized with maximum efficiency, and operation efficiency may be improved.

For example, it is assumed that the processing elements constitute an array of 2×2, one input matrix is a matrix of 2×4, and another input matrix is a matrix of 4×3. There are many ways of division. FIG. 2-2a and FIG. 2-2b respectively show a plurality of different ways of division. Partitioning a matrix A₂₄ in column direction and partitioning a matrix B₄₃ in row direction may be performed in the same way. FIG. 2-2a is an example of division. The matrix A₂₄ is divided into two parts in column direction, and each part includes two columns. The matrix B₄₃ is divided into two parts in row direction, and each part includes two rows. FIG. 2-2b is another example of division. The matrix A₂₄ is divided into three parts in column direction, where one part includes two columns, and other two parts each includes one column. The matrix B₄₃ is divided into three parts in row direction, where one part includes two rows, and other two parts each includes one row. The aforementioned arrangements of the processing elements and the aforementioned ways of dividing the input matrix are just examples of the present disclosure and do not limit the present disclosure in any way.

The present disclosure does not limit the way of dividing the left multiply matrix in row direction and the way of dividing the right multiply matrix in column direction, as long as the divided matrices satisfy conditions of not requiring partitioning again.

According to operation rules of matrix multiplication, products of elements in the rows of the left multiply matrix and elements in the columns of the right multiply matrix may be obtained one by one, and then the products may be summed. Therefore, in a possible implementation, for a case of not partitioning, or for the partitioned first matrix and the corresponding partitioned second matrix, the controller is used to load each element in the transposed matrix of the first matrix and each element in the second matrix into registers of each processing element respectively. An element in the transposed matrix and an element in a corresponding position of the second matrix are stored in registers of a same processing element. According to rules of matrix multiplication, the element in the transposed matrix may be an element that is required to perform the multiplication operation in the transposed matrix, and the element in the corresponding position of the second matrix may be an element that is required to perform the multiplication operation in the second matrix.

In a possible implementation, the controller may transpose the first matrix to obtain the transposed matrix first, and then the controller may load elements in the transposed matrix into the registers of each processing element. In another possible implementation, the controller may also transpose the first matrix during a process of loading. For example, assuming that the first matrix is the right multiply matrix, then, during a process of loading elements in the first matrix into the registers of the processing elements, the controller may load elements of one column of the first matrix into registers of one row of processing elements to transpose the first matrix.

In a possible implementation, the transposed matrix and the second matrix are aligned in row direction or in column direction. Specifically, if the left multiply matrix is transposed, then, after loading, rows of the transposed matrix of the first matrix are aligned with the second matrix in column direction. In other words, in column direction, the transposed matrix is aligned with rows of the second matrix. If the right multiply matrix is transposed, then, after loading, columns of the transposed matrix are aligned with the second matrix in row direction. In other words, in row direction, the transposed matrix is aligned with columns of the second matrix.

After loading the transposed matrix and the second matrix, the controller is further used to control elements in the transposed matrix or elements in the second matrix to roll in row direction or in column direction. The controller is further used to control the processing elements to perform multiplication operations on elements in corresponding registers to obtain element products. The controller is further used to sum element products of a same row or element products of a same column to obtain first intermediate results. Specifically, the controller may control the processing elements, the transposed matrix stored in the registers, and the second matrix stored in the registers to repeat the following process until the elements in the transposed matrix or the elements in the second matrix return to unrolled positions: the controller may control the processing elements to perform the multiplication operations on the elements in the corresponding registers to obtain the element products and sum the element products of the same row or the element products of the same column to obtain the first intermediate results, and the controller may control the transposed matrix stored in the registers or the second matrix stored in the registers to roll by one row or by one column in row direction or in column direction.

In other words, the processing elements may be controlled to perform the multiplication operations on the elements in the corresponding registers to obtain the element products first, and the element products of the same row or the element products of the same column may be summed to obtain the first intermediate results. Then, the elements in the transposed matrix or the elements in the second matrix may be controlled to roll by one row or by one column in row direction or in column direction. At this time, whether positions of the elements in the transposed matrix after rolling or positions of the elements in the second matrix after rolling are the same as initial positions may be judged, where the initial positions may refer to unrolled positions of the elements in the transposed matrix or unrolled positions of the elements in the second matrix. If a judging result shows that two kinds of positions are the same, then, this process ends. If the judging result shows that two kinds of positions are different, then, the processing elements may be controlled to perform the multiplication operations on the elements in the corresponding registers to obtain the element products, and the element products of the same row or the element products of the same column may be summed to obtain the first intermediate results. Then, the elements in the transposed matrix or the elements in the second matrix may be controlled to roll by one row or by one column in row direction or in column direction, and whether the positions of the elements in the transposed matrix after rolling or the positions of the elements in the second matrix after rolling are the same as the initial positions may be judged... The above process may be repeated until the positions of the elements in the transposed matrix after rolling or the positions of the elements in the second matrix after rolling are the same as the initial positions.

In an example, the first matrix is the left multiply matrix, and the second matrix is the right multiply matrix. In another example, the first matrix is the right multiply matrix, and the second matrix is the left multiply matrix.

If the first matrix is the left multiply matrix, and the second matrix is the right multiply matrix, the controller may control the elements in the transposed matrix to roll in row direction, or the controller may control the elements in the second matrix to roll in row direction. The controller may control the processing elements to perform the multiplication operations on the elements in the corresponding registers to obtain the element products. The controller may sum the element products of the same column to obtain the first intermediate results.

If the first matrix is the right multiply matrix, and the second matrix is the left multiply matrix, the controller may control the elements in the transposed matrix to roll in column direction, or the controller may control the elements in the second matrix to roll in column direction. The controller may control the processing elements to perform the multiplication operations on the elements in the corresponding registers to obtain the element products. The controller may sum the element products of the same row to obtain the first intermediate results.

In a possible implementation, the above rolling rolls one row or one column each time. Processing elements storing elements of the matrix form a closed loop. Since adjacent processing elements are connected together, therefore, the controller may determine a loop-forming way according to dimensions of the matrix. For example, if it is determined to roll by row (roll in column direction), then, a first row of processing elements storing the elements of the matrix may be connected to a last row of processing elements storing the elements of the matrix. During a process of rolling, if it is determined to roll up by one row, then, elements of a first row of the matrix may be rolled from original storage positions to positions where elements of a last row of the matrix are stored. If it is determined to roll by column (roll in row direction), then, a first column of processing elements storing the elements of the matrix may be connected to a last column of processing elements storing the elements of the matrix. During the process of rolling, if it is determined to roll to the left by one column, then, elements of a first column of the matrix may be rolled from original storage positions to positions where elements of a last column of the matrix are stored. The above connection among the processing elements may refer to a virtual connection. In other words, there is no actual connection line, but the controller may record a corresponding processor, as long as there forms the closed loop during the process of rolling.

If the elements in the transposed matrix or the elements in the second matrix return to the unrolled positions, after completing processes of rolling and calculating the first intermediate results, the controller may process the first intermediate results to obtain the product of the first matrix and the second matrix.

In a possible implementation, the controller may store the first intermediate results by row or by column. After rolling elements in the first intermediate results in row direction or in column direction, the controller may obtain the product of the first matrix and the second matrix. A specific processing way is related with the matrix for transposing and the direction of rolling. For example, if the first matrix is the right multiply matrix, and the second matrix is the left multiply matrix, in a case where the transposed matrix is rolled up in column direction, the first intermediate results may be stored by column, and the elements in the first intermediate results may be rolled to the right in row direction. For example, elements in the i-th row may be rolled to the right by i-1 step in row direction.

If the first matrix is the right multiply matrix, and the second matrix is the left multiply matrix, in a case where the transposed matrix is rolled down in column direction, the first intermediate results may be stored by column, and the elements in the first intermediate results may be rolled to the left in row direction. For example, the elements in the i-th row may be rolled to the left by i-1 step in row direction.

If the first matrix is the left multiply matrix, and the second matrix is the right multiply matrix, in a case where the transposed matrix is rolled to the left in row direction, the first intermediate results may be stored by row, and elements in the i-th column of the first intermediate results may be rolled down by i-1 step in column direction to obtain the product of the input matrix.

If the first matrix is the left multiply matrix, and the second matrix is the right multiply matrix, in a case where the transposed matrix is rolled to the right in row direction, the first intermediate results may be stored by row, and the elements in the i-th column of the first intermediate results may be rolled up by i-1 step in column direction to obtain the product of the input matrix.

In related technologies, for a matrix multiplication where a size of an input matrix is relatively large, in order to improve efficiency of the matrix operation, a multi-stage pipeline method is usually adopted to perform the operation. However, in a multi-stage pipeline, since each stage may process a part of input data, it is required to read the data from the memory frequently, and frequent memory accesses lead to high demands for a bandwidth. In order to solve the above technical problems, the processor of the present disclosure may store the input matrix in stacks after the input matrix is partitioned, and at the same time, the processor of the present disclosure may perform matrix multiplication operations on corresponding matrices after partitioning. In this way, memory access frequency may be reduced, and operation efficiency may be improved.

If the first matrices are obtained by partitioning the left multiply matrix, or the second matrices are obtained by partitioning the right multiply matrix, then, in a possible implementation, the controller is further used to calculate the product of the left multiply matrix and the right multiply matrix according to products of the first matrices and the second matrices. In other words, for the partitioned first matrices and the corresponding partitioned second matrix, the products of the first matrices and the second matrices may be calculated respectively, and then according to the products of the first matrices and the second matrices, the product of the left multiply matrix and the right multiply matrix may be calculated. As such, the memory access frequency may be reduced, and the operation efficiency may be improved.

In another possible implementation, the processor may include a plurality of groups of registers. In other words, the controller may divide the registers of the processing elements into a plurality of groups based on the partitioning of the matrix.

As such, the controller may transpose two or more first matrices to obtain transposed matrices after the controller partitions the input matrix. The controller may load the transposed matrices and two or more second matrices into the plurality of groups of registers for storing in stacks, where one group of registers stores a transposed matrix and a second matrix of a corresponding position.

Before rolling elements in the transposed matrices or elements in the second matrices once in row direction or in column direction each time, the controller may control the processing elements to perform the multiplication operations on the elements in the corresponding registers to obtain the element products, and the controller may sum the element products of the same row or the element products of the same column to obtain the first intermediate results. After controlling elements in one group of registers to roll by one row of the transposed matrix or by one column of the transposed matrix in row direction or in column direction, the controller may further correct a rolling result.

In a possible implementation, correcting the rolling result includes:
if it is determined to roll to the left in row direction, according to a correcting method, rolling data of a last column of each block of the transposed matrices after rolling to a last column of data of a previous adjacent block of the transposed matrices;
if it is determined to roll to the right in row direction, according to the correcting method, rolling data of a first column of each block of the transposed matrices after rolling to a first column of data of a later adjacent block of the transposed matrices;
if it is determined to roll up in column direction, according to the correcting method, rolling data of a last row of each block of the transposed matrices after rolling to a last row of data of a previous adjacent block of the transposed matrices; and
if it is determined to roll down in column direction, according to the correcting method, rolling data of a first row of each block of the transposed matrices after rolling to a first row of data of a later adjacent block of the transposed matrices, where each block of the transposed matrices may refer to each transposed matrix after partitioning Specific processes of calculating and correcting may be introduced in detail in the following example.

The present disclosure further provides an operation method used for implementing a matrix multiplication operation.

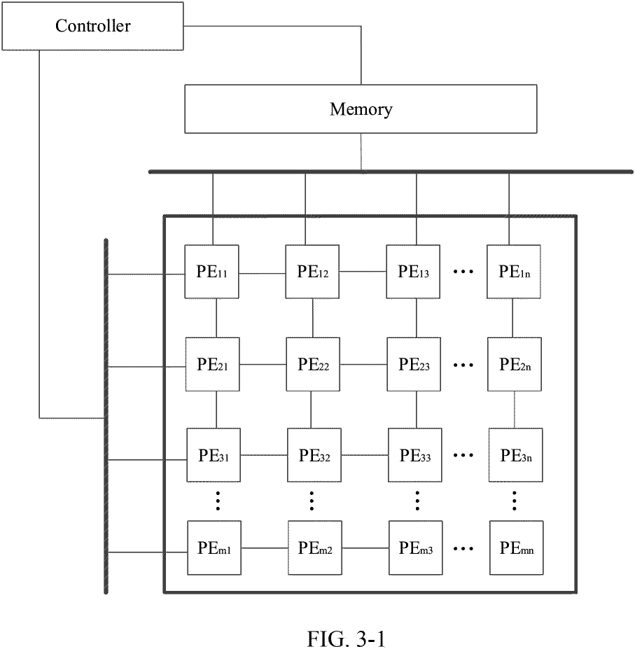

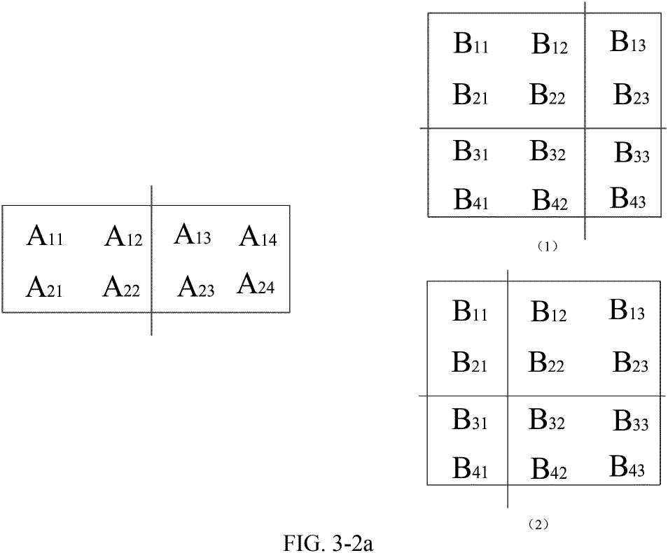

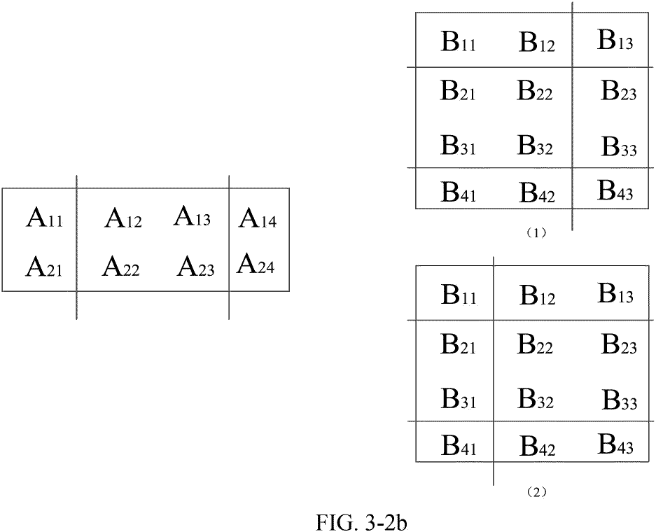

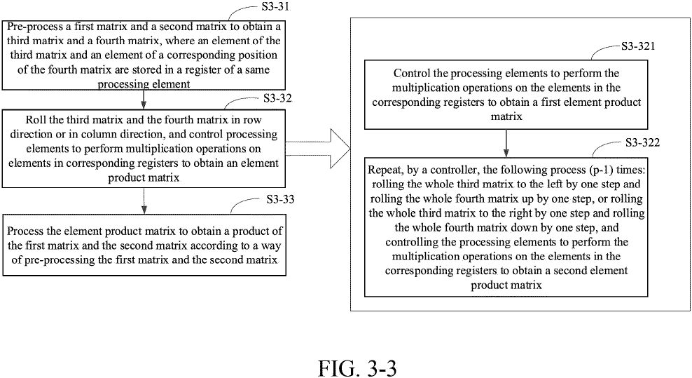

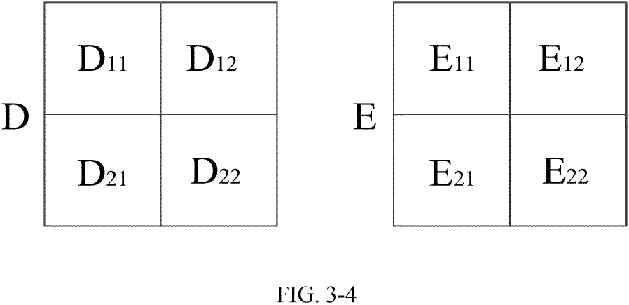

For a case of not partitioning, or for the partitioned first matrix and the partitioned second matrix, FIGS. 2-3 is a flowchart of an operation method according to an embodiment of the present disclosure. For a case of not partitioning, the left multiply matrix may be used as the first matrix directly, and the right multiply matrix may be used as the second matrix directly; or the left multiply matrix may be used as the second matrix directly, and the right multiply matrix may be used as the first matrix directly. The present disclosure does not limit this.

As shown in FIGS. 2-3, the operation method of the present disclosure may include the following steps.

In a step S2-11, the first matrix is transposed to obtain the transposed matrix, and the transposed matrix and the second matrix are loaded into registers of processing elements, where an element in the transposed matrix and an element in a corresponding position of the second matrix are stored in a register of a same processing element.

According to rules of matrix multiplication, the element in the transposed matrix may be an element that is required to perform a multiplication operation in the transposed matrix, and the element in the corresponding position of the second matrix may be an element that is required to perform a multiplication operation in the second matrix.

In a possible implementation, the transposed matrix and the second matrix are aligned in row direction or in column direction. Specifically, if the left multiply matrix is transposed, then, after loading, rows of the transposed matrix of the first matrix are aligned with the second matrix in column direction. In other words, in column direction, the transposed matrix is aligned with rows of the second matrix. If the right multiply matrix is transposed, then, after loading, columns of the transposed matrix are aligned with the second matrix in row direction. In other words, in row direction, the transposed matrix is aligned with columns of the second matrix.

In a step S2-12, the transposed matrix or the second matrix is controlled to roll in row direction or in column direction, the processing elements are controlled to perform multiplication operations on elements in corresponding registers to obtain element products, and element products of a same row or element products of a same column are summed to obtain first intermediate results.

In a possible implementation, the step S2-12 may specifically include repeating the following process until elements in the transposed matrix or elements in the second matrix return to unrolled positions: controlling the processing elements to perform the multiplication operations on the elements in the corresponding registers to obtain the element products, and summing the element products of the same row or the element products of the same column to obtain the first intermediate results; and in the matrix of the processing elements, rolling the transposed matrix or the second matrix by one row or by one column in row direction or in column direction.

In a step S2-13, the first intermediate results are processed to obtain a product of the first matrix and the second matrix.

In other words, for the step S2-12 and the step S2-13, the processing elements may be controlled to perform the multiplication operations on the elements in the corresponding registers to obtain the element products first, and the element products of the same row or the element products of the same column may be summed to obtain the first intermediate results. Then, the elements in the transposed matrix or the elements in the second matrix may be controlled to roll by one row or by one column in row direction or in column direction. At this time, whether positions of the elements in the transposed matrix after rolling or positions of the elements in the second matrix after rolling are the same as initial positions may be judged, where the initial positions may refer to unrolled positions of the elements in the transposed matrix or unrolled positions of the elements in the second matrix. If a judging result shows that two kinds of positions are the same, then, this process ends and the step S2-13 is performed. If the judging result shows that two kinds of positions are different, then, the processing elements may be controlled to perform the multiplication operations on the elements in the corresponding registers to obtain the element products, and the element products of the same row or the element products of the same column may be summed to obtain the first intermediate results. Then, the elements in the transposed matrix or the elements in the second matrix may be controlled to roll by one row or by one column in row direction or in column direction, and whether the positions of the elements in the transposed matrix after rolling or the positions of the elements in the second matrix after rolling are the same as the initial positions may be judged... The above process may be repeated until the positions of the elements in the transposed matrix after rolling or the positions of the elements in the second matrix after rolling are the same as the initial positions.

In an example, the first matrix is the left multiply matrix, and the second matrix is the right multiply matrix. In another example, the first matrix is the right multiply matrix, and the second matrix is the left multiply matrix.

If the first matrix is the left multiply matrix, and the second matrix is the right multiply matrix, in the step S2-12, the elements in the transposed matrix may be controlled to roll in row direction, or the elements in the second matrix may be controlled to roll in row direction. The processing elements may be controlled to perform the multiplication operations on the elements in the corresponding registers to obtain the element products. The element products of the same column may be summed to obtain the first intermediate results.

If the first matrix is the right multiply matrix, and the second matrix is the left multiply matrix, in the step S2-12, the elements in the transposed matrix may be controlled to roll in column direction, or the elements in the second matrix may be controlled to roll in column direction. The processing elements may be controlled to perform the multiplication operations on the elements in the corresponding registers to obtain the element products. The element products of the same row may be summed to obtain the first intermediate results.

In a possible implementation, the above rolling rolls one row or one column each time.

For the step S2-13, processing the first intermediate results may refer to: storing the first intermediate results by row or by column, and obtaining the product of the first matrix and the second matrix after rolling elements in the first intermediate result in row direction or in column direction. A specific processing way is related with the matrix for transposing and the direction of rolling. For example, if the first matrix is the right multiply matrix, and the second matrix is the left multiply matrix, in a case where the transposed matrix is rolled up in column direction, the first intermediate results may be stored by column, and the elements in the first intermediate results may be rolled to the right in row direction. For example, elements in the i-th row may be rolled to the right by i-1 step in row direction.

If the first matrix is the right multiply matrix, and the second matrix is the left multiply matrix, in a case where the transposed matrix is rolled down in column direction, the first intermediate results may be stored by column, and the elements in the first intermediate results may be rolled to the left in row direction. For example, the elements in the i-th row may be rolled to the left by i-1 step in row direction.

If the first matrix is the left multiply matrix, and the second matrix is the right multiply matrix, in a case where the transposed matrix is rolled to the left in row direction, the first intermediate results may be stored by row, and elements in the i-th column of the first intermediate results may be rolled down by i-1 step in column direction to obtain the product of the input matrix.

If the first matrix is the left multiply matrix, and the second matrix is the right multiply matrix, in a case where the transposed matrix is rolled to the right in row direction, the first intermediate results may be stored by row, and the elements in the i-th column of the first intermediate results may be rolled up by i-1 step in column direction to obtain the product of the input matrix.

The following will explain processes of steps S2-11 to S2-13 by taking a case where the first matrix is the right multiply matrix, and the second matrix is the left multiply matrix, and a case where the first matrix is the left multiply matrix, and the second matrix is the right multiply matrix as examples.

### Example 2-1: The First Matrix Is the Right Multiply Matrix, and the Second Matrix Is The Left Multiply Matrix; in Other Words, The Right Multiply Matrix is Transposed

It is assumed that both a first matrix bₙₖ and a second matrix aₘₙ are matrices of 3x3, and the processing elements constitute an array of 4×4.

FIGS. 2-4 is a schematic diagram of an array composed of processing elements according to an embodiment of the present disclosure. The operation method of the present disclosure may be explained in combination with FIGS. 2-4 and FIGS. 2-3. Assuming that the first matrix is

$${b}_{33} = \left[\begin{matrix}{B}_{11} & {B}_{12} & {B}_{13} \\ {B}_{21} & {B}_{22} & {B}_{23} \\ {B}_{31} & {B}_{32} & {B}_{33}\end{matrix}\right] ,$$

and the second matrix is

$${a}_{33} = \left[\begin{matrix}{A}_{11} & {A}_{12} & {A}_{13} \\ {A}_{21} & {A}_{22} & {A}_{23} \\ {A}_{31} & {A}_{32} & {A}_{33}\end{matrix}\right] ,$$

then, the transposed matrix obtained by transposing the first matrix is

$${b}_{33}^{T} = \left[\begin{matrix}{B}_{11} & {B}_{12} & {B}_{13} \\ {B}_{21} & {B}_{22} & {B}_{23} \\ {B}_{31} & {B}_{32} & {B}_{33}\end{matrix}\right] .$$

For loading the second matrix into registers of processing elements, the second matrix may be loaded into the registers of the processing elements according to arrangements of rows and columns of the second matrix. In other words, arrangements of elements of the second matrix in the matrix are the same as arrangements of the elements of the second matrix in the registers of the processing elements.

In a possible implementation, a row number and a column number of the elements of the second matrix in the matrix are the same as a row number and a column number of the processing elements loading the elements in the array composed of the processing elements.

For example, in an example, A₁₁ may be loaded into registers of PE₁₁, A₁₂ may be loaded into registers of PE₁₂, A₁₃ may be loaded into registers of PE₁₃, A₂₁ may be loaded into registers of PE₂₁ ... and A₃₃ may be loaded into registers of PE₃₃. In other words, subscripts of the elements of the second matrix may be the same as subscripts of the processing elements where the elements of the second matrix are located.

In another example, A₁₁ may be loaded into registers of PE₁₂, A₁₂ may be loaded into registers of PE₁₃, A₁₃ may be loaded into registers of PE₁₄, A₂₁ may be loaded into registers of PE₂₂ ...and A₃₃ may be loaded into registers of PE₃₄. In other words, arrangements of the elements of the second matrix in the matrix may be the same as arrangements of the elements of the second matrix in the registers of the processing elements.

It is required to be explained that the above examples are just some embodiments of loading the first matrix and do not restrict the present disclosure in any way. Those skilled in the art should know that the first matrix may be loaded in other ways, as long as arrangements of the elements of the first matrix in the matrix are the same as arrangements of the elements of the first matrix in the registers of the processing elements.

The transposed matrix may be loaded into the registers of the processing elements according to a way of loading the first matrix. Or after loading, columns of the second matrix may be aligned with columns of the transposed matrix. After loading, elements in the transposed matrix and element in corresponding positions of the second matrix may be stored in the registers of the same processing element.

For example, it is assumed that A₁₁ may be loaded into registers of PE₁₁, A₁₂ may be loaded into registers of PE₁₂, A₁₃ may be loaded into registers of PE₁₃, A₂₁ may be loaded into registers of PE₂₁...and A₃₃ may be loaded into registers of PE₃₃. In other words, subscripts of the elements of the first matrix may be the same as subscripts of the processing elements where the elements of the first matrix are located. Then, ^{B}11 may be loaded into registers of PE₁₁, ^{B}21 may be loaded into registers of PE₁₂, ^{B}31 may be loaded into registers of PE₁₃, B₁₂ may be loaded into registers of PE₂₁, B₂₂ may be loaded into registers of PE₂₂, B₃₂ may be loaded into registers of PE₂₃...and B₃₃ may be loaded into registers of PE₃₃. In other words, the transposed matrix may be loaded into the registers of the processing elements in an order aligned with the columns of the second matrix.

In a possible implementation, the transposed matrix may be loaded first, and then the second matrix may be loaded, or the transposed matrix and the second matrix may be loaded at the same time. The present disclosure does not limit a specific way of loading, as long as the transposed matrix is aligned with the second matrix in row direction after loading, and the elements in the transposed matrix and the elements in the corresponding positions of the second matrix are stored in the registers of the same processing element.

In a possible implementation, after the input matrix is loaded, for a case of transposing the right multiply matrix, processing elements storing elements of a first row of the transposed matrix and processing elements storing elements of a last row of the transposed matrix may be connected in column direction, so as to form a loop. Data in the loop may flow to implement the rolling of the matrix in column direction. As shown in FIGS. 2-1, PE₁₁ and PE₃₁ may be connected to form the loop; PE₁₂ and PE₃₂ may be connected to form the loop; and PE₁₃ and PE₃₃ may be connected to form the loop. As such, when the data flows in the loop, if the data flows upward, then, data of a first row may flow to a third row, data of a second row may flow to the first row, and data of the third row may flow to the second row. If the data flows downward, then, the data of the first row may flow to the second row, the data of the second row may flow to the third row, and the data of the third row may flow to the first row.

In this implementation, the transposed matrix may be rolled only. Before rolling the transposed matrix for the first time, the controller may control the processing elements to perform the multiplication operations on the elements in the corresponding registers to obtain the element products. The controller may sum the element products of the same row to obtain the first intermediate results. Taking the above example as an example, the controller may control PE₁₁ to perform a multiplication operation on A₁₁ and ^{B}11 stored in the registers of the processing element to obtain an element product A₁₁ x B₁₁. Similarly, the controller may control PE₁₂ and PE₁₃ to obtain A₁₂ x ^{B}21 and A₁₃ x B₃₁.

Then, the controller may sum the element products of the same row to obtain C₁₁=A₁₁ _{X} ^{B}11 + A₁₂ x B₂₁ + A₁₃ x B_{31.}

In the same way, C₂₂ and C₃₃ may be obtained.

In a possible implementation, C₁₁, C₂₂, and C₃₃ may be stored in a caching unit temporarily as first intermediate results of a first column. The caching unit may be located in a position in the processor outside the plurality of processing elements.

Next, in a possible implementation, the transposed matrix may be rolled up by one row, and elements of a first row may be rolled to a last row; in other words, the elements of the first row may be rolled to a last row of the processing elements storing the elements of the matrix. Or, the transposed matrix may be rolled down by one row. The present disclosure does not limit the direction of specific rolling, and for the example in this implementation, the matrix may just be rolled in units of rows in column direction.

As shown in FIGS. 2-1, when the matrix is rolled up, data of a first row may be rolled to a third row, as shown in the following.

$${b}_{33}^{T 1} = \left[\begin{matrix}{B}_{12} & {B}_{22} & {B}_{32} \\ {B}_{13} & {B}_{23} & {B}_{33} \\ {B}_{11} & {B}_{21} & {B}_{31}\end{matrix}\right]$$

In a possible implementation, a rolling process of data in the matrix may be implemented by using spare registers in the processing elements or an on-chip caching unit in the processor. This implementation is applicable to rolling processes of example 2-1 and example 2-2 of the present disclosure.

For example, taking the above example 2-1 as an example, the elements of the first row of the transposed matrix may be stored in the spare registers temporarily. The processing elements of the second row may be controlled to send elements of the second row of the transposed matrix stored in the corresponding registers to the processing elements of the first row. Then, the processing elements of the third row may be controlled to send elements of the third row of the transposed matrix stored in the corresponding registers to the processing elements of the second row. Finally, the temporarily-stored elements of the first row may be stored to registers corresponding to the processing elements of the third row, thus implementing a rolling process of data of one row of the transposed matrix. The above process is just an example of the present disclosure and does not limit the present disclosure in any way.

Again, the processing elements may be controlled to perform the multiplication operations on the elements in the corresponding registers to obtain the element products, and the element products of the same row may be summed to obtain the first intermediate results. A first row of a₃₃ may be multiplied with a second row of

$${b}_{33}^{T 1}$$

to obtain C₁₂; a second row of a₃₃ may be multiplied with a third row of

$${b}_{33}^{T 1}$$

to obtain C₂₃; and a third row of a₃₃ may be multiplied with a first row of

$${\text{b}}_{\text{22}}^{\text{T1}}$$

to obtain C₃₁. C₁₂, C₂₃, and C₃₁ may be stored in the caching unit temporarily as first intermediate results of the second column.

Again, the transposed matrix may be rolled up by one row, and the multiplication operations on the elements in the corresponding registers may be performed to obtain the element products. The element products of the same row may be summed to obtain first intermediate results including C₁₃, C₂₁, and C₃₂. C₁₃, C_{21,} and C₃₂ may be stored in the caching unit temporarily as first intermediate results of the third column. In other words, the first intermediate results stored in the caching unit may be

$${c}_{33} = \left[\begin{matrix}{C}_{11} & {C}_{12} & {C}_{13} \\ {C}_{22} & {C}_{23} & {C}_{21} \\ {C}_{33} & {C}_{31} & {C}_{32}\end{matrix}\right] .$$

For the step S2-13, for a case of rolling the transposed matrix up, processing the first intermediate results means that the controller may store the obtained first intermediate results by column, and then the controller may roll elements of the i-th row of the first intermediate results to the right by i-1 step in row direction to obtain the product of the input matrix. Here, the rolling may also refer to rolling in the form of a closed loop in row direction. Processing elements of a first column storing the elements of the matrix are connected to processing elements of a last column storing the elements of the matrix to form the closed loop. During a process of rolling, if it is determined to roll to the right, then, elements stored in the processing elements of the last column are rolled to the processing elements of the first column.

Optionally, for the step S2-13, for a case of rolling the transposed matrix down, processing the first intermediate results means that the controller may store the obtained first intermediate results by column, and then the controller may roll the elements of the i-th row of the first intermediate results to the left by i-1 step in row direction to obtain the product of the input matrix.

It may be understood to those skilled in the art that for the step S2-13, the controller may further roll the elements in the first intermediate results in row direction (for example, the elements in the first intermediate results may be rolled to the right or to the left) to obtain the product of the input matrix according to identification of rows and columns of the first intermediate results. In this implementation, the elements stored in the registers may be configured with identification of rows and columns of the elements in the matrix. During the process of rolling, according to the identification of rows and columns of the elements in the matrix, identification of rows and columns of the elements of the first intermediate results may be determined. Thereby, the controller may be enabled to roll the elements in the first intermediate results in row direction to obtain the product of the first matrix and the second matrix according to the identification of rows and columns of the first intermediate results.

Taking the above example as an example, the 1st row is rolled to the right by 0 step; in other words, the 1st row does not roll. The 2nd row is rolled to the right by 1 step; in other words, C₂₁ is rolled to the right by 1 step to the 1st column. C₂₃ is rolled to the right by 1 step to the 3rd column, and C₂₂ is rolled to the right by 1 step to the 2nd column. The obtained result is:

$${c}_{33} = \left[\begin{matrix}{C}_{11} & {C}_{12} & {C}_{13} \\ {C}_{21} & {C}_{22} & {C}_{23} \\ {C}_{33} & {C}_{31} & {C}_{32}\end{matrix}\right] .$$

The 3rd row is rolled to the right by 2 steps, and the obtained product of the input matrix is:

$${c}_{33} = \left[\begin{matrix}{C}_{11} & {C}_{12} & {C}_{13} \\ {C}_{21} & {C}_{22} & {C}_{23} \\ {C}_{31} & {C}_{32} & {C}_{33}\end{matrix}\right] .$$

In a possible implementation, in the step S2-12, the second matrix may further be rolled in column direction. A specific process is similar to the rolling process of the transposed matrix, and compared with the step S2-13, there is just a slight difference in how the elements are processed and rolled. The present disclosure does not repeat a specific derivative process. For the specific derivative process, reference may be made to the above process.

It is required to be explained that the arrangements of the processing elements and the input matrix in the above example are just used to clearly explain the process of the operation method of the present disclosure and do not limit the present disclosure in any way.

### Example 2-2: The First Matrix Is the Left Multiply Matrix, and the Second Matrix Is The Right Multiply Matrix; in Other Words, The Left Multiply Matrix Is Transposed

It is still assumed that both the first matrix aₘₙ and the second matrix bₙₖ are matrices of 3×3, and the processing elements constitute an array of 4×4. A₁₁ A₁₂ A₁₃ Assuming that the first matrix is a₃₃ =

$$\left[\begin{matrix}{\text{A}}_{11} & {\text{A}}_{12} & {\text{A}}_{13} \\ {\text{A}}_{21} & {\text{A}}_{22} & {\text{A}}_{23} \\ {\text{A}}_{31} & {\text{A}}_{32} & {\text{A}}_{33}\end{matrix}\right] ,$$

then, the transposed matrix obtained by transposing the first matrix is

$${\text{a}}_{33}^{\text{T}}$$

=

$$\left[\begin{matrix}{\text{A}}_{11} & {\text{A}}_{21} & {\text{A}}_{31} \\ {\text{A}}_{12} & {\text{A}}_{22} & {\text{A}}_{31} \\ {\text{A}}_{13} & {\text{A}}_{23} & {\text{A}}_{33}\end{matrix}\right] ,$$

and the second matrix is

$${\text{b}}_{33} = \left[\begin{matrix}{B}_{11} & {B}_{12} & {B}_{13} \\ {B}_{21} & {B}_{22} & {B}_{23} \\ {B}_{31} & {B}_{32} & {B}_{33}\end{matrix}\right] .$$

For a way of loading the second matrix into the registers of the processing elements, reference may be made to the way of loading the first matrix in the example 2-1, which will not be repeated. Then, according to the way of loading the second matrix, the transposed matrix may be loaded into the registers of the processing elements. After loading, rows of the transposed matrix of the first matrix may be aligned with rows of the second matrix.

For example, it is assumed that ^{B}11 may be loaded into registers of PE₁₁, B₁₂ may be loaded into registers of PE₁₂, B₁₃ may be loaded into registers of PE₁₃, ^{B}21 may be loaded into registers of PE₂₁...and B₃₃ may be loaded into registers of PE₃₃. In other words, subscripts of the elements of the first matrix may be the same as subscripts of the processing elements where the elements of the first matrix are located. Then, A₁₁ may be loaded into registers of PE₁₁, A₂₁ may be loaded into registers of PE₁₂, A₃₁ may be loaded into registers of PE₁₃, A₁₂ may be loaded into registers of PE₂₁, A₂₂ may be loaded into registers of PE₂₂, A₃₂ may be loaded into registers of PE₂₃...and A₃₃ may be loaded into registers of PE₃₃. In other words, the transposed matrix may be loaded into the registers of the processing elements in an order aligned with rows of another matrix (the second matrix).

In a possible implementation, after the input matrix is loaded, for a case of transposing the first matrix, processing elements storing elements of a first column of the transposed matrix and processing elements storing elements of a last column of the transposed matrix may be connected in row direction, so as to form a loop. Data in the loop may flow to enable rolling in units of columns in row direction. As shown in FIGS. 2-4, PE₁₁ and PE₁₃ may be connected to form the loop; PE₂₁ and PE₂₃ may be connected to form the loop; and PE₃₁ and PE₃₃ may be connected to form the loop. As such, when the data flows in the loop, if the data flows to the left, then, data of a first column may flow to a third column, data of a second column may flow to the first column, and data of the third column may flow to the second column. If the data flows to the right, then, the data of the first column may flow to the second column, the data of the second column may flow to the third column, and the data of the third column may flow to the first column.

In this implementation, the transposed matrix may be rolled only. Before rolling the transposed matrix to the left or to the right in column direction for the first time, the controller may control the processing elements to perform the multiplication operations on the elements in the corresponding registers to obtain the element products, and the controller may sum the element products of the same column to obtain the first intermediate results. Taking the above example as an example, PE₁₁ may perform a multiplication operation on A₁₁ and ^{B}11 stored in the registers of the processing element to obtain an element product A₁₁ x B₁₁. Similarly, A₁₂ x ^{B}21 and A₁₃ x ^{B}31 may be obtained.

By summing the element products of the first column, C₁₁=A₁₁ x ^{B}11 + A₁₂ x B₂₁ + A₁₃ x ^{B}31 may be obtained.

In the same way, a sum of the element products of the second column C₂₂ and a sum of the element products of the third column C₃₃ may be obtained.

In a possible implementation, C₁₁, C₂₂, and C₃₃ may be stored in the caching unit temporarily as first intermediate results of the first row.

Next, the transposed matrix may be rolled to the left by one column and the elements of the first column may be rolled to the last column, or the transposed matrix may also be rolled to the right by one column. The present disclosure does not limit this.

As shown in FIGS. 2-1, when rolling to the left, data of the first column may be rolled to the third column, as shown in the following:

$${a}_{33}^{T 1} = \left[\begin{matrix}{\text{A}}_{21} & {\text{A}}_{31} & {\text{A}}_{11} \\ {\text{A}}_{22} & {\text{A}}_{32} & {\text{A}}_{11} \\ {\text{A}}_{33} & {\text{A}}_{33} & {\text{A}}_{13}\end{matrix}\right] .$$

Again, the processing elements may be controlled to perform the multiplication operations on the elements in the corresponding registers to obtain the element products, and the element products of the same column may be summed to obtain the first intermediate results. A second column of

$${\text{a}}_{33}^{\text{T} 1}$$

may be multiplied with a first column of b₃₃ to obtain C₂₁; a third column of

$${\text{a}}_{33}^{\text{T} 1}$$

may be multiplied with a second column of b₃₃ to obtain C₃₂; and a first column of a₃₃ may be multiplied with a third column of b₃₃ to obtain C₁₃. C₂₁, C₃₂, and C₁₃ may be stored in the caching unit temporarily as first intermediate results of the second row.

Again, the transposed matrix may be rolled to the left by one column, and the multiplication operations on the elements in the corresponding registers may be performed to obtain the element products. The element products of the same column may be summed to obtain first intermediate results including C₃₁, C₁₂, and C₂₃. C₃₁, C₁₂, and C₂₃ may be stored in the caching unit temporarily as first intermediate results of the third row.

In other words, the first intermediate results stored in the caching unit are:

$${\text{c}}_{33} = \left[\begin{matrix}{\text{C}}_{11} & {\text{C}}_{22} & {\text{C}}_{33} \\ {\text{C}}_{21} & {\text{C}}_{32} & {\text{C}}_{13} \\ {\text{C}}_{31} & {\text{C}}_{12} & {\text{C}}_{23}\end{matrix}\right] .$$

For the step S2-13, for a case of rolling the transposed matrix of the first matrix to the left, the first intermediate results may be stored by row. The controller may roll elements in the i-th column of the first intermediate results down by i-1 step in column direction to obtain the product of the input matrix.

Optionally, for a case of rolling the transposed matrix of the first matrix to the right, the controller may store the first intermediate results by row. The elements in the i-th column of the first intermediate results may be rolled up by i-1 step in column direction to obtain the product of the input matrix. Specific steps are similar to steps of rolling to the left, which will not be repeated herein.

Those skilled in the art may understand that for the step S2-13, the controller may further roll the elements in the first intermediate results in column direction (for example, the elements in the first intermediate results may be rolled up or down) to obtain the product of the input matrix according to identification of rows and columns of the first intermediate results. In this implementation, the elements stored in the registers may be configured with identification of rows and columns of the elements in the matrix. During the process of rolling, according to the identification of rows and columns of the elements in the matrix, identification of rows and columns of the elements of the first intermediate results may be determined. Thereby, the controller may be enabled to roll the elements in the first intermediate results in column direction to obtain the product of the input matrix according to the identification of rows and columns of the first intermediate results.

Taking the above example as an example, the 1st column is rolled down by 0 step; in other word, the 1st column does not roll. The 2nd column is rolled down by 1 step; in other words, C₁₂ is rolled down by 1 step to the 1st column. C₃₂ is rolled down by 1 step to the 3rd column, and C₂₂ is rolled down by 1 step to the 2nd column. The obtained result is:

$${\text{c}}_{33} = \left[\begin{matrix}{\text{C}}_{11} & {\text{C}}_{12} & {\text{C}}_{33} \\ {\text{C}}_{21} & {\text{C}}_{22} & {\text{C}}_{13} \\ {\text{C}}_{31} & {\text{C}}_{32} & {\text{C}}_{23}\end{matrix}\right] .$$

The 3rd column is rolled down by 2 steps, and the obtained product of the input matrix is:

$${\text{c}}_{33} = \left[\begin{matrix}{\text{C}}_{11} & {\text{C}}_{12} & {\text{C}}_{13} \\ {\text{C}}_{21} & {\text{C}}_{22} & {\text{C}}_{23} \\ {\text{C}}_{31} & {\text{C}}_{32} & {\text{C}}_{33}\end{matrix}\right] .$$

It is required to be explained that the arrangements of the processing elements and the input matrix in the above example are just used to clearly explain the process of the operation method of the present disclosure and do not limit the present disclosure in any way.

In a possible implementation, in the step S2-12, the second matrix may also be rolled in row direction. A specific process is similar to a rolling process of the transposed matrix, and compared with the step S2-13, there is just a slight difference in how the elements are processed and rolled. The present disclosure does not repeat a specific derivative process. For the specific derivative process, reference may be made to the above process.

The operation method of matrix multiplication according to the aforementioned implementations of the present disclosure is more applicable to a processor composed of processing elements arranged in the form of an array. For an input matrix with any size satisfying the arrangements of the processing elements, an operation result of matrix multiplication may be obtained. Compared with matrix multiplication operations in related technologies, the number of times of memory accesses may be decreased, bandwidth pressure may be reduced, and operation efficiency may be improved.

For a case of not partitioning, according to the above example, the result of matrix multiplication may be obtained directly. For a case of requiring partitioning, for the partitioned first matrices and the partitioned second matrices, according to rules of matrix multiplication, results obtained by multiplying the first matrices with the corresponding second matrices may be used as second intermediate results. In other words, the first matrices obtained after partitioning and the second matrices obtained after partitioning may be used as one element in the matrix to perform the operation process of matrix multiplication to obtain the second intermediate results. By calculating according to the second intermediate results, the product of the input matrix may be obtained.

FIGS. 2-5 is a schematic diagram of partitioning according to an embodiment of the present disclosure. As shown in FIGS. 2-5, according to the above way, the controller may partition a matrix D to obtain first matrices including D₁₁, D₁₂, D₂₁, and D₂₂, and the controller may partition a matrix E to obtain second matrices including E₁₁, E₁₂, E_{21,} and E₂₂. The controller may use the first matrices and the second matrices as one element of the matrix to perform the operation process of matrix multiplication. For example, multiplying a first row of the matrix D with a first column of the matrix E is F₁₁=D₁₁ _{X} E₁₁ + D₁₂ x E₂₁; multiplying the first row of the matrix D with a second column of the matrix E is F₁₂=D₁₁ _{X} E₁₂ + D₁₂ x E₂₂; multiplying a second row of the matrix D with the first column of the matrix E is F₂₁=D₂₁ _{X} E₁₁ + D₂₂ _{X} E_{21;} and multiplying the second row of the matrix D with the second column of the matrix E is F₂₂=D₂ᵢ x E₁₂ + D₂₂ _{X} E₂₂. In other words, in order to obtain a final operation result of matrix multiplication, it is required to obtain the second intermediate results first:

$${\text{D}}_{11} \times \text{} \text{} \text{} {\text{E}}_{11} , {\text{D}}_{12} \times {\text{E}}_{21} , {\text{D}}_{11} \times {\text{E}}_{12} , {\text{D}}_{12} \times {\text{E}}_{22} ,$$

$${\text{D}}_{21} \times {\text{E}}_{11} , {\text{D}}_{22} \times {\text{E}}_{21} , {\text{D}}_{21} \times {\text{E}}_{12 ,} {\text{D}}_{22} \times {\text{E}}_{22} .$$

Processes of obtaining the second intermediate results may be obtained by operating corresponding first matrices and corresponding second matrices according to processes of steps S2-11 to S2-13, respectively.

By partitioning the input matrix and performing the matrix multiplication operations of the present disclosure on the partitioned matrices respectively to obtain the second intermediate results, the product of the input matrix may be obtained by calculating according to the second intermediate results. Based on the operation method according to the aforementioned implementations of the present disclosure, for a matrix with any dimension, processes of matrix multiplication may be implemented quickly.

In an optional embodiment, the partitioned first matrices and the partitioned second matrices may be stored to the processing elements in turn respectively for calculating, and the partitioned first matrices and the partitioned second matrices may also be stored to the processing elements in stacks.

### Example 2-3: Storage in Stacks in Combination With Steps S2-11 to S2-13

For example, the operation method of the present disclosure may be explained by taking a case where the processing elements constitute an array of ₂×₂, and input matrices are matrices of 4×4 as an example. A₁₁ A₁₂ A₁₃ A₁₄⁻ It is assumed that the left multiply matrix is

$${a}_{44} = \left[\begin{matrix}{\text{A}}_{11} & {\text{A}}_{12} & {\text{A}}_{13} & {\text{A}}_{14} \\ {\text{A}}_{21} & {\text{A}}_{22} & {\text{A}}_{23} & {\text{A}}_{24} \\ {\text{A}}_{31} & {\text{A}}_{32} & {\text{A}}_{33} & {\text{A}}_{34} \\ {\text{A}}_{41} & {\text{A}}_{42} & {\text{A}}_{43} & {\text{A}}_{44}\end{matrix}\right] ,$$

and the right multiply matrix is

$${b}_{44} = \left[\begin{matrix}{\text{B}}_{11} & {\text{B}}_{12} & {\text{B}}_{13} & {\text{B}}_{14} \\ {\text{B}}_{21} & {\text{B}}_{22} & {\text{B}}_{23} & {\text{B}}_{24} \\ {\text{B}}_{31} & {\text{B}}_{32} & {\text{B}}_{33} & {\text{B}}_{34} \\ {\text{B}}_{41} & {\text{B}}_{42} & {\text{B}}_{43} & {\text{B}}_{44}\end{matrix}\right] .$$

Then, the controller may divide both the left multiply matrix and the right multiply matrix into matrices of 2×2.

FIGS. 2-6 shows an example of dividing a matrix according to an embodiment of the present disclosure. As shown in FIGS. 2-6, the controller may divide both the left multiply matrix and the right multiply matrix into sub-matrices of 2×2. Four matrices obtained by dividing the left multiply matrix are α₁₁, α₁₂, α₂₁, and α₂₂, where α₁₁ is

$$\left[\begin{matrix}{\text{A}}_{11} & {\text{A}}_{12} \\ {\text{A}}_{21} & {\text{A}}_{22}\end{matrix}\right] ,$$

α₁₂ is

$$\left[\begin{matrix}{\text{A}}_{13} & {\text{A}}_{14} \\ {\text{A}}_{23} & {\text{A}}_{24}\end{matrix}\right] ,$$

α₂₁ is

$$\left[\begin{matrix}{\text{A}}_{33} & {\text{A}}_{34} \\ {\text{A}}_{43} & {\text{A}}_{44}\end{matrix}\right] ,$$

and α₂₂ is

$$\left[\begin{matrix}{\text{A}}_{33} & {\text{A}}_{34} \\ {\text{A}}_{43} & {\text{A}}_{44}\end{matrix}\right] .$$

Four matrices obtained by dividing the right multiply matrix are b₁₁, b_{12,} b₂₁, and b₂₂, where b₁₁ is

$$\left[\begin{matrix}{B}_{11} & {B}_{12} \\ {B}_{21} & {B}_{22}\end{matrix}\right] ,$$

b₁₂ is

$$\left[\begin{matrix}{B}_{13} & {B}_{14} \\ {B}_{23} & {B}_{24}\end{matrix}\right] ,$$

b21 is L

$$\left[\begin{matrix}{B}_{31} & {B}_{32} \\ {B}_{41} & {B}_{42}\end{matrix}\right] ,$$

and b₂₂ is

$$\left[\begin{matrix}{B}_{33} & {B}_{34} \\ {B}_{43} & {B}_{44}\end{matrix}\right] .$$

For a case of performing partitioning, if the number of registers included in the processing elements may meet requirements for storing the input matrix, the input matrix may be stored to the registers of the processing elements by adopting a way of storing in stacks, so as to implement the multiplication operation of the input matrix. When the input matrix is stored in stacks, the controller may divide the registers of the processing elements into a plurality of different groups, and each group may store one partitioned first matrix and one corresponding partitioned second matrix. The present disclosure does not limit a specific way of dividing groups, but each of registers of a same group may be located in different processing elements.

In an example of storing the input matrix in stacks, a possible calculating method is to roll the matrix in units of the first matrices obtained by partitioning and the second matrices obtained by partitioning. During the process of calculating the second intermediate results, processes of steps S2-11 to S2-13 may be adopted for the operation.

Taking calculating the second intermediate results by adopting the processes of the steps S1-11 to S1-13 as an example, assuming that the processing elements constitute an array of ₂×₂, taking the example shown in FIGS. 2-6 as an example, for the operation method of the present disclosure, the first matrices may be obtained either by partitioning the left multiply matrix or by partitioning the right multiply matrix.

The present disclosure may explain the operation method by taking a case where the first matrices are obtained by partitioning the right multiply matrix as an example and by taking a case where the second matrices are loaded and the corresponding first matrices are loaded after transposing as an example. Results of loading are as shown in Table 2-1 and Table 2-2. Reg0, Reg1, Reg2, and Reg3 each respectively represents one group of registers in the processing elements. The processing elements constitute an array of ₂×₂. Each processor includes a plurality of registers. The controller may divide the plurality of registers into a plurality of groups. Taking this embodiment as an example, the plurality of registers may be divided into four groups. The registers in the same group may be used to store one transposed matrix and a corresponding second matrix, as shown in Table 2-1 and Table 2-2. Reg0 stores a₁₁ and b₁₁. Reg1 stores a₁₂ and b₂₁. Reg2 stores a₂₁ and b₁₂. Reg3 stores a₂₂ and b₂₂. In other words, elements of a first row of the matrix

$$\left[\begin{matrix}{\text{a}}_{\text{11}} & {\text{a}}_{\text{12}} \\ {\text{a}}_{\text{21}} & {\text{a}}_{\text{22}}\end{matrix}\right]$$

are multiplied with elements of a first column of the matrix

$$\left[\begin{matrix}{\text{b}}_{\text{11}} & {\text{b}}_{\text{12}} \\ {\text{b}}_{\text{21}} & {\text{b}}_{\text{22}}\end{matrix}\right] ,$$

and elements of a second row are multiplied with elements of a second column.

TABLE 2-1

Element Storage Example

| Reg0 | | Reg1 | |
|---|---|---|---|
| A₁₁ | A₁₂ | A₁₃ | A₁₄ |
| A₂₁ | A₂₂ | A₂₃ | A₂₄ |
| Reg2 | | Reg3 | |
| A₃₁ | A₃₂ | A₃₃ | A₃₄ |
| ^{A}41 | A₄₂ | A₄₃ | A₄₄ |

TABLE 2-2

Element Storage Example

| Reg0 | | Reg1 | |
|---|---|---|---|
| ^{B}11 | ^{B}21 | ^{B} ₃₁ | ^{B} ₄₁ |
| B12 | B₂₂ | B₃₂ | B₄₂ |
| Reg2 | | Reg3 | |
| B₁₃ | B₂₃ | B₃₃ | B₄₃ |
| ^{B}14 | ^{B}24 | ^{B}34 | ^{B}44 |

During a calculating process, for elements in one group of registers, the processing elements may obtain second intermediate results including a₁₁ x b₁₁, a₁₂ _{X} b₂₁, a₂₁ _{X} b₁₂, and a₂₂ x b₂₂ by calculating according to processes of steps S2-11 to S2-13. A specific process will not be repeated herein. According to the second intermediate results including a₁₁ _{X} b₁₁, a₁₂ _{X} b₂₁, a₂₁ _{X} b₁₂, and a₂₂ _{X} b₂₂, C₁₁=a₁₁ _{X} b₁₁ + a₁₂ _{X} b₂₁ and C₂₂=a₂₁ _{X} b₁₂ + a₂₂ x b₂₂ may be obtained by calculating.

After the above second intermediate results are calculated, the transposed matrix may be rolled in units of groups. Specifically, for the transposed matrix

$$\left[\begin{matrix}{\text{b}}_{\text{11}} & {\text{b}}_{\text{21}} \\ {\text{b}}_{\text{12}} & {\text{b}}_{\text{22}}\end{matrix}\right] ,$$

rolling up by one row means that elements in the transposed matrix in Reg2 are rolled to RegO, elements in the transposed matrix in Reg0 are rolled to Reg2, elements in the transposed matrix in Reg3 are rolled to Reg1, and elements in the transposed matrix in Reg1 are rolled to Reg3. Thereby, a Table 2-3 may be obtained.

TABLE 2-3

Element Storage Example

| | | | |
|---|---|---|---|
| Reg0 | | Reg1 | |
| B₁₃ | B₂₃ | B₃₃ | B₄₃ |
| B₁₄ | B₂₄ | B₃₄ | B₄₄ |
| B₁₁ | B₂₁ | B₃₁ | B₄₁ |
| B₁₂ | B₂₂ | B₃₂ | B₄₂ |

In combination with Table 2-1 and Table 2-3, during the calculating process, for the elements in one group of registers, the processing elements may obtain second intermediate results including a₁₁ × b₁₂, a₁₂ × b₂₂, a₂₁ × b₁₁, and a₂₂ × b₂₁ by calculating according to the processes of steps S2-11 to S2-13. A specific process will not be repeated herein. According to the second intermediate results including a₁₁ × b₁₂, a₁₂ × b₂₂, a₂₁ × b₁₁, and a₂₂ × b_{21,} C₁₂=a₁₁ × b₁₂ + a₁₂ × b₂₂ and C₂₁=a₂₁ × b₁₁ + a₂₂ × b₂₁ may be obtained by calculating.

According to the above process, the product of the input matrix may be calculated by using a way of partitioning.

Therefore, according to the operation method of matrix multiplication of the present disclosure, a matrix operation with any size may be implemented.

### Example 2-4: Storage in Stacks in Combination With Overall Rolling

In another possible implementation, another rolling way may also be adopted. In the rolling way of this embodiment, the step S2-12 in FIGS. 2-3 may be implemented through the following process. Before rolling the transposed matrix once in row direction or in column direction each time, the processing elements may be controlled to perform the multiplication operations on the elements in the corresponding registers to obtain the element products. The element products of the same row (or the element products of the same column in the example of transposing the first matrix) may be summed to obtain first intermediate results includingC₁₁, C₂₂, C₃₃, and C₄₄.

Since the input matrix is partitioned and stored in stacks, data of an original one row or one column is stored to different groups of registers. As such, when data of original one row or one column that is stored consecutively becomes independent data of at least two rows or at least two columns and the data is stored to different groups of registers, a first piece of data of a next row or a next column stored in the different groups of registers and a last piece of data of a previous row or a next column are data that is stored consecutively before storing in stacks. However, after storing in stacks, the data is not stored consecutively. Therefore, after the elements in one group of registers are controlled to roll once in row direction or in column direction, it is required to correct a rolling result to obtain a correct result. A specific correcting method may include:
for each block of the transposed matrices, rolling once in row direction or in column direction;
if it is determined to roll to the left in row direction, according to the correcting method, rolling data of a last column of each block of the transposed matrices after rolling to a last column of data of a previous adjacent block of the transposed matrices;
if it is determined to roll to the right in row direction, according to the correcting method, rolling data of a first column of each block of the transposed matrices after rolling to a first column of data of a later adjacent block of the transposed matrices;
if it is determined to roll up in column direction, according to the correcting method, rolling data of a last row of each block of the transposed matrices after rolling to a last row of data of a previous adjacent block of the transposed matrices; and
if it is determined to roll down in column direction, according to the correcting method, rolling data of a first row of each block of the transposed matrices after rolling to a first row of data of a later adjacent block of the transposed matrices, where each block described above may refer to each block of the transposed matrices, and each block of the transposed matrices may refer to each transposed matrix after partitioning.

For this embodiment, the right multiply matrix is transposed. During the rolling process, the right multiply matrix is still rolled in row direction. However, since the matrix is stored in stacks, elements of at least two rows are consecutive, but when storing in stacks, at least two rows are regarded as independent rows. As such, simply rolling in row direction within each group of registers may not implement correct rolling, and the correcting is also required.

Taking Table 2-2 as an example, within each group of registers, the elements may be rolled up by one row, and a rolling result may be as shown in Table 2-4. In Table 2-4, elements of a first row of one group of registers may be rolled to a last row. However, as shown in Table 2-2, elements of first rows of Reg0 and Reg1 should be rolled to last rows of Reg2 and Reg3, but the elements of the first rows of Reg0 and Reg1 are located in last rows of Reg0 and Reg1 now (as shown in Table 2-4). As shown in Table 2-2, elements of first rows of Reg2 and Reg3 should be rolled to the last rows of Reg0 and Reg1, but the elements of the first rows of Reg2 and Reg3 are located in the last rows of Reg2 and Reg3 now (as shown in Table 2-4). In other words, in Table 2-4, now, the elements of the last rows of Reg0 and Reg1 should be located in the last rows of Reg2 and Reg3, and the elements of the last rows of Reg2 and Reg3 should be located in the last rows of Reg0 and Reg1. Then, by exchanging elements of the last row of Reg2 and elements of the last row of Reg0 by exchanging elements of the last row of Reg3 and elements of the last row of Reg1, the rolling process may be implemented, as shown in Table 2-5.

TABLE 2-4

Element Storage Example

| Reg0 | | Reg1 | |
|---|---|---|---|
| B₁₂ | B₂₂ | B₃₂ | B₄₂ |
| B₁₁ | B₂₁ | B₃₁ | B₄₁ |
| Reg2 | | Reg3 | |
| B₁₄ | B₂₄ | B₃₄ | B₄₄ |
| B₁₃ | B₂₃ | B₃₃ | B₄₃ |

TABLE 2-5

Element Storage Example

| Reg0 | | Reg1 | |
|---|---|---|---|
| B₁₂ | B₂₂ | B₃₂ | B₄₂ |
| B₁₃ | B₂₃ | B₃₃ | B₄₃ |
| Reg2 | | Reg3 | |
| B₁₄ | B₂₄ | B₃₄ | B₄₄ |
| B₁₁ | B₂₁ | B₃₁ | B₄₁ |

According to Table 2-1 and Table 2-5, the processing elements may be controlled to perform the multiplication operations on the elements in the corresponding registers to obtain the element products, and the element products of the same row may be summed to obtain first intermediate results including C₁₂, C₂₃, C₃₄, and C₄₁.

By repeating four times of calculating and three times of rolling in the above process, the operation process of matrix multiplication may be completed. According to the first intermediate results, the product of the input matrix may be obtained.

In an optional embodiment, the way of storing in stacks may be implemented according to the above way of partitioning. The way of storing in stacks is not limited to a case where each of the registers stores one element in the matrix. The way of storing in stacks is not limited to a case where a row number of matrix multiplication is an integer multiple of a row number of the processing elements and a column number of matrix multiplication is an integer multiple of a column number of the processing elements. The way of storing in stacks is also not limited to a case where the way of storing in stacks is the only way and keeps the same in the correcting process, as long as elements of the original one row/column after correcting may be concatenated. The present disclosure does not limit a specific process of storing in stacks.

It is required to be explained that the above way of storing in stacks and the above way of rolling the elements are just examples of the present disclosure, and other ways may be adopted. The present disclosure does not limit this.

It is required to be explained that for the sake of conciseness, the foregoing method embodiments are all described as a series of combinations of actions, but those skilled in the art should know that the present disclosure is not limited by the described order of actions since some steps may be performed in a different order or simultaneously according to the present disclosure. Secondly, those skilled in the art should also understand that the embodiments described in the specification are all optional, and the actions and modules involved are not necessarily required for the present disclosure.

Further, it is required to be explained that though steps in the flowchart are shown by following the direction of arrows, yet these steps may not necessarily be performed according to the order indicated by the arrows. Unless clearly stated herein, the order for performing these steps is not strictly restricted, and these steps may be performed in a different order. Additionally, at least part of the steps shown in the flowchart may include a plurality of sub-steps or a plurality of stages. These sub-steps or stages may not necessarily be performed and completed at the same time; instead, these sub-steps or stages may be performed at different time. These sub-steps or stages may not necessarily be performed sequentially either; instead, these sub-steps or stages may be performed in turn or alternately with at least part of other steps, or sub-steps of other steps, or stages of other steps.

The present disclosure further provides an operation apparatus of matrix multiplication based on a processing element matrix. The operation apparatus may be applied to a processor. FIGS. 2-1 is an exemplary processor. The processor may include two or more processing elements arranged in the form of a two-dimensional matrix. Each processing element may include at least one register. The operation apparatus may be used to implement a matrix multiplication operation on a first matrix and a second matrix.

It should be understood that the foregoing apparatus embodiments are just illustrative, and the apparatus of the present disclosure may also be implemented in other ways. For example, a division of units/modules in the foregoing embodiments is just a logical function division, and there may be other ways of division in actual implementations. For example, a plurality of units, modules, or components may be combined or integrated into another system, or some features may be omitted or may not be implemented.

In addition, unless otherwise specified, functional units/modules in various embodiments of the present disclosure may be integrated into one unit/module. Alternatively, each unit/module may exist alone physically. Alternatively, two or more units/modules may be integrated together. The above-mentioned integrated unit/module may be implemented in the form of hardware or in the form of a software program module.

If the above-mentioned integrated unit/module is implemented in the form of hardware, the hardware may be a digital circuit, an analog circuit, and the like. Physical implementations of the structure of the hardware include but are not limited to, a transistor, a memristor, and the like. Unless otherwise specified, the register may be any appropriate magnetic storage medium or magneto-optical storage medium, such as a resistive random access memory (RRAM), a dynamic random access memory (DRAM), a static random access memory (SRAM), an enhanced dynamic random access memory (EDRAM), a high bandwidth memory (HBM), a hybrid memory cube (HMC), and the like.

If the integrated unit/module is implemented in the form of the software program module and sold or used as an independent product, the integrated unit/module may be stored in a computer-readable memory. Based on such understanding, the essence of the technical solution of the present disclosure, or a part of the present disclosure that contributes to the prior art, or all or part of the technical solution, may be embodied in the form of a software product. The computer software product may be stored in a memory. The software product may include several instructions used to enable a computer device (which may be a personal computer, a server, or a network device, and the like) to perform part or all of steps of the method of the embodiments of the present disclosure. The foregoing memory includes: a USB flash drive, a read-only memory (ROM), a random access memory (RAM), a mobile hard disk, a magnetic disk, or an optical disc, and other media that may store a program code.

In an embodiment of the present disclosure, a computer-readable storage medium is also provided. The computer-readable storage medium stores a computer program instruction. When the computer program instruction is executed by a processor, the aforementioned method is performed. The computer-readable storage medium may be a nonvolatile computer-readable storage medium.

In an embodiment of the present disclosure, an artificial intelligence chip is also provided. The chip includes the aforementioned processor.

In a possible implementation, a board card is also disclosed. The board card includes a storage component, an interface apparatus, a control component, and the aforementioned artificial intelligence chip. The artificial intelligence chip is connected to the storage component, the control component, and the interface apparatus, respectively. The storage component is used to store data. The interface apparatus is used to implement data transfer between the artificial intelligence chip and an external device. The control component is used to monitor a state of the artificial intelligence chip.

The foregoing may be better understood according to the following articles:
Article B1. A processor, where the processor includes two or more processing elements arranged in the form of a two-dimensional matrix, each processing element includes at least one register, and the processor is used to perform a matrix multiplication operation on a first matrix and a second matrix;
   the processor further includes a controller, which is used to load each element of a transposed matrix of the first matrix and each element of the second matrix into registers of each processing element respectively, where an element of the transposed matrix and an element of a corresponding position of the second matrix are stored in a register of a same processing element;
   the controller is used to control the transposed matrix or the second matrix to roll in row direction or in column direction, control the processing elements to perform multiplication operations on elements in corresponding registers to obtain element products, and sum element products of a same row or element products of a same column to obtain first intermediate results; and
   the controller is further used to process the first intermediate results to obtain a product of the first matrix and the second matrix.
Article B2. The processor of article B1, where
   the controller controls the processing elements, the transposed matrix stored in the registers, and the second matrix stored in the registers to repeat the following process until elements in the transposed matrix or elements in the second matrix return to unrolled positions, where
   the controller is used to control the processing elements to perform the multiplication operations on the elements in the corresponding registers to obtain the element products, sum the element products of the same row or the element products of the same column to obtain the first intermediate results, and control the transposed matrix stored in the registers or the second matrix stored in the registers to roll by one row or by one column in row direction or in column direction.
Article B3. The processor of article B1 or article B2, where
   if the first matrix is a left multiply matrix, and the second matrix is a right multiply matrix, the controller controls elements in the transposed matrix to roll in row direction, or the controller controls elements in the second matrix to roll in row direction; the controller controls the processing elements to perform the multiplication operations on the elements in the corresponding registers to obtain the element products; and the controller sums the element products of the same column to obtain the first intermediate results; and
   if the first matrix is the right multiply matrix, and the second matrix is the left multiply matrix, the controller controls the elements in the transposed matrix to roll in column direction, or the controller controls the elements in the second matrix to roll in column direction; the controller controls the processing elements to perform the multiplication operations on the elements in the corresponding registers to obtain the element products; and the controller sums the element products of the same row to obtain the first intermediate results.
Article B4. The processor of article B1 or article B2, where
   the controller stores the first intermediate results by row or by column, and after rolling in row direction or in column direction, the controller obtains the product of the first matrix and the second matrix.
Article B5. The processor of any one of articles B1-B4, where the controller is further used to determine whether to partition an input matrix according to arrangements of the processing elements, a row rank of the input matrix, and a column rank of the input matrix, where the input matrix includes the left multiply matrix and the right multiply matrix;
   if it is determined to partition one matrix in the input matrix, the controller splits rows of the left multiply matrix or columns of the right multiply matrix according to the arrangements of the processing elements;
   if it is determined to partition two matrices in the input matrix, the controller partitions the left multiply matrix in column direction and the right multiply matrix in row direction in the same way according to the arrangements of the processing elements, the row rank of the input matrix, and the column rank of the input matrix; and
   after the left multiply matrix is partitioned, two or more first matrices are obtained, and after the right multiply matrix is partitioned, two or more second matrices are obtained, or after the left multiply matrix is partitioned, two or more second matrices are obtained, and after the right multiply matrix is partitioned, two or more first matrices are obtained.
Article B6. The processor of article B5, where
   the controller is further used to calculate a product of the left multiply matrix and the right multiply matrix according to the product of the first matrix and the second matrix.
Article B7. The processor of article B5, where the processor includes a plurality of groups of registers;
   the controller is further used to transpose the two or more first matrices to obtain transposed matrices after the controller partitions the input matrix;
   the controller loads the transposed matrices and the two or more second matrices into the plurality of groups of registers for storing in stacks, where one group of registers stores a transposed matrix and a second matrix of a corresponding position;
   before rolling elements in the transposed matrices and elements in the second matrices once in row direction or in column direction each time, the controller controls the processing elements to perform the multiplication operations on the elements in the corresponding registers to obtain the element products, and the controller sums the element products of the same row or the element products of the same column to obtain the first intermediate results; and
   after controlling elements in one group of registers to roll by one row of the transposed matrix or by one column of the transposed matrix in row direction or in column direction, the controller further corrects a rolling result.
Article B8. The processor of article B7, where correcting the rolling result includes:
   if it is determined to roll to the left in row direction, according to a correcting method, rolling data of a last column of each block of the transposed matrices after rolling to a last column of data of a previous adjacent block of the transposed matrices;
   if it is determined to roll to the right in row direction, according to the correcting method, rolling data of a first column of each block of the transposed matrices after rolling to a first column of data of a later adjacent block of the transposed matrices;
   If it is determined to roll up in column direction, according to the correcting method, rolling data of a last row of each block of the transposed matrices after rolling to a last row of data of a previous adjacent block of the transposed matrices; and
   if it is determined to roll down in column direction, according to the correcting method, rolling data of a first row of each block of the transposed matrices after rolling to a first row of data of a later adjacent block of the transposed matrices, where
   each block of the transposed matrices refers to each transposed matrix after partitioning.
Article B9. An operation method of matrix multiplication based on a processing element matrix, which is applied to a processor, where the processor includes two or more processing elements arranged in the form of a two-dimensional matrix, each processing element includes at least one register, the method implements a matrix multiplication operation on a first matrix and a second matrix, and the method includes:
   transposing the first matrix to obtain a transposed matrix, and loading each element of the transposed matrix and each element of the second matrix into registers of each processing element respectively, where an element of the transposed matrix and an element of a corresponding position of the second matrix are stored in a register of a same processing element;
   controlling the transposed matrix or the second matrix to roll in row direction or in column direction, controlling the processing elements to perform multiplication operations on elements in corresponding registers to obtain element products, and summing element products of a same row or element products of a same column to obtain first intermediate results; and
   processing the first intermediate results to obtain a product of the first matrix and the second matrix.
Article B10. The operation method of article B9, where controlling the transposed matrix or the second matrix to roll in row direction or in column direction, controlling the processing elements to perform the multiplication operations on the elements in the corresponding registers to obtain the element products, and summing the element products of the same row or the element products of the same column to obtain the first intermediate results include repeating the following process until elements in the transposed matrix or elements in the second matrix return to unrolled positions:
   controlling the processing elements to perform the multiplication operations on the elements in the corresponding registers to obtain the element products, summing the element products of the same row or the element products of the same column to obtain the first intermediate results, and rolling the transposed matrix or the second matrix by one row or by one column in row direction or in column direction in the matrix of the processing elements.
Article B11. The method of article B9 or article B10, where
   if the first matrix is a left multiply matrix, and the second matrix is a right multiply matrix, elements in the transposed matrix are controlled to roll in row direction, or elements in the second matrix are controlled to roll in row direction; the processing elements are controlled to perform the multiplication operations on the elements in the corresponding registers to obtain the element products, and the element products of the same column are summed to obtain the first intermediate results; and
   if the first matrix is the right multiply matrix, and the second matrix is the left multiply matrix, the elements in the transposed matrix are controlled to roll in column direction, or the elements in the second matrix are controlled to roll in column direction; the processing elements are controlled to perform the multiplication operations on the elements in the corresponding registers to obtain the element products, and the element products of the same row are summed to obtain the first intermediate results.
Article B12. The method of article B9 or article B10, where processing the first intermediate results to obtain the product of the first matrix and the second matrix includes:
   storing the first intermediate results by row or by column, and after rolling in row direction or in column direction, obtaining the product of the first matrix and the second matrix.
Article B13. The method of any one of articles B9-B12, further including:
   determining whether to partition an input matrix according to arrangements of the processing elements, a row rank of the input matrix, and a column rank of the input matrix, where the input matrix includes the left multiply matrix and the right multiply matrix;
   if it is determined to partition one matrix in the input matrix, splitting rows of the left multiply matrix or columns of the right multiply matrix according to the arrangements of the processing elements;
   if it is determined to partition two matrices in the input matrix, partitioning the left multiply matrix in column direction and the right multiply matrix in row direction in the same way according to the arrangements of the processing elements, the row rank of the input matrix, and the column rank of the input matrix; and
   obtaining two or more first matrices after the left multiply matrix is partitioned, and obtaining two or more second matrices after the right multiply matrix is partitioned, or obtaining two or more second matrices after the left multiply matrix is partitioned, and obtaining two or more first matrices after the right multiply matrix is partitioned.
Article B14. The method of article B13, further including:
   calculating a product of the left multiply matrix and the right multiply matrix according to the product of the first matrix and the second matrix.
Article B15. The method of article B13, where the processor includes a plurality of groups of registers, and
   the method further includes: transposing the two or more first matrices to obtain transposed matrices after the input matrix is partitioned;
   storing the transposed matrices and the two or more second matrices in stacks in the plurality of groups of registers, where one group of registers stores a transposed matrix and a second matrix of a corresponding position;
   before rolling elements in the transposed matrices and elements in the second matrices once in row direction or in column direction each time, controlling the processing elements to perform the multiplication operations on the elements in the corresponding registers to obtain the element products, and summing the element products of the same row or the element products of the same column to obtain the first intermediate results; and
   after controlling elements in one group of registers to roll by one row of the transposed matrix or by one column of the transposed matrix in row direction or in column direction, correcting a rolling result.
Article B16. The method of article B15, where correcting the rolling result includes:
   if it is determined to roll to the left in row direction, according to a correcting method, rolling data of a last column of each block of the transposed matrices after rolling to a last column of data of a previous adjacent block of the transposed matrices;
   if it is determined to roll to the right in row direction, according to the correcting method, rolling data of a first column of each block of the transposed matrices after rolling to a first column of data of a later adjacent block of the transposed matrices;
   if it is determined to roll up in column direction, according to the correcting method, rolling data of a last row of each block of the transposed matrices after rolling to a last row of data of a previous adjacent block of the transposed matrices; and
   if it is determined to roll down in column direction, according to the correcting method, rolling data of a first row of each block of the transposed matrices after rolling to a first row of data of a later adjacent block of the transposed matrices, where
   each block of the transposed matrices may refer to each transposed matrix after partitioning.
Article B17. An artificial intelligence chip, including the processor of any one of articles B1-B8.
Article B18. An electronic device, including the artificial intelligence chip of article B17.

During a process of processing information by means of artificial intelligence, a matrix operation may occupy a relatively large calculating amount. Moreover, during a process of processing the matrix operation, splitting the matrix operation into a multiplication operation and an addition operation for operating step by step by an existing processor requires reading data from a memory frequently, resulting in very low operation efficiency.

In related technologies, for a matrix multiplication where a size of an input matrix is relatively large, in order to improve efficiency of the matrix operation, a multi-stage pipeline method is usually adopted to perform the operation. However, in a multi-stage pipeline, since each stage may process a part of input data, it is required to read the data from the memory frequently, and frequent memory accesses lead to high demands for a bandwidth.

In order to solve the aforementioned technical problems, the present disclosure provides an operation method and a processor for performing the operation method. The processor may include a plurality of processing elements. In some implementations, the plurality of processing elements may be arranged in the form of a two-dimensional matrix to better adapt to the matrix operation.

FIGS. 3-1 is a schematic diagram of a processor according to an embodiment of the present disclosure. As shown in FIGS. 3-1, the processor may include a plurality of processing elements (PE) arranged in the form of a two-dimensional matrix, each processing element may be connected to adjacent processing elements. Each PE may be configured with at least one register (which is not shown in the figure). During an operation process, the processor may load elements of a matrix into registers corresponding to each PE. Then, the processor may control the PE to perform operations on elements stored in the registers set in the PE.

The processor may further include a controller and a memory, where both the controller and the memory may be connected to the plurality of processing elements, and the controller may be connected to the memory. The controller may be used to load input data into the registers of the processing elements from the memory and control the processing elements to process the input data. For example, the memory may store a first matrix and a second matrix (or a left multiply matrix and a right multiply matrix). The processor may be used to perform a matrix multiplication operation on the first matrix and the second matrix. Therefore, the controller may load the first matrix and the second matrix into the registers of the processing elements and control the processing elements to perform the matrix multiplication operation.

In a possible implementation, the memory may further store an executable program. The executable program may include an instruction. By executing the instruction, the matrix multiplication operation on the first matrix and the second matrix may be implemented. The controller may be configured with a loader and a decoder. The loader may be used to load input data in the memory into the registers of the processing elements, and the decoder may decode an instruction for accessing data in the executable program according to storage addresses of the input data after loading. For example, for the instruction for accessing data, storage addresses of the data in the registers obtained by decoding may be assigned to the instruction for accessing data and the decoded instruction may be sent to the processing elements, and the processing elements execute the instruction, thus implementing processing on the data, such as the matrix multiplication operation on the first matrix and the second matrix.

In a possible implementation, the memory may be an on-chip caching unit. The controller may load an executable program and input data (such as an input matrix, including a left multiply matrix and a right multiply matrix) on an off-chip flash memory into the aforementioned memory (the on-chip caching unit). Then, the controller may perform subsequent processes of the matrix multiplication operation.

In a possible implementation, the controller may also load the input matrix and the executable program from the off-chip memory into the registers of the processing elements directly, which is not limited in the present disclosure.

The PE may further include an operator for completing a specified operation. Taking a matrix operation as an example, the PE may include, for example, a multiplier and an adder. Specific structures of each PE may be the same or different. The present disclosure does not limit this. The PE may further include other types of operators to adapt to various different operation processes. The present disclosure does not limit the number and type of the operators included in the PE.

In a possible implementation, the processor (the controller) may further pre-process the input data to obtain the pre-processed input data. The processor (the controller) may further load the pre-processed input data into the registers of the processing elements. The processor (the controller) may further control the processing elements to perform operations on the pre-processed input data.

The input matrix of the multiplication operation may include a left multiply matrix and a right multiply matrix. The left multiply matrix may refer to a matrix located in a left side of a multiplication sign, and the right multiply matrix may refer to a matrix located in a right side of the multiplication sign.

Since the number and arrangements of the processing elements in the processor are known, before loading the data and calculating, the controller may determine whether to partition the input matrix according to arrangements of the processing elements, a row rank of the input matrix, and a column rank of the input matrix first. For first intermediate results obtained by operating each block of the partitioned matrices, the controller may control the processing elements to calculate a product of the input matrix according to the first intermediate results.

The arrangements of the processing elements may refer to a row number of the processing elements and a column number of the processing elements. The row rank of the input matrix may refer to a row number of the left multiply matrix and a row number of the right multiply matrix. The column rank of the input matrix may refer to a column number of the left multiply matrix and a column number of the right multiply matrix.

Determining whether to partition the input matrix according to the arrangements of the processing elements, the row rank of the input matrix, and the column rank of the input matrix means that: the controller may judge whether a row number of the input matrix is greater than the row number of the processing elements and whether a column number of the input matrix is greater than the column number of the processing elements; and the controller may determine whether to partition the input matrix according to a judging result.

If both row numbers of two matrices in the input matrix are not greater the row number of the processing elements, and both column numbers of two matrices in the input matrix are not greater the column number of the processing elements, the controller may not partition the input matrix.

If a row number of any matrix in the input matrix is greater than the row number of the processing elements, or a column number of any matrix in the input matrix is greater than the column number of the processing elements, the controller may partition the input matrix.

For example, it is assumed that an array composed of the processing elements is a matrix of M×N, which may be expressed as PE_{MN.} It is assumed that one input matrix is a matrix of m×n, which may be expressed as Aₘₙ, and another input matrix is a matrix of n × k, which may be expressed as Bₙₖ. If the controller judges that a row number m of the matrix Aₘₙ is not greater than a row number M of the processing elements and a column number n of the matrix is not greater than a column number N of the processing elements, and a row number n of Bₙₖ is not greater than the row number M of the processing elements and a column number k of the matrix is not greater than the column number N of the processing elements, the controller may not partition the input matrix.

If the row number m of the matrix Aₘₙ is greater than the row number M of the processing elements or the column number n of the matrix is greater than the column number N of the processing elements, or the row number n of the matrix Bₙₖ is greater than the row number M of the processing elements or the column number k of the matrix is greater than the column number N of the processing elements, the controller may partition the input matrix.

If it is determined to partition the input matrix, it is assumed that two or more first matrices may be obtained after the left multiply matrix is partitioned, and two or more second matrices may be obtained after the right multiply matrix is partitioned.

For a case of partitioning, if the column number of the left multiply matrix is not greater than the column number of the processing elements, the row number of the right multiply matrix is not greater than the row number of the processing elements, and the row number of the left multiply matrix is greater than the row number of the processing elements, the controller may determine to partition the left multiply matrix in the input matrix. If the column number of the right multiply matrix is greater than the column number of the processing elements, the controller may determine to partition the right multiply matrix. If it is determined to partition the left multiply matrix, the controller may split rows of the left multiply matrix according to the arrangements of the processing elements. If it is determined to partition the right multiply matrix, the controller may split columns of the right multiply matrix according to the arrangements of the processing elements.

If the column number of the left multiply matrix in the input matrix is greater than the column number of the processing elements, or the row number of the right multiply matrix is greater than the row number of the processing elements, the controller may partition the two matrices in the input matrix. In order to enable the partitioned matrices to perform the matrix multiplication operations, as long as columns of the left multiply matrix are split, rows of the right multiply matrix should be split. Therefore, either the column number of the left multiply matrix is greater than the column number of the processing elements or the row number of the right multiply matrix is greater than the row number of the processing elements, the controller should be required to partition the two matrices. If both the two matrices in the input matrix are required to be partitioned, the controller may partition the left multiply matrix in column direction and the right multiply matrix in row direction in the same way according to the arrangements of the processing elements, the row rank of the input matrix, and the column rank of the input matrix.

For example, assuming that an array of 2×2 composed of the processing elements is PE₂₂, the left multiply matrix is A₃₂, and the right multiply matrix is B₂₂, then, the left multiply matrix A₃₂ may be split into a matrix A₁₂ and a matrix A₂₂ to be multiplied with the right multiply matrix B₂₂, respectively. If the left multiply matrix is A₂₂, and the right multiply matrix is B₂₃, then, the right multiply matrix B₂₃ may be split into a matrix B₂₁ and a matrix B₂₂.

For a case where the two matrices in the input matrix are required to be partitioned, the controller may partition the left multiply matrix in column direction and the right multiply matrix in row direction in the same way. The same way of division means that a column number of a first matrix obtained after dividing is the same as a row number of a corresponding second matrix obtained after dividing, so as to ensure that the matrix operation may be completed normally.

According to the arrangements of the processing elements, the row rank of the input matrix, and the column rank of the input matrix, partitioning the left multiply matrix in column direction and partitioning the right multiply matrix in row direction may be performed in the same way. Both the first matrices obtained after partitioning and the second matrices obtained after partitioning are required to satisfy conditions of not requiring partitioning again. In other words, both the row number of the first matrix and the row number of the second matrix are not greater than the row number of the processing elements, and both the column number of the first matrix and the column number of the second matrix are not greater than the column number of the processing elements.

In a possible implementation, division may be performed in such a way that the row rank of the divided first matrix or the row rank of the divided second matrix is as close as possible to the row number of the processing elements, and the column rank of the divided first matrix or the column rank of the divided second matrix is as close as possible to the column number of the processing elements. As such, efficiency of the operation may be improved, and operation time may be reduced. In other words, assuming that the processing elements constitute an array of 4×4, then, division may be performed in such a way that the divided matrices are 4×4 first. As such, the processing elements may be utilized with maximum efficiency, and operation efficiency may be improved.

For example, it is assumed that the processing elements constitute an array of 2×2, one input matrix is a matrix of 2×4, and another input matrix is a matrix of 4×3. There are many ways of division. FIG. 3-2a and FIG. 3-2b respectively show a plurality of different ways of division. Partitioning a matrix A₂₄ in column direction and partitioning a matrix B₄₃ in row direction may be performed in the same way. FIG. 3-2a is an example of division. The matrix A₂₄ is divided into two parts in column direction, and each part includes two columns. The matrix B₄₃ is divided into two parts in row direction, and each part includes two rows, including two situations shown in (1) and (2) of FIG. 3-2a. FIG. 3-2b is another example of division. The matrix A₂₄ is divided into three parts in column direction, where one part includes two columns, and other two parts each includes one column. The matrix B₄₃ is divided into three parts in row direction, where one part includes two rows, and other two parts each includes one row. The aforementioned arrangements of the processing elements and the aforementioned ways of dividing the input matrix are just examples of the present disclosure and do not limit the present disclosure in any way.

The present disclosure does not limit the way of dividing the left multiply matrix in row direction and the way of dividing the right multiply matrix in column direction, as long as the divided matrices satisfy conditions of not requiring partitioning again.

For a case of not partitioning, or for the partitioned first matrix and the partitioned second matrix, FIG. 3-3 is a flowchart of an operation method according to an embodiment of the present disclosure. For a case of not partitioning, the controller may use the left multiply matrix as the first matrix and the right multiply matrix as the second matrix directly. The method shown in FIG. 3-3 may be performed by the controller in the processor, or the controller may control the processing elements to perform the method shown in FIG. 3-3. As shown in FIG. 3-3, the operation method of the present disclosure may include the following steps.

In a step S3-31, the first matrix and the second matrix may be pre-processed to obtain a third matrix and a fourth matrix, where an element of the third matrix and an element of a corresponding position of the fourth matrix are stored in a register of a same processing element.

Both the third matrix and the fourth matrix are matrices of p×p, and p=max(m, k, n), where m represents a row rank of the first matrix, n represents a column rank of the second matrix, both a column rank of the first matrix and a row rank of the second matrix are k, and max(m, k, n) represents taking a maximum value among m, k, and n.

In a step S3-32, the third matrix and the fourth matrix may be rolled in row direction or in column direction, and processing elements may be controlled to perform multiplication operations on elements in corresponding registers to obtain an element product matrix.

In a step S3-33, the element product matrix may be processed to obtain a product of the first matrix and the second matrix according to a way of pre-processing the first matrix and the second matrix.

For the pre-processing in the step S3-31, different rolling ways in the step S3-32 correspond to different pre-processing ways. The pre-processing may include: first pre-processing and second pre-processing. The first pre-processing may refer to extending the first matrix and the second matrix. The second pre-processing may refer to rolling elements in the extended matrices.

For a process of the first pre-processing, the controller may adopt 0 to extend the first matrix and the second matrix. Specifically, assuming that the first matrix is m×k, and the second matrix is k×n, the controller may determine a maximum value p among m, k, and n, and then the controller may use 0 to extend lower sides and/or right sides of the first matrix and the second matrix to form matrices of p×p.

For a process of the second pre-processing, in the step S3-32, processes of the second pre-processing using different rolling ways are also different. In a possible implementation, the step S3-32 may include the following processes.

In a step S3-321, the controller may control the processing elements to perform the multiplication operations on the elements in the corresponding registers to obtain a first element product matrix.

In a step S3-322, the controller may repeat the following process (p-1) times: rolling the whole third matrix to the left by one step and rolling the whole fourth matrix up by one step, or rolling the whole third matrix to the right by one step and rolling the whole fourth matrix down by one step, and controlling the processing elements to perform the multiplication operations on the elements in the corresponding registers to obtain a second element product matrix.

In other words, before rolling the third matrix and the fourth matrix, the controller may control the processing elements to perform the multiplication operations on the elements in the corresponding registers to obtain the first element product matrix. Then, the controller may repeat the following process (p-1) times: rolling the whole third matrix to the left by one step and rolling the whole fourth matrix up by one step, controlling the processing elements to perform the multiplication operations on the elements in the corresponding registers to obtain the second element product matrix. Or the controller may repeat the following process (p-1) times: rolling the whole third matrix to the right by one step and rolling the whole fourth matrix down by one step, controlling the processing elements to perform the multiplication operations on the elements in the corresponding registers to obtain the second element product matrix. In other words, after performing the step S3-322, the controller may control the processing elements to calculate to obtain p-1 second element product matrices.

For a process of rolling the whole third matrix to the left by one step and rolling the whole fourth matrix up by one step each time in the step S3-322, a corresponding process of the second pre-processing may be “rolling the i-th row of the extended first matrix to the left by i step, and rolling the j-th column of the extended second matrix up by j step, where both i and j are natural numbers, and 0≤i≤p-1 and 0≤j≤p-1”. For a process of rolling the whole third matrix to the right by one step and rolling the whole fourth matrix down by one step each time in the step S3-322, a corresponding process of the second pre-processing may be “rolling the i-th row of the extended first matrix to the left by i step and then rolling the whole matrix to the right by one step, and rolling the j-th column of the extended second matrix up by j step and then rolling the whole matrix down by one step. In other words, the corresponding process of the second pre-processing may be “rolling the i-th row of the extended first matrix to the left by i-1 step, and rolling the j-th column of the extended second matrix up by j-1 step”.

In a possible implementation, processing elements storing elements of the matrix may be connected to form a closed loop. Since adjacent processing elements are connected together, the controller may determine a loop-forming way according to dimensions of the matrix. For example, if it is required to roll in column direction, then, a first row of the processing elements storing the elements of the matrix may be connected to a last row of the processing elements. During a rolling process, if it is determined to roll up, then, elements of a first row of the matrix are rolled from original storage positions to positions where elements of a last row are stored. If it is required to roll in row direction, then, a first column of the processing elements storing the elements of the matrix may be connected to a last column of the processing elements. During the rolling process, if it is determined to roll to the left, then, elements of a first column of the matrix are rolled from original storage positions to positions where elements of a last column are stored. The above connection among the processing elements may refer to a virtual connection. In other words, there is no actual connection line, but the controller may record a corresponding processor, as long as there forms the closed loop during the process of rolling.

In a possible implementation, the pre-processing of the first matrix and the second matrix may further include a loading process. The loading process may be performed either before the first pre-processing and the second pre-processing or after the first pre-processing and the second pre-processing. In other words, in an implementation of the present disclosure, the first matrix and the second matrix may be loaded into the registers of the processing elements first, and then the third matrix and the fourth matrix may be obtained during processes of performing the first pre-processing and the second pre-processing on the first matrix and the second matrix. Or the third matrix and the fourth matrix may be obtained after the first pre-processing and the second pre-processing of the first matrix and the second matrix are completed outside the controller, and then the third matrix and the fourth matrix may be loaded into the registers of the processing elements. The present disclosure does not limit this.

It is required to be explained that the above rolling and calculating processes and the corresponding pre-processing processes in the step S3-321 and the step S3-322 are just examples of the present disclosure, and the present disclosure does not limit this.

In a possible implementation, the step S3-33 may include: summing the first element product matrix and a plurality of second element product matrices to obtain a fifth matrix, and processing the fifth matrix to obtain a matrix product according to a way of pre-processing the first matrix and the second matrix.

For processing the fifth matrix according to the way of pre-processing the first matrix and the second matrix in the step S3-33, the fifth matrix may be processed according to a process of the first pre-processing. For example, 0 may be added to right sides and lower sides of the first matrix and the second matrix to form matrices of p×p. As such, post-processing of the fifth matrix may refer to extending a right side and a lower side of the fifth matrix inversely. For example, 0 in the right side and the lower side of the fifth matrix may be omitted to form a matrix of m×n.

Based on the operation method of matrix multiplication according to the aforementioned implementations of the present disclosure, during the matrix multiplication operation, the operation may not be required to be split, data may not be required to be read repeatedly, thus decreasing the number of times of reading the memory, reducing bandwidth pressure, and having high operation efficiency. Moreover, for an input matrix with any size, by transforming the input matrix using a pre-processing way and then operating, an operation result of matrix multiplication may be obtained.

### Application Example

For example, assuming that the first matrix is

$${\text{a}}_{\text{22}} \text{=} \left[\begin{matrix}{\text{A}}_{\text{11}} & {\text{A}}_{\text{12}} \\ {\text{A}}_{\text{21}} & {\text{A}}_{\text{22}}\end{matrix}\right] ,$$

and the second matrix is

$${\text{b}}_{\text{23}} \text{=} \left[\begin{matrix}{\text{B}}_{\text{11}} & {\text{B}}_{\text{12}} & {\text{B}}_{\text{13}} \\ {\text{B}}_{\text{21}} & {\text{B}}_{\text{22}} & {\text{B}}_{\text{23}}\end{matrix}\right] \text{,}$$

since the first matrix is 2×2, and the second matrix is 2×3, which means m=2, k=2, and n=3, p may be a maximum value 3.

For the step S3-31, the first matrix and the second matrix may be loaded into the registers of the processing elements first, and then the process of the first pre-processing may be performed: extending the first matrix as

$${\text{a}}_{\text{33}} \text{=} \left[\begin{matrix}{\text{A}}_{\text{11}} & {\text{A}}_{\text{12}} & \text{0} \\ {\text{A}}_{\text{21}} & {\text{A}}_{\text{22}} & \text{0} \\ \text{0} & \text{0} & \text{0}\end{matrix}\right]$$

and extending the second matrix as

$${\text{b}}_{\text{33}} \text{=} \left[\begin{matrix}{B}_{11} & {B}_{12} & {B}_{13} \\ {B}_{21} & {B}_{22} & {B}_{23} \\ 0 & 0 & 0\end{matrix}\right] .$$

In a possible implementation, when loading, elements of first rows of the first matrix and the second matrix and elements of first columns of the first matrix and the second matrix may be loaded into registers of the same processing element. For example, the first matrix may be loaded into a first group of registers Reg0 of the processing elements, and the second matrix may be loaded into a second group of registers Reg1 of the processing elements. Each block of Reg0 may represent registers of different processing elements, and each block of Reg1 may represent registers of different processing elements. A₁₁ and B₁₁ may be stored in the registers of the same processing element. Here, the first group of registers or the second group of registers may refer to either a layer of registers divided as different layers physically or a group of registers divided logically. The present disclosure does not limit this.

Reg0

| | | |
|---|---|---|
| A₁₁ | A₁₂ | 0 |
| A₂₁ | A₂₂ | 0 |
| 0 | 0 | 0 |

Reg1

| B₁₁ | B₁₂ | B₁₃ |
|---|---|---|
| B₂₁ | B₂₂ | B₂₃ |
| 0 | 0 | 0 |

The controller may further connect the processing elements in row direction or in column direction to form the closed loop. For example, processing elements storing elements of first rows of the extended first matrix and the extended second matrix and processing elements storing elements of last rows of the extended first matrix and the extended second matrix may be connected in column direction to form the loop. Data in the loop may flow to implement the rolling of the matrix in column direction. Or processing elements storing elements of first columns of the extended first matrix and the extended second matrix and processing elements storing elements of last columns of the extended first matrix and the extended second matrix may be connected in row direction to form the loop. Data in the loop may flow to implement the rolling of the matrix in row direction.

For the above example, PE₁₁ and PE₃₁ may be connected to form the loop; PE₁₂ and PE₃₂ may be connected to form the loop; and PE₁₃ and PE₃₃ may be connected to form the loop. As such, when the data flows in the loop, if the data flows upward, then, data of a first row may flow to a third row, data of a second row may flow to the first row, and data of the third row may flow to the second row. If the data flows downward, then, the data of the first row may flow to the second row, the data of the second row may flow to the third row, and the data of the third row may flow to the first row.

PE₁₁ and PE₁₃ may also be connected to form the loop; PE₂₁ and PE₂₃ may also be connected to form the loop; and PE₃₁ and PE₃₃ may also be connected to form the loop. As such, when the data flows in the loop, if the data flows to the left, then, data of a first column may flow to a third column, data of a second column may flow to the first column, and data of the third column may flow to the second column. If the data flows to the right, then, the data of the first column may flow to the second column, the data of the second column may flow to the third column, and the data of the third column may flow to the first column.

A process of the second pre-processing: in an example (example 3-1), for the matrix a₃₃, the controller may not be required to roll the 0-th row, and the third matrix obtained by controlling elements of the 1st row to roll to the left by one step in turn and controlling elements of the 2nd row to roll to the left by two steps in turn may be as shown in the following:

Reg0

| | | |
|---|---|---|
| A₁₁ | A₁₂ | 0 |
| A₂₂ | 0 | A₂₁ |
| 0 | 0 | 0 |

For the matrix b₃₃, the controller may not be required to roll the 0-th column, and the fourth matrix obtained by controlling elements of the 1st column to roll up by one step in turn and controlling elements of the 2nd column to roll up by two steps in turn may be as shown in the following:

Reg1

| | | |
|---|---|---|
| B₁₁ | B₂₂ | 0 |
| B₂₁ | 0 | B₁₃ |
| 0 | B₁₂ | B₂₃ |

The process of the second pre-processing: in another example (example 3-2), for the matrix a₃₃, the controller may not be required to roll the 0-th row, and the third matrix obtained by controlling elements of the 1st row to roll to the left by one step in turn and controlling elements of the 2nd row to roll to the left by two steps in turn, and then by controlling the whole elements of the matrix to roll to the right by one step (or by controlling the 0-th row to roll to the right by one step, controlling the elements of the 1st row not to roll, and controlling the elements of the 2nd row to roll to the left by one step by the controller) may be as shown in the following:

Reg0

| | | |
|---|---|---|
| 0 | A₁₁ | A₁₂ |
| A₂₁ | A₂₂ | 0 |
| 0 | 0 | 0 |

For the matrix b₃₃, the controller may not be required to roll the 0-th column, and the fourth matrix obtained by controlling elements of the 1st column to roll up by one step in turn and controlling elements of the 2nd column to roll up by two steps in turn, and then by controlling the whole elements to roll down by one step is as shown in the following:

Reg1

| | | |
|---|---|---|
| 0 | B₁₂ | B₂₃ |
| B₁₁ | B₂₂ | 0 |
| B₂₁ | 0 | B₁₃ |

In a possible implementation, the third matrix and the fourth matrix may also be loaded into the registers of the processing elements after completing the pre-processing of the first matrix and the second matrix to obtain the third matrix and the fourth matrix. As long as elements of corresponding positions of the third matrix and the fourth matrix are loaded into the registers of the same processing element, the third matrix and the fourth matrix may not be required to be transposed. In other words, the third matrix and the fourth matrix may be loaded into the registers of the processing elements in a row-aligned and column-aligned fashion.

For example, the third matrix may be loaded into a first group of registers RegO of the processing elements, and the fourth matrix may be loaded into a second group of registers Reg1 of the processing elements. Each block of Reg0 may represent registers of different processing elements, and each block of Reg1 may represent registers of different processing elements. As shown in FIGS. 3-1, in combination with the third matrix and the fourth matrix obtained by pre-processing in the example 3-1 described above, storage positions of an element A₁₁ and an element B₁₁ may be registers of a processing element PE₁₁; storage positions of an element A₁₂ and an element B₂₂ may be registers of a processing element PE₁₂; and storage positions of an element A₂₁ and an element B₁₃ may be registers of a processing element PE₂₃... Here, the first group of registers or the second group of registers may refer to either a layer of registers divided as different layers physically or a group of registers divided logically. The present disclosure does not limit this.

It is required to be explained that this embodiment is just one example of the present disclosure and does not limit the present disclosure in any way, as long as the third matrix and the fourth matrix are loaded into the registers of the processing elements in the row-aligned and column-aligned fashion.

Reg0

| | | |
|---|---|---|
| A₁₁ | A₁₂ | 0 |
| A₂₂ | 0 | A₂₁ |
| 0 | 0 | 0 |

Reg1

| | | |
|---|---|---|
| B₁₁ | B₂₂ | 0 |
| B₂₁ | 0 | B₁₃ |
| 0 | B₁₂ | B₂₃ |

The processing elements may be controlled to perform the multiplication operations on the elements in the corresponding registers to obtain the first element product matrix. The first element product matrix may be as shown in the following:

| | | |
|---|---|---|
| A₁₁ B₁₁ | A₁₂B₂₂ | 0 |
| A₂₂B₂₁ | 0 | A₂₁B₁₃ |
| 0 | 0 | 0 |

For the step S3-32, the embodiment 3-1 may still be used as an example, and by rolling the whole third matrix to the left by one step, the following may be obtained:

Reg0

| | | |
|---|---|---|
| A₁₂ | 0 | A₁₁ |
| 0 | A₂₁ | A₂₂ |
| 0 | 0 | 0 |

By rolling the whole fourth matrix up by one step, the following may be obtained:

Reg1

| | | |
|---|---|---|
| B₂₁ | 0 | B₁₃ |
| 0 | B₁₂ | B₂₃ |
| B₁₁ | B₂₂ | 0 |

The processing elements may be controlled to perform the multiplication operations on the elements in the corresponding registers to obtain the second element product matrix. The second element product matrix may be as shown in the following:

| | | |
|---|---|---|
| A₁₂B₂₁ | 0 | A₁₁B₁₃ |
| 0 | A₂₁B₁₂ | A₂₂B₂₃ |
| 0 | 0 | 0 |

Here, p is 3, and p-1 is 2. Therefore, it is still required to roll the whole third matrix to the left by one step and roll the whole fourth matrix up by one step.

Reg0

| | | |
|---|---|---|
| 0 | A₁₁ | A₁₂ |
| A₂₁ | A₂₂ | 0 |
| 0 | 0 | 0 |

Reg1

| | | |
|---|---|---|
| 0 | B₁₂ | B₂₃ |
| B₁₁ | B₂₂ | 0 |
| B₂₁ | 0 | B₁₃ |

The processing elements may be controlled to perform the multiplication operations on the elements in the corresponding registers to obtain the second element product matrix.

| | | |
|---|---|---|
| 0 | A₁₁B₁₂ | A₁₂B₂₃ |
| A₂₁B₁₁ | A₂₂B₂₂ | 0 |
| 0 | 0 | 0 |

For the step S3-33, the first element product matrix and the plurality of second element product matrices may be summed to obtain the fifth matrix.

| A₁₁B₁₁ + A₁₂B₂₁ | A₁₁B₁₂ + A₁₂B₂₂ | A₁₁B₁₃ + A₁₂B₂₃ |
|---|---|---|
| A₂₁B₁₁ + A₂₂B₂₁ | A₂₁B₁₂ + A₂₂B₂₂ | A₂₁B₁₃ + A₂₂B₂₃ |
| 0 | 0 | 0 |

By extending the fifth matrix inversely (omitting the element 0 in the lower side), the matrix product may be obtained.

| | | |
|---|---|---|
| A₁₁B₁₁ + A₁₂B₂₁ | A₁₁B₁₂ + A₁₂B₂₂ | A₁₁B₁₃ + A₁₂B₂₃ |
| A₂₁B₁₁ + A₂₂B₂₁ | A₂₁B₁₂ + A₂₂B₂₂ | A₂₁B₁₃ + A₂₂B₂₃ |

In a possible implementation, the first element product matrix and the plurality of second element product matrices obtained by calculating in the above process may be stored in a temporary caching unit temporarily. Or the first element product matrix and the plurality of second element product matrices may be stored in the registers of the processing elements. For example, the first element product matrix and the plurality of second element product matrices may be stored in Reg2, Reg3, and Reg4 (other groups of registers of the processing elements). Each processing element may sum elements stored in the corresponding registers to implement a process of summing the first element product matrix and the plurality of second element product matrices. It is required to be explained that the above is just an example of calculating the fifth matrix of the present disclosure and does not limit the present disclosure in any way.

The operation method of matrix multiplication according to the aforementioned implementations of the present disclosure is more applicable to a processor composed of processing elements arranged in the form of an array, and operation efficiency is high. Moreover, for an input matrix with any size satisfying the arrangements of the processing elements, by transforming the input matrix using a pre-processing way and then operating, an operation result of matrix multiplication may be obtained. Moreover, compared with matrix multiplication operations in related technologies, the number of times of memory accesses may be decreased, bandwidth pressure may be reduced, and operation efficiency may be improved.

For a case of not partitioning, according to the above example, the result of matrix multiplication may be obtained directly. For a case of requiring partitioning, for the partitioned first matrices and the partitioned second matrices, according to rules of matrix multiplication, results obtained by multiplying the first matrices with the corresponding second matrices may be used as the first intermediate results. In other words, the first matrix obtained after partitioning and the second matrix obtained after partitioning may be used as one element in the matrix to perform the operation process of matrix multiplication to obtain the first intermediate results. By calculating according to the first intermediate results, the product of the input matrix may be obtained.

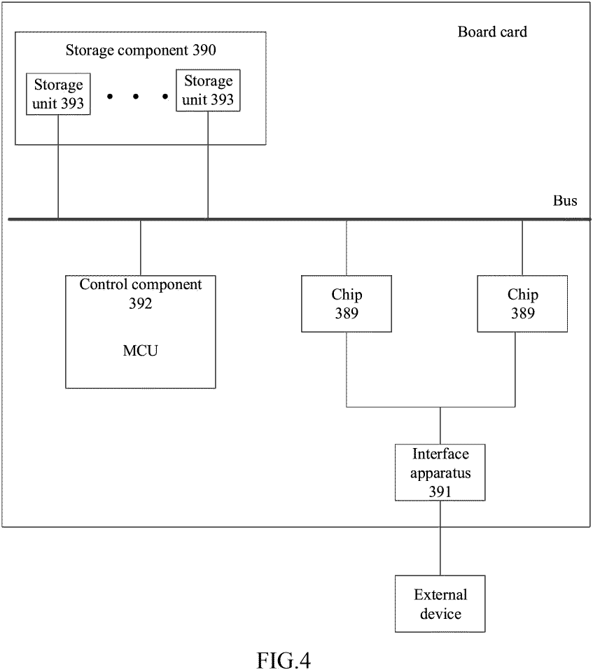

FIGS. 3-4 is a schematic diagram of partitioning according to an embodiment of the present disclosure. As shown in FIGS. 3-4, according to the above way, a matrix D may be partitioned to obtain first matrices including D₁₁, D₁₂, D₂₁, and D₂₂, and a matrix E may be partitioned to obtain second matrices including E₁₁, E₁₂, E₂₁, and E₂₂. The first matrix and the second matrix may be used as one element in the matrix to perform the operation process of matrix multiplication. For example, multiplying a first row of the matrix D with a first column of the matrix E is F₁₁=D₁₁ × E₁₁ + D₁₂ × E₂₁; multiplying the first row of the matrix D with a second column of the matrix E is F₁₂=D₁₁ × E₁₂ + D₁₂ × E₂₂; multiplying a second row of the matrix D with the first column of the matrix E is F₂₁=D₂₁ × E₁₁ + D₂₂ × E_{21;} and multiplying the second row of the matrix D with the second column of the matrix E is F₂₂=D₂₁ × E₁₂ + D₂₂ × E_{22.} In other words, in order to obtain a final operation result of matrix multiplication, it is required to obtain the first intermediate results first:

$${\text{D}}_{11} \times {\text{E}}_{11} , {\text{D}}_{12} \times {\text{E}}_{21} , {\text{D}}_{11} \times {\text{E}}_{12} , {\text{D}}_{12} \times {\text{E}}_{22} ,$$

$${\text{D}}_{21} \times {\text{E}}_{11} , {\text{D}}_{22} \times {\text{E}}_{21} , {\text{D}}_{21} \times {\text{E}}_{12} , {\text{D}}_{22} \times {\text{E}}_{22} .$$

Processes of obtaining the first intermediate results may be obtained by operating corresponding first matrices and corresponding second matrices according to processes of steps S3-31 to S3-34, respectively.

By partitioning the input matrix and performing the matrix multiplication operations of the present disclosure on the partitioned matrices respectively to obtain the first intermediate results, the product of the input matrix may be obtained by calculating according to the first intermediate results. Based on the operation method according to the aforementioned implementations of the present disclosure, for a matrix with any dimension, processes of matrix multiplication may be implemented quickly. Moreover, compared with a process of implementing the operation using a multi-stage pipeline in related technologies, the number of times of memory accesses may be decreased, bandwidth pressure may be reduced, and operation efficiency may be improved.

### Example 3-3

Assuming that the processing elements constitute an array of 2×2, taking a first way (1) of partitioning in FIG. 3-2a as an example, processes of obtaining the first intermediate results by calculating after partitioning and calculating the product of the input matrix according to the first intermediate results may be explained.

$$\begin{matrix}{\text{a}}_{\text{11}} \text{is} \left[\begin{matrix}{\text{A}}_{\text{11}} & {\text{A}}_{\text{12}} \\ {\text{A}}_{\text{21}} & {\text{A}}_{\text{22}}\end{matrix}\right] {\text{; a}}_{\text{12}} \text{is} \left[\begin{matrix}{\text{A}}_{\text{13}} & {\text{A}}_{\text{14}} \\ {\text{A}}_{\text{23}} & {\text{A}}_{\text{24}}\end{matrix}\right] \text{;} \\ {\text{b}}_{\text{11}} \text{is} \left[\begin{matrix}{\text{B}}_{\text{11}} & {\text{B}}_{\text{12}} \\ {\text{B}}_{\text{21}} & {\text{B}}_{\text{22}}\end{matrix}\right] {\text{; b}}_{\text{21}} \text{is} \left[\begin{matrix}{\text{B}}_{\text{13}} & {\text{B}}_{\text{14}} \\ {\text{B}}_{\text{23}} & {\text{B}}_{\text{24}}\end{matrix}\right] {\text{; b}}_{\text{12}} \text{is} \\ \left[\begin{matrix}{\text{B}}_{\text{13}} \\ {\text{B}}_{\text{23}}\end{matrix}\right] {\text{; and b}}_{\text{22}} \text{is} \left[\begin{matrix}{\text{B}}_{\text{33}} \\ {\text{B}}_{\text{43}}\end{matrix}\right] \text{.}\end{matrix}$$

Then, a calculating process of a₁₁ × b₁₁ according to steps S3-31 to S3-33 is as shown in the following.

For the step S3-31, since both the matrix a₁₁ and the matrix a₁₂ are matrices of 2×2, the extending is not required. The process of the second pre-processing may be the following: for the matrix a₁₁, the controller may not be required to roll the 0-th row, and the third matrix obtained by controlling elements of the 1st row to roll to the left by one step in turn may be as shown in the following.

$$\left[\begin{matrix}{\text{A}}_{\text{11}} & {\text{A}}_{\text{12}} \\ {\text{A}}_{\text{22}} & {\text{A}}_{\text{21}}\end{matrix}\right]$$

For a₁₂, the controller may not be required to roll the 0-th column, and the fourth matrix obtained by controlling elements of the 1st column to roll up by one step in turn may be as shown in the following.

$$\left[\begin{matrix}{\text{B}}_{\text{11}} & {\text{B}}_{\text{22}} \\ {\text{B}}_{\text{21}} & {\text{B}}_{\text{12}}\end{matrix}\right]$$

The element of the third matrix and the element of the corresponding position of the fourth matrix are stored in the registers of the same processing element. For example, the third matrix may be stored in a first group of registers RegO of the processing elements, and the fourth matrix may be stored in a second group of registers Reg1 of the processing elements. Storage positions of an element A₁₁ and an element B₁₁ may be registers of a processing element PE₁₁; storage positions of an element A₁₂ and an element B₂₂ may be registers of a processing element PE₁₂; and storage positions of an element A₂₂ and an element B₂₁ may be registers of a processing element PE₂₁.

Reg0

| | |
|---|---|
| A₁₁ | A₁₂ |
| A₂₂ | A₂₁ |

Reg1

| | |
|---|---|
| B₁₁ | B₂₂ |
| B₂₁ | B₁₂ |

The processing elements may be controlled to perform the multiplication operations on the elements in the corresponding registers to obtain the first element product matrix. The first element product matrix may be as shown in the following.

| | |
|---|---|
| A₁₁B₁₁ | A₁₂B₂₂ |
| A₂₂B₂₁ | A₂₁B₁₂ |

For the step S3-32, the example 3-1 may still be used as an example, and by rolling the whole third matrix to the left by one step, the following may be obtained:

Reg0

| | |
|---|---|
| A₁₂ | A₁₁ |
| A₂₁ | A₂₂ |

By rolling the whole fourth matrix up by one step, the following may be obtained:

Reg1

| | |
|---|---|
| B₂₁ | B₁₂ |
| B₁₁ | B₂₂ |

The processing elements may be controlled to perform the multiplication operations on the elements in the corresponding registers to obtain the second element product matrix. The second element product matrix may be as shown in the following.

| | |
|---|---|
| A₁₂B₂₁ | A₁₁B₁₂ |
| A₂₁B₁₁ | A₂₂B₂₂ |

Here, p is 2, and p-1 is 1. Therefore, the rolling process ends.

For the step S3-33, the first element product matrix and the second element product matrix may be summed to obtain the fifth matrix.

| | |
|---|---|
| A₁₁B₁₁ + A₁₂B₂₁ | A₁₂B₂₂ + A₁₁B₁₂ |
| A₂₂B₂₁ + A₂₁B₁₁ | A₂₁B₁₂ + A₂₂B₂₂ |

Since both the first matrix and the second matrix are not extended, a process of extending inversely may also not be required. Therefore, the above results are the first intermediate results of a₁₁ × b₁₁.

For a₁₂ × b₂₁, a₁₁ × b₁₂, and a₁₂ × b₂₂, processes of steps S3-31 to S3-33 may also be adopted to obtain the first intermediate results. Then, the product of the input matrix may be calculated according to the first intermediate results. The calculating processes are:

$${\text{C}}_{\text{11}} {\text{=a}}_{\text{11}} \times {\text{b}}_{\text{11}} + {\text{a}}_{\text{12}} \times {\text{b}}_{\text{21}}$$

$${\text{C}}_{\text{12}} {\text{=a}}_{\text{11}} \times {\text{b}}_{\text{12}} + {\text{a}}_{\text{12}} \times {\text{b}}_{\text{22}}$$

The above shows the operation method of matrix multiplication according to the implementations of the present disclosure. According to the above process, a way of partitioning may be adopted to calculate to obtain the product of the input matrix. Therefore, according to the operation method of matrix multiplication of the present disclosure, a matrix operation with any size may be implemented.

The present disclosure also provides a processor. FIGS. 3-1 shows an exemplary processor. The processor may include two or more processing elements arranged in the form of a two-dimensional matrix. Each processing element may include at least one register. The processor may be used to implement a matrix multiplication operation on a first matrix and a second matrix.

The processor may further include a controller. The controller may be used to pre-process the first matrix and the second matrix to obtain a third matrix and a fourth matrix. An element of the third matrix and an element of a corresponding position of the fourth matrix are stored in a register of a same processing element. Both the third matrix and the fourth matrix are matrices of p×p, and p=max(m, k, n), where m represents a row rank of the first matrix, n represents a column rank of the second rank, both a column rank of the first matrix and a row rank of the second matrix are k, and p is a maximum value among m, k, and n.

The controller may be used to roll the third matrix and the fourth matrix in row direction or in column direction. The controller may be used to control the processing elements to perform multiplication operations on elements in corresponding registers to obtain an element product matrix.

The controller may be used to process the element product matrix to obtain a product of the first matrix and the second matrix according to a way of pre-processing the first matrix and the second matrix.

In a possible implementation, the controller may be further used to control the processing elements to perform the multiplication operations on the elements in the corresponding registers to obtain a first element product matrix.

The controller may repeat the following process (p-1) times: rolling the whole third matrix to the left once and rolling the whole fourth matrix up once, or rolling the whole third matrix to the right once and rolling the whole fourth matrix down once, and controlling the processing elements to perform the multiplication operations on the elements in the corresponding registers to obtain a second element product matrix.

In a possible implementation, the controller may be used to sum the first element product matrix and the second element product matrix to obtain a fifth matrix. According to a way of pre-processing the first matrix and the second matrix, the controller may be used to process the fifth matrix to obtain the product of the first matrix and the second matrix.

In a possible implementation, the pre-processing of the first matrix and the second matrix of the controller may include: first pre-processing and second pre-processing.

The first pre-processing may refer to: adopting 0 to extend right sides and/or lower sides of the first matrix and the second matrix to obtain matrices of p×p.

The second pre-processing may refer to: rolling elements in the extended matrices of p×p.

In a possible implementation, for a way of rolling the whole third matrix to the left and rolling the whole fourth matrix up, a corresponding process of the second pre-processing may be: rolling the i-th row of the extended first matrix to the left by i step, and rolling the j-th column of the extended second matrix up by j step, where both i and j are natural numbers, and 0≤i≤p-1 and 0≤j≤p-1.

In a possible implementation, for a way of rolling the whole third matrix to the right and rolling the whole fourth matrix down, a corresponding process of the second pre-processing may be: rolling the i-th row of the extended first matrix to the left by i-1 step, and rolling the j-th column of the extended second matrix up by j-1 step.

In a possible implementation, the controller may be further used to determine whether to partition the input matrix according to arrangements of the processing elements, a row rank of the input matrix, and a column rank of the input matrix, where the input matrix may include a left multiply matrix and a right multiply matrix.

If it is determined to partition the left multiply matrix, the controller may split rows of the left multiply matrix according to the arrangements of the processing elements. If it is determined to partition the right multiply matrix, the controller may split columns of the right multiply matrix according to the arrangements of the processing elements.

If it is determined to partition two matrices in the input matrix, the controller may partition the left multiply matrix in column direction and the right multiply matrix in row direction in the same way according to the arrangements of the processing elements, the row rank of the input matrix, and the column rank of the input matrix.

Two or more first matrices may be obtained after the left multiply matrix is partitioned, and two or more second matrices may be obtained after the right multiply matrix is partitioned. Or two or more second matrices may be obtained after the left multiply matrix is partitioned, and two or more first matrices may be obtained after the right multiply matrix is partitioned.

In a possible implementation, if a column number of the left multiply matrix is not greater than a column number of the processing elements, a row number of the right multiply matrix is not greater than a row number of the processing elements, and a row number of the left multiply matrix is greater than the row number of the processing elements, the controller may determine to partition the left multiply matrix. If a column number of the right multiply matrix is greater than the column number of the processing elements, the controller may determine to partition the right multiply matrix.

If the column number of the left multiply matrix in the input matrix is greater than the column number of the processing elements, or the row number of the right multiply matrix is greater than the row number of the processing elements, the controller may partition the two matrices in the input matrix.

In a possible implementation, the controller may be further used to, based on rules of matrix multiplication, calculate a product of the left multiply matrix and the right multiply matrix according to the product of the first matrix and the second matrix.

For a detailed process of performing the matrix multiplication operation by the processor of the embodiments of the present disclosure, reference may be made to the above method embodiments, which will not be repeated herein.

In an embodiment of the present disclosure, an artificial intelligence chip is also provided. The chip includes the aforementioned processor. In an embodiment of the present disclosure, an operation apparatus is also provided. The operation apparatus includes the aforementioned processor.

In a possible implementation, a board card is also disclosed. The board card includes a storage component, an interface apparatus, a control component, and the aforementioned artificial intelligence chip. The artificial intelligence chip may be connected to the storage component, the control component, and the interface apparatus, respectively. The storage component may be used to store data. The interface apparatus may be used to implement data transfer between the artificial intelligence chip and an external device. The control component may be used to monitor a state of the artificial intelligence chip.

The foregoing may be better understood according to the following articles:
Article C1. An operation method of matrix multiplication based on a processing element matrix, which is applied to a processor, where the processor includes two or more processing elements arranged in the form of a two-dimensional matrix, each processing element includes at least one register, the method implements a matrix multiplication operation on a first matrix and a second matrix, and the method includes:
   pre-processing the first matrix and the second matrix to obtain a third matrix and a fourth matrix, where an element of the third matrix and an element of a corresponding position of the fourth matrix are stored in a register of a same processing element, both the third matrix and the fourth matrix are matrices of p×p, and p=max(m, k, n), where m represents a row rank of the first matrix, n represents a column rank of the second rank, both a column rank of the first matrix and a row rank of the second matrix are k, and p is a maximum value among m, k, and n;
   rolling the third matrix and the fourth matrix in row direction or in column direction, and controlling the processing elements to perform multiplication operations on elements in corresponding registers to obtain an element product matrix; and
   processing the element product matrix to obtain a product of the first matrix and the second matrix according to a way of pre-processing the first matrix and the second matrix.
Article C2. The method of article C1, where rolling the third matrix and the fourth matrix in row direction or in column direction and controlling the processing elements to perform the multiplication operations on the elements in the corresponding registers to obtain the element product matrix include:
   controlling the processing elements to perform the multiplication operations on the elements in the corresponding registers to obtain a first element product matrix; and
   repeating the following process (p-1) times: rolling the whole third matrix to the left once and rolling the whole fourth matrix up once, or rolling the whole third matrix to the right once and rolling the whole fourth matrix down once, and controlling the processing elements to perform the multiplication operations on the elements in the corresponding registers to obtain a second element product matrix.
Article C3. The method of article C2, where processing the element product matrix to obtain the product of the first matrix and the second matrix according to the way of pre-processing the first matrix and the second matrix includes:
   summing the first element product matrix and the second element product matrix to obtain a fifth matrix, and processing the fifth matrix to obtain the product of the first matrix and the second matrix according to the way of pre-processing the first matrix and the second matrix.
Article C4. The method of article C1, where pre-processing the first matrix and the second matrix to obtain the third matrix and the fourth matrix includes first pre-processing and second pre-processing, where
   the first pre-processing refers to adopting 0 to extend right sides and/or lower sides of the first matrix and the second matrix to obtain matrices of p×p; and
   the second pre-processing refers to rolling elements in the extended matrices of p×p.
Article C5. The method of article C4, where
   for a way of rolling the whole third matrix to the left and rolling the whole fourth matrix up, a corresponding process of the second pre-processing is: rolling the i-th row of the extended first matrix to the left by i step, and rolling the j-th column of the extended second matrix up by j step, where both i and j are natural numbers, and 0≤i≤p-1 and 0≤j≤p-1.
Article C6. The method of article C4, where
   for a way of rolling the whole third matrix to the right and rolling the whole fourth matrix down, a corresponding process of the second pre-processing is: rolling the i-th row of the extended first matrix to the left by i-1 step, and rolling the j-th column of the extended second matrix up by j-1 step.
Article C7. The method of any one of articles C1-C6, further including:
   determining whether to partition an input matrix according to arrangements of the processing elements, a row rank of the input matrix, and a column rank of the input matrix, where the input matrix includes a left multiply matrix and a right multiply matrix;
   if it is determined to partition the left multiply matrix, splitting rows of the left multiply matrix according to the arrangements of the processing elements; if it is determined to partition the right multiply matrix, splitting columns of the right multiply matrix according to the arrangements of the processing elements;
   if it is determined to partition two matrices in the input matrix, partitioning the left multiply matrix in column direction and the right multiply matrix in row direction in the same way according to the arrangements of the processing elements, the row rank of the input matrix, and the column rank of the input matrix; and
   obtaining two or more first matrices after the left multiply matrix is partitioned, and obtaining two or more second matrices after the right multiply matrix is partitioned, or obtaining two or more second matrices after the left multiply matrix is partitioned, and obtaining two or more first matrices after the right multiply matrix is partitioned.
Article C8. The method of article C7, where determining whether to partition the input matrix according to the arrangements of the processing elements, the row rank of the input matrix, and the column rank of the input matrix includes:
   if a column number of the left multiply matrix is not greater than a column number of the processing elements, a row number of the right multiply matrix is not greater than a row number of the processing elements, and a row number of the left multiply matrix is greater than the row number of the processing elements, determining to partition the left multiply matrix; if a column number of the right multiply matrix is greater than the column number of the processing elements, determining to partition the right multiply matrix; and
   if the column number of the left multiply matrix in the input matrix is greater than the column number of the processing elements, or the row number of the right multiply matrix is greater than the row number of the processing elements, partitioning the two matrices in the input matrix.
Article C9. The method of article C7, further including: based on rules of matrix multiplication, calculating a product of the left multiply matrix and the right multiply matrix according to the product of the first matrix and the second matrix.
Article C10. A processor, where the processor includes two or more processing elements arranged in the form of a two-dimensional matrix; each processing element includes at least one register; the processor is used to perform a matrix multiplication operation on a first matrix and a second matrix; and the processor further includes a controller, which is used to pre-process the first matrix and the second matrix to obtain a third matrix and a fourth matrix, where an element of the third matrix and an element of a corresponding position of the fourth matrix are stored in a register of a same processing element; both the third matrix and the fourth matrix are matrices of p×p, and p=max(m, k, n), where m represents a row rank of the first matrix; n represents a column rank of the second rank; both a column rank of the first matrix and a row rank of the second matrix are k; and p is a maximum value among m, k, and n;
   the controller is used to roll the third matrix and the fourth matrix in row direction or in column direction and control the processing elements to perform multiplication operations on elements in corresponding registers to obtain an element product matrix; and
   the controller is used to process the element product matrix to obtain a product of the first matrix and the second matrix according to a way of pre-processing the first matrix and the second matrix.
Article C11. The processor of article C10, where the controller is further used to control the processing elements to perform the multiplication operations on the elements in the corresponding registers to obtain a first element product matrix; and
   the controller repeats to roll the whole third matrix to the left once and roll the whole fourth matrix up once (p-1) times, or the controller repeats to roll the whole third matrix to the right once and roll the whole fourth matrix down once (p-1) times, and the controller controls the processing elements to perform the multiplication operations on the elements in the corresponding registers to obtain a second element product matrix.
Article C12. The processor of article C11, where the controller is used to sum the first element product matrix and the second element product matrix to obtain a fifth matrix and process the fifth matrix to obtain the product of the first matrix and the second matrix according to the way of pre-processing the first matrix and the second matrix.
Article C13. The processor of article C10, where pre-processing of the first matrix and the second matrix by the controller includes first pre-processing and second pre-processing, where
   the first pre-processing refers to adopting 0 to extend right sides and/or lower sides of the first matrix and the second matrix to obtain matrices of p×p; and
   the second pre-processing refers to rolling elements in the extended matrices of p×p.
Article C14. The processor of article C13, where for a way of rolling the whole third matrix to the left and rolling the whole fourth matrix up, a corresponding process of the second pre-processing is: rolling the i-th row of the extended first matrix to the left by i step, and rolling the j-th column of the extended second matrix up by j step, where both i and j are natural numbers, and 0≤i≤p-1 and 0≤j≤p-1.
Article C15. The processor of article C13, where for a way of rolling the whole third matrix to the right and rolling the whole fourth matrix down, a corresponding process of the second pre-processing is: rolling the i-th row of the extended first matrix to the left by i-1 step, and rolling the j-th column of the extended second matrix up by j-1 step.
Article C16. The processor of any one of articles C10-C15, where
   the controller is further used to determine whether to partition an input matrix according to arrangements of the processing elements, a row rank of the input matrix, and a column rank of the input matrix, where the input matrix includes a left multiply matrix and a right multiply matrix;
   if it is determined to partition the left multiply matrix, the controller splits rows of the left multiply matrix according to the arrangements of the processing elements; if it is determined to partition the right multiply matrix, the controller splits columns of the right multiply matrix according to the arrangements of the processing elements;
   if it is determined to partition two matrices in the input matrix, the controller partitions the left multiply matrix in column direction and the right multiply matrix in row direction in the same way according to the arrangements of the processing elements, the row rank of the input matrix, and the column rank of the input matrix; and
   two or more first matrices are obtained after the left multiply matrix is partitioned, and two or more second matrices are obtained after the right multiply matrix is partitioned, or two or more second matrices are obtained after the left multiply matrix is partitioned, and two or more first matrices are obtained after the right multiply matrix is partitioned.
Article C17. The processor of article C16, where, if a column number of the left multiply matrix is not greater than a column number of the processing elements, a row number of the right multiply matrix is not greater than a row number of the processing elements, and a row number of the left multiply matrix is greater than the row number of the processing elements, the controller determines to partition the left multiply matrix; if a column number of the right multiply matrix is greater than the column number of the processing elements, the controller determines to partition the right multiply matrix; and
   if the column number of the left multiply matrix in the input matrix is greater than the column number of the processing elements, or the row number of the right multiply matrix is greater than the row number of the processing elements, the controller partitions the two matrices in the input matrix.
Article C18. The processor of article C16, where, based on rules of matrix multiplication, the controller is further used to calculate a product of the left multiply matrix and the right multiply matrix according to the product of the first matrix and the second matrix.

FIG. 4 is a structural block diagram of a board card according to an embodiment of the present disclosure. Referring to FIG. 4, in addition to the aforementioned chip 189, the board card may further include other supporting components. The supporting components include but are not limited to a storage component 190, an interface apparatus 191, and a control component 192.

The storage component 190 may be connected to the artificial intelligence chip through a bus. The storage component 190 may be used to store data. The storage component may include a plurality of groups of storage units 193. Each group of storage units may be connected to the artificial intelligence chip through the bus. It may be understood that each group of storage units may be a double data rate (DDR) synchronous dynamic random access memory (SDRAM).

The DDR may double the speed of the SDRAM without increasing clock frequency. The DDR may allow data to be read on rising and falling edges of a clock pulse. The speed of the DDR is twice that of a standard SDRAM. In an embodiment, the storage component may include four groups of storage units. Each group of storage units may include a plurality of DDR4 particles (chips). In an embodiment, four 72-bit DDR4 controllers may be arranged inside the artificial intelligence chip, where 64 bits of each 72-bit DDR4 controller are used for data transfer, and 8 bits are used for error checking and correcting (ECC) parity.

In an embodiment, each group of storage units may include a plurality of DDR SDRAMs arranged in parallel. The DDR may transfer data twice in one clock cycle. A controller for controlling the DDR may be arranged in the chip, and the controller may be used to control data transfer and data storage of each storage unit.

The interface apparatus may be electrically connected to the artificial intelligence chip. The interface apparatus may be used to implement data transfer between the artificial intelligence chip and an external device (such as a server or a computer). For example, in an embodiment, the interface apparatus may be a standard peripheral component interconnect express (PCIe) interface. For instance, to-be-processed data may be transferred by the server through the standard PCIe interface to the chip, thereby implementing data transfer. In another embodiment, the interface apparatus may also be other interfaces. The present disclosure does not restrict specific forms of other interfaces, as long as an interface unit may realize a transferring function. In addition, a calculating result of the artificial intelligence chip may still be transferred by the interface apparatus to the external device (such as the server).

The control component may be electrically connected to the artificial intelligence chip. The control component may be used to monitor a state of the artificial intelligence chip. Specifically, the artificial intelligence chip and the control component may be electrically connected through a serial peripheral interface (SPI). The control component may include a micro controller unit (MCU). If the artificial intelligence chip may include a plurality of processing chips, a plurality of processing cores, or a plurality of processing circuits, the chip may be capable of driving a plurality of loads. Therefore, the artificial intelligence chip may be in different working states, such as a multi-load state and a light-load state. Through the control component, regulation and controls of working states of the plurality of processing chips, the plurality of processing cores, and/or the plurality of processing circuits may be implemented.

In an embodiment of the present disclosure, a computer-readable storage medium is also provided. The computer-readable storage medium stores a computer program instruction. When the computer program instruction is executed by a processor, the aforementioned method is performed. The computer-readable storage medium may be a nonvolatile computer-readable storage medium.

In an embodiment of the present disclosure, an electronic device is also provided. The electronic device includes the aforementioned processor.

It should be understood that the aforementioned embodiments are just illustrative, and the apparatus of the present disclosure may also be implemented in other ways. For example, a division of units/modules in the aforementioned embodiments is just a logical function division, and there may be other ways of division in actual implementations. For example, a plurality of units, modules, or components may be combined or integrated into another system, or some features may be omitted or may not be implemented.

In addition, unless otherwise specified, functional units/modules in various embodiments of the present disclosure may be integrated into one unit/module. Alternatively, each unit/module may exist alone physically. Alternatively, two or more units/modules may be integrated together. The aforementioned integrated unit/module may be implemented in the form of hardware or in the form of a software program module.

If the aforementioned integrated unit/module is implemented in the form of hardware, the hardware may be a digital circuit, an analog circuit, and the like. Physical implementations of the structure of the hardware include but are not limited to, a transistor, a memristor, and the like.

If the integrated unit/module is implemented in the form of the software program module and sold or used as an independent product, the integrated unit/module may be stored in a computer-readable memory. Based on such understanding, the essence of the technical solution of the present disclosure, or a part of the present disclosure that contributes to the prior art, or all or part of the technical solution, may be embodied in the form of a software product. The computer software product may be stored in a memory. The software product includes several instructions used to enable a computer device (which may be a personal computer, a server, or a network device, and the like) to perform part or all of steps of the method of the embodiments of the present disclosure. The foregoing memory includes: a USB flash drive, a read-only memory (ROM), a random access memory (RAM), a mobile hard disk, a magnetic disk, or an optical disc, and other media that may store a program code.

In the above embodiments, the description of each embodiment has its own emphasis. For a part that is not described in detail in a certain embodiment, reference may be made to related descriptions in other embodiments. Each technical feature of the above embodiments may be randomly processed. For the sake of conciseness, not all possible processing of each technical feature of the above embodiments are described. Yet, provided that there is no contradiction, processing of these technical features shall fall within the scope of the description of the present specification.

The present disclosure may be a system, a method, and/or a computer program product. The computer program product may include a computer-readable storage medium loaded with computer-readable program instructions for enabling a processor to implement various aspects of the present disclosure.

The computer-readable storage medium may be a tangible device that may hold and store an instruction used by an instruction execution device. The computer-readable storage medium may be, for example, but may not be limited to, an electrical storage device, a magnetic storage device, an optical storage device, an electromagnetic storage device, a semiconductor storage device, or any suitable processing of the above. More specific examples (a non-exhaustive list) of the computer-readable storage medium include: a portable computer disk, a hard disk, a random access memory (RAM), a read-only memory (ROM), an erasable programmable read-only memory (EPROM or a flash memory), a static random access memory (SRAM), a portable compact disk read-only memory (CD-ROM), a digital versatile disk (DVD), a memory stick, a floppy disk, a mechanical encoding device, a punched card or a groove structure with protrusion inside where an instruction is stored, and any suitable processing of the above. The computer-readable storage medium used herein should not be interpreted as a transient signal itself, such as radio waves or other electromagnetic waves that are freely propagated, electromagnetic waves that are propagated through waveguides or other transmission media (such as light pulses through fiber-optic cables), or electrical signals that are transferred through wires.

The computer-readable program instructions described herein may be downloaded from the computer-readable storage medium to various calculating/processing devices, or downloaded to an external computer or an external storage device via a network, such as the Internet, a local area network, a wide area network, and/or a wireless network. The network may include copper transmission cables, optical fiber transmission, wireless transmission, routers, firewalls, switches, gateway computers, and/or edge servers. The network adapter card or network interface in each calculating/processing device receives the computer-readable program instructions from the network and forwards the computer-readable program instructions for storage in the computer-readable storage medium in each calculating/processing device.

The computer program instruction used to perform operations of the present disclosure may be an assembly instruction, an instruction set architecture (ISA) instruction, a machine instruction, a machine-related instruction, a microcode, a firmware instruction, status setting data, or a source code or an object code written in any processing of one or more programming languages. The programming languages include object-oriented programming languages such as Smalltalk, C++, and conventional procedural programming languages such as “C” language or similar programming languages. The computer-readable program instructions may be executed entirely on a subscriber computer, executed partly on the subscriber computer, executed as an independent software package, executed partly on the subscriber computer and executed partly on a remote computer, or executed entirely on the remote computer or the server. In the case of the remote computer, the remote computer may be connected to the subscriber computer through any kind of network, including a local area network (LAN) or a wide area network (WAN), or the remote computer may be connected to an external computer (for example, the remote computer may be connected to the external computer through the Internet provided by an Internet service provider). In some embodiments, status information of the computer-readable program instructions may be used to customize an electronic circuit such as a programmable logic circuit, a field programmable gate array (FPGA), or a programmable logic array (PLA). The electronic circuit may execute the computer-readable program instructions to implement various aspects of the present disclosure.

Here, various aspects of the present disclosure are described according to flowcharts and/or block diagrams of the method, the apparatus (system), and the computer program product of the embodiments of the present disclosure. It should be understood that each block of the flowcharts and/or the block diagrams and processing of the blocks in the flowcharts and/or the block diagrams may be implemented by the computer-readable program instructions.

The computer-readable program instructions may be provided to the processor of a general-purpose computer, a special-purpose computer, or other programmable data processing apparatus to generate a machine. As such, when the instructions are performed by the processor of the computer or other programmable data processing apparatus, an apparatus for realizing a function/action specified in one or more blocks in the flowcharts and/or the block diagrams may be generated. These computer-readable program instructions may also be stored in the computer-readable storage medium. The instructions may enable the computer, the programmable data processing apparatus, and/or another device to work in a specific manner, so that the computer-readable storage medium storing the instructions includes a product including an instruction for realizing various aspects of the function/action specified in one or more blocks in the flowcharts and/or the block diagrams.

The computer-readable program instructions may also be loaded into the computer, other programmable data processing apparatus, or other devices, so that a series of operation steps are executed on the computer, another programmable data processing apparatus, or another device to produce a process of computer implementation. As such, the instructions that are executed on the computer, another programmable data processing apparatus, or another device may realize the function/action specified in one or more blocks in the flowcharts and/or the block diagrams.

The flowcharts and the block diagrams in the drawings show architectures, functions, and operations of possible implementations of the system, the method, and the computer program product according to a plurality of embodiments of the present disclosure. In this regard, each block in the flowcharts or the block diagrams may represent a part of a module, a program segment, or an instruction. The part of the module, the program segment, or the instruction includes one or more executable instructions for realizing a specified logic function. In some alternative implementations, functions marked in the blocks may also occur in a different order. For example, depending on a function involved, actually, two consecutive blocks may be executed in parallel basically. Sometimes, the two consecutive blocks may be executed in reverse order. It should also be noted that each block in the block diagrams and/or the flowcharts, and the processing of the blocks in the block diagrams and/or the flowcharts may be implemented by a dedicated hardware-based system that performs a specified function or action, or by processing of dedicated hardware and a computer instruction.

The embodiments of the present disclosure have been described in detail above. Specific examples have been used in the specification to explain principles and implementations of the present disclosure. Descriptions of the above embodiments are only used to facilitate understanding of the method and core ideas of the present disclosure. Simultaneously, those skilled in the art may change or transform specific implementations and application scope of the present disclosure based on ideas of the present disclosure. The changes and transformations shall all fall within the scope of protection of the present disclosure. In summary, the content of this specification should not be construed as a limitation on the present disclosure.

1. An operation method of matrix multiplication based on a processing element matrix, which is applied to a processor, wherein the processor comprises two or more processing elements arranged in the form of a two-dimensional matrix, each processing element comprises at least one register, and the method implements a matrix multiplication operation on a first matrix and a second matrix; and
the method comprises:
loading the first matrix into registers of the processing elements;
for each row of the second matrix, storing elements in each row of the second matrix and elements of each column of the first matrix to the registers of the processing elements correspondingly, obtaining products of the elements in each row of the second matrix and the elements of each column of the first matrix respectively, and summing products of one column to obtain a first intermediate result; or for each column of the second matrix, storing elements in each column of the second matrix and elements of each row of the first matrix to the registers of the processing elements correspondingly, obtaining products of the elements in each column of the second matrix and the elements of each row of the first matrix respectively, and summing products of one row to obtain the first intermediate result; and
processing first intermediate results to obtain a product of the first matrix and the second matrix.

2. The method of claim 1, wherein the first matrix is a left multiply matrix, and the second matrix is a right multiply matrix; and
for elements of each column of the second matrix, each of the elements of each column of the second matrix and elements of a corresponding column of the first matrix are stored to the registers of the processing elements, each processing element is controlled to perform multiplication operations on elements in corresponding registers to obtain element products, and element products of each row are summed to obtain the first intermediate results, wherein
the elements of the column of the first matrix corresponding to each of the elements of each column of the second matrix mean that a row number of the element in the second matrix is the same as a column number of the elements of the column.

3. The method of claim 1, wherein the first matrix is a right multiply matrix, and the second matrix is a left multiply matrix; and
for elements of each row of the second matrix, each of the elements of each row of the second matrix and elements of a corresponding row of the first matrix are stored to the registers of the processing elements, each processing element is controlled to perform multiplication operations on elements in corresponding registers to obtain element products, and element products of each column are summed to obtain the first intermediate results, wherein
the elements of the row of the first matrix corresponding to each of the elements of each row of the second matrix mean that a column number of the element in the second matrix is the same as a row number of the elements of the row.

4. The method of claim 1, further comprising:
according to arrangements of the processing elements, determining a matrix that is not required to be partitioned from an input matrix as the first matrix, and determining another matrix in the input matrix as the second matrix, wherein the input matrix comprises the left multiply matrix and the right multiply matrix.

5. The method of claim 1, further comprising:
determining a to-be-loaded matrix from an input matrix, wherein the input matrix comprises the left multiply matrix and the right multiply matrix, and the to-be-loaded matrix is the left multiply matrix or the right multiply matrix;
determining whether to partition the to-be-loaded matrix according to arrangements of the processing elements, a row rank of the to-be-loaded matrix, and a column rank of the to-be-loaded matrix; and
if it is determined to partition the to-be-loaded matrix, partitioning the to-be-loaded matrix to obtain two or more first matrices according to the arrangements of the processing elements, the row rank of the to-be-loaded matrix, and the column rank of the to-be-loaded matrix.

6. The method of claim 5, further comprising:
according to a way of partitioning the to-be-loaded matrix, partitioning another matrix in the input matrix besides the to-be-loaded matrix to obtain two or more second matrices; and
according to products of the first matrices and corresponding second matrices, based on rules of matrix multiplication, calculating a product of the left multiply matrix and the right multiply matrix.

7. The method of claim 5, wherein the processor comprises a plurality of groups of registers, and the method further comprises:
after partitioning the input matrix, storing the two or more first matrices in stacks in the plurality of groups of registers, wherein each group stores one first matrix.

8. A processor, wherein the processor comprises two or more processing elements arranged in the form of a two-dimensional matrix, each processing element comprises at least one register, and the processor is used to perform a matrix multiplication operation on a first matrix and a second matrix;
the processor further comprises a controller, which is configured to load the first matrix into registers of the processing elements;
for each row of the second matrix, the controller is used to store elements in each row of the second matrix and elements of each column of the first matrix to the registers of the processing elements correspondingly, obtain products of the elements in each row of the second matrix and the elements of each column of the first matrix respectively, and sum products of one column to obtain a first intermediate result; or for each column of the second matrix, the controller is used to store elements in each column of the second matrix and elements of each row of the first matrix to the registers of the processing elements correspondingly, obtain products of the elements in each column of the second matrix and the elements of each row of the first matrix respectively, and sum products of one row to obtain the first intermediate result; and
the controller is further used to process first intermediate results to obtain a product of the first matrix and the second matrix.

9. The processor of claim 8, wherein the first matrix is a left multiply matrix, and the second matrix is a right multiply matrix; and
for elements of each column of the second matrix, the controller is used to store each of the elements of each column of the second matrix and elements of a corresponding column of the first matrix to the registers of the processing elements, control each processing element to perform multiplication operations on elements in corresponding registers to obtain element products, and sum element products of each row to obtain the first intermediate results, wherein
the elements of the column of the first matrix corresponding to each of the elements of each column of the second matrix mean that a row number of the element in the second matrix is the same as a column number of the elements of the column.

10. The processor of claim 8, wherein the first matrix is a right multiply matrix, and the second matrix is a left multiply matrix; and
for elements of each row of the second matrix, the controller is used to store each of the elements of each row of the second matrix and elements of a corresponding row of the first matrix to the registers of the processing elements, control each processing element to perform multiplication operations on elements in corresponding registers to obtain element products, and sum element products of each column to obtain the first intermediate results, wherein
the elements of the row of the first matrix corresponding to each of the elements of each row of the second matrix mean that a column number of the element in the second matrix is the same as a row number of the elements of the row.

11. The processor of claim 8, wherein the processor is further used to determine a matrix that is not required to be partitioned from an input matrix as the first matrix and determine another matrix in the input matrix as the second matrix according to arrangements of the processing elements, wherein the input matrix comprises the left multiply matrix and the right multiply matrix.

12. The processor of claim 8, wherein the controller is further used to determine a to-be-loaded matrix from an input matrix, wherein the input matrix comprises the left multiply matrix and the right multiply matrix, and the to-be-loaded matrix is the left multiply matrix or the right multiply matrix; the controller is used to determine whether to partition the to-be-loaded matrix according to arrangements of the processing elements, a row rank of the to-be-loaded matrix, and a column rank of the to-be-loaded matrix; and
if it is determined to partition the to-be-loaded matrix, the controller is used to partition the to-be-loaded matrix to obtain two or more first matrices according to the arrangements of the processing elements, the row rank of the to-be-loaded matrix, and the column rank of the to-be-loaded matrix.

13. The processor of claim 12, wherein the controller is further used to partition another matrix in the input matrix besides the to-be-loaded matrix to obtain two or more second matrices according to a way of partitioning the to-be-loaded matrix; and according to products of the first matrices and corresponding second matrices, based on rules of matrix multiplication, the controller is used to calculate a product of the left multiply matrix and the right multiply matrix.

14. The processor of claim 12, wherein the processor comprises a plurality of groups of registers, and after partitioning the input matrix, the controller is further used to store the two or more first matrices in stacks in the plurality of groups of registers, wherein each group stores one first matrix.

15. An artificial intelligence chip, comprising the processor of claim 8 .

16. (canceled)
